(19) United States
(12) Patent Application Publication
(10) Pub. No.: US 2008/0250101 A1
(43) Pub. Date: Oct. 9, 2008

(54) MULTIMEDIA DATA TRANSMITTING APPARATUS AND MULTIMEDIA DATA RECEIVING APPARATUS

(75) Inventors: Michiko TANAKA, Osaka (JP); Toshihiko MUNETSUGU, Osaka (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/062,084

(22) Filed: Apr. 3, 2008

Related U.S. Application Data
(60) Provisional application No. 60/910,264, filed on Apr. 5, 2007.
(60) Provisional application No. 60/987,865, filed on Nov. 14, 2007.

(51) Int. Cl. G06F 15/16

(52) U.S. Cl. 709/203

(57) ABSTRACT

To provide, in a multimedia content server which stores multimedia data and transmits the stored multimedia data to a terminal, a technique which allows the terminal to implement a data broadcast even when random access for trick play, and the like, is performed. Upon receiving a data transmission request from a multimedia data receiving apparatus, a multimedia data transmitting apparatus transmits the requested multimedia data and definitely inserts data required for data broadcasting or transmits data for data broadcasting, separately from the multimedia data, thereby enabling the multimedia data receiving apparatus to obtain the data required for data broadcasting.

### BACKGROUND OF THE INVENTION

(1) Field of the Invention

The present invention relates to the transmission and reception of digitalized multimedia content data on a network such as a home network, and particularly to implementing reproduction of data accompanying multimedia data, such as a data broadcast.

(2) Description of the Related Art

In recent years, digital broadcasting such as BS digital broadcasting, CS 110-degree digital broadcasting, and digital terrestrial broadcasting has commenced. Furthermore, DVR for recording a TV-program in a recording medium for digital data such as a Hard Disk Drive (HDD), a Blu-Ray Disc (BD), and a Digital Versatile Disc (DVD) is becoming popular. With this, digitalized multimedia content that can be used in households is increasing.

Meanwhile, with the development of the broadband environment, internet access from households is becoming widespread. Accordingly, the spread of the so-called home network, in which the respective rooms in a house are connected by an IP network, is also advancing.

With such a situation, digital broadcasts received by a digital broadcast receiver in the house, or digital contents stored in a recorder can now be viewed at other rooms, using the home network.

With regard to such sharing of digital content using a home network, there is a move to make this possible not only between the above-mentioned CE devices, but also between all devices connected to a home network, including personal computers (PC) and Personal Digital Assistants (PDA). To be more specific, standardization organizations such as the Digital Living Network Alliance (DLNA) have laid-out and made public standards and implementing guidelines for this purpose.

In such content sharing, the methods defined in the Universal Plug and Play Device Architecture (UPnP DA), and UPnP AV Architecture (UPnP AV) are widely used in the recognition of the devices and the exchange of information on the contents that can be used, between a server (for example, a set top box or DVR which receives digital broadcasts) and a client (for example, a personal computer or a digital player) in the home network. In UPnP AV, upon receiving an inquiry from the client, the server replies with a list of provided contents and the attributes of each of the contents. Furthermore, as a mandatory protocol for transmission of content data, Hypertext Transfer Protocol (HTTP) is used in DLNA.

In such sharing of content in a home network, for example, in the case of sharing a broadcast content among plural terminals using the network, it is necessary to follow a broadcast standard such as the ARIB Standard in Japan or the DVB Standard in Europe. In these standards, when outputting to a network, it is stipulated that the output format must be the Partial TS format. Furthermore, in a broadcast, section data carrying the structure information of a stream and/or the application information is updated by a version up. In addition, for data broadcast, actual data used during reproduction of data broadcast is delivered, and such actual data for data broadcast is updated by a version up. In addition, in order to attain synchronization of video/audio and content of data broadcast, a section, which notifies time information used for content for carrying out data broadcast as well as a timing for performing synchronization with video/audio, is also transmitted. In order to obtain event information such as the update information or the synchronization timing notification inside of a stream, it is necessary for the client to receive and analyze all the Partial TS on the server over the network.

However, when reproducing a recorded content via the network, it does not follow that the client can receive all the data of the Partial TS of the content. For example, when a client performs trick play of content existing on the server, it is acceptable to use a method in which the client selectively receives and reproduces specific sections of content data, or a method in which the server selects specific sections of content data according to a reproduction speed requested by the client, constructs a stream with the selected data and transmits the stream, and the client reproduces the received stream. When trick play such as fast forward is performed with such methods, the client cannot receive all of the stream data of the content. In the case where the stream which was not received includes an event which notifies a timing for synchronizing video and/or audio and a data broadcast, or an event which notifies the version up of actual data used during reproduction of the data broadcast, data for data broadcasting, and the like, the client is unable to correctly implement the reproduction of the data broadcast. Therefore, there is a demand for a method in which a server sends out, to the client, information that allows the client to judge event information within a stream even during trick play, or a method in which a server separates information associated with video/audio and data broadcast, and sends out the separated information.

At this time, the first problem is that, since the client does not know about the existence and details of data for data broadcasting including the desired content, it is not possible to separately request for obtainment of data for data broadcasting or event information.

The second problem is that, since there is a possibility that the data for data broadcasting has been updated, if a version up of the data occurs when obtaining the data for data broadcasting from the server, the client is unable to obtain the appropriate data.

The third problem is that, in the case of storing, in a storage region, the data for data broadcasting obtained by the client from the server, it is not possible to judge whether or not the data for data broadcasting stored in the storage region can be used in the reproduction position desired by the client. This is because the client is unable to detect the occurrence of an event such as a version up associated with the data for data broadcasting.

The fourth problem is that, even when the client issues, to the server, a data obtainment request at a timing for requiring the data, in order for the client to implement data broadcasting that is synchronized with video and audio, there is a possibility that data cannot be obtained in time for video and/or audio synchronization process. This means that, in addition to the possibility of a delay (delay due to the network or delay due to server processing, and so on) occurring during the obtainment of desired data by the client from the server, since content reproduction is being performed on the client terminal during the time such delay is taking place, and there is a possibility that the fundamental timing for synchronizing with the data broadcast may pass by, synchronization of audio/video and the data broadcast cannot be correctly implemented at the client.

For this problem, Japanese Unexamined Patent Application Publication No. 2005-123734 proposes a method for reserving the bandwidth for video/audio, and sending out data broadcast through the remaining bandwidth. Here, a data transmission request is issued to the server, with the manipulation of EPG information by the user operating the client terminal as a trigger. However, since Japanese Unexamined Patent Application Publication No. 2005-123734 does not assume the storing of data for data broadcasting in a storage region at the client, the third problem cannot be solved. In addition, since Japanese Unexamined Patent Application Publication No. 2005-123734 does not assume the delay in obtaining the data for data broadcasting due to network delays, and the like, the fourth problem cannot be solved. In addition, since Japanese Unexamined Patent Application Publication No. 2005-123734 does not mention a version up of data, it is not possible to obtain a solution for the second problem. Furthermore, since a specific method for transmitting and receiving information that requires synchronizing, such as an event for data broadcasting, a sufficient solution likewise cannot be obtained for the first problem.

Furthermore, Japanese Unexamined Patent Application Publication No. 2006-261763 proposes a method which records the data and management table of a data broadcast, and enables the reproduction of a data broadcast even during trick play. However, Japanese Unexamined Patent Application Publication No. is 2006-261763 proposes a method for performing data broadcasting at the time of trick play on a local terminal, and does not assume streaming reproduction via a network. As such, it is not possible to solve the first to fourth problems arising when implementing reproduction of a data broadcast by streaming reproduction via a network.

Thus, the present invention is conceived in view of the aforementioned problems and has as an object to provide: a method for transmitting, from a server to a client, information allowing the judgment of an event within a stream, even during trick play, in streaming reproduction; a multimedia data transmitting apparatus which receives an obtainment request for data broadcasting association information from a multimedia data receiving apparatus, and transmits data broadcasting association information in response to the request; and the multimedia data receiving apparatus which reproduces a stream and a data broadcast, based on the received information.

### SUMMARY OF THE INVENTION

In order to achieve the aforementioned object, the present invention is a multimedia data transmitting apparatus which transmits stored multimedia data to a multimedia data receiving apparatus via a network, in response to a transmission request from the multimedia data receiving apparatus, the multimedia data transmitting apparatus includes: a storage unit in which first multimedia data received from a digital broadcast is stored, the first multimedia data including audio, video, and added information; an event information management unit which manages event information representing: an event occurring in the first multimedia data stored in the storage unit, and an occurrence timing of the event; a request receiving unit which receives a request message from the multimedia data receiving apparatus; and an information transmitting unit which transmits, to the multimedia data receiving apparatus, the multimedia data and the event information which are specified in the request message.

According to this configuration, it is possible to manage event information associated with timing such as the time of an update included in multimedia data or the time of a data broadcast or information for synchronization with video/audio, and transmit the event information to the multimedia data receiving apparatus.

Furthermore, it is also possible that: the multimedia data transmitting apparatus further includes a transmission data generating unit which extracts plural portions from the stored first multimedia data, and generates second multimedia data conforming to a specified trick play, wherein, in the case of receiving a request for a trick play from the multimedia data receiving apparatus, the transmission data generating unit: generates the second multimedia data by referring to the event information, so as to include the event occurring in the first multimedia data specified by the multimedia data receiving apparatus, and in the case where a portion including the occurrence timing of the event in the first multimedia data is specified, places the event at the same position in the portion of the second multimedia data, and in the case where the portion including the occurrence timing of the event in the first multimedia data is not specified, places the event immediately before the portion of the second multimedia data that is equivalent to the portion of the first multimedia data that is specified immediately after the occurrence timing of the event in the first multimedia data, and the information transmitting unit transmits the second multimedia data generated by the transmission data generating unit.

According to this configuration, it is possible to transmit the event of first multimedia data to the multimedia data receiving apparatus, even during trick play.

Furthermore, it is also possible that the request message received, from the multimedia data receiving apparatus, by the request receiving unit is an obtainment request for one of: multimedia data, Moving Picture Experts Group (MPEG) section data, a file, a directory, an MPEG Digital Storage Media Command and Control (DSM-CC) Module, and an MPEG DSM-CC Object.

According to this configuration, the multimedia data transmitting apparatus according to the present invention can transmit multimedia data, Moving Picture Experts Group (MPEG) section data, a file, a directory, an MPEG Digital Storage Media Command and Control (DSM-CC) module, or an MPEG DSM-CC object, in response to the request from the multimedia data receiving apparatus.

Furthermore, it is also possible that the request message received from the multimedia data receiving apparatus by the request receiving unit specifies at least one from among a data type, a data identifier, and a multimedia data section.

According to this configuration, the multimedia data transmitting apparatus according to the present invention can definitely transmit data specified by the multimedia data receiving apparatus.

Furthermore, it is also possible that the information transmitting unit transmits, in response to the request message from the multimedia data receiving apparatus, one of the following which conforms to the request message: multimedia data, MPEG section data, a file, a directory, an MPEG DSM-CC Module, and an MPEG DSM-CC Object.

According to this configuration, the multimedia data transmitting apparatus according to the present invention can transmit data required for reproducing a data broadcast, in response to the request from the multimedia data receiving apparatus.

Furthermore, it is also possible that, when the request is received from the multimedia data receiving apparatus, the information transmitting unit selects data conforming to the request message, by referring to data managed by the event information management unit, and transmits the selected data.

According to this configuration, it is possible to transmit, to the multimedia data receiving apparatus, multimedia data that reflects an event such as an update included in the multimedia data.

Furthermore, it is also possible that the event information management unit further manages information for reproducing a data broadcast included in the first multimedia data.

According to this configuration, since the event information management unit also manages the required data, the required data can be transmitted without having to extract data conforming to the request message from the first multimedia, when a transmission request is received.

Furthermore, it is also possible that the information transmitting unit transmits management information of the event information held by the event information management unit, to the multimedia data receiving apparatus, in response to the request from the multimedia data receiving apparatus.

According to this configuration, the multimedia data receiving apparatus can know the event information prior to reproduction, and the multimedia data receiving apparatus can determine event information, or information required for data broadcast, or the timing for obtaining such information.

Furthermore, the multimedia data receiving apparatus according to the present invention is multimedia data receiving apparatus which receives multimedia data and association information of the multimedia data from a multimedia data transmitting apparatus, and reproduces the multimedia data, wherein the association information is one of the following which is associated with the multimedia data: MPEG section data, a file, a directory, an MPEG DSM-CC Module, an MPEG DSM-CC Object, and event information representing an event occurring in the multimedia data and an occurrence timing of the event, and the multimedia is reproduced by a process that conforms to the type of the received association information.

According to this configuration, the reproduction of a content recorded by the multimedia data transmitting apparatus, and the reproduction of the data broadcast of the content can be performed on the multimedia data receiving apparatus.

Furthermore, it is also possible that, in the case where an event information is received, the multimedia data receiving as apparatus updates the multimedia data or the association information which are held in the multimedia data receiving apparatus, by performing either of the following according to details of the received event information: deleting the received multimedia data or the association information; and receiving new multimedia data or association information by requesting to the multimedia data transmitting apparatus.

According to this configuration, the multimedia data or the association information can be correctly updated according to the event.

Furthermore, it is also possible that the multimedia data receiving apparatus receives the association information by requesting the multimedia data transmitting apparatus.

According to this configuration, the multimedia data receiving apparatus can control the timing for obtaining the association information.

Furthermore, it is also possible that the multimedia data receiving apparatus further: receives management information of the event held by the multimedia data transmitting apparatus; determines data that is required according to the event, by referring to the received management information; and receives the required data by requesting to the multimedia data transmitting apparatus.

According to this configuration, the multimedia data receiving apparatus can determine event information, or information required for data broadcast, or the timing for obtaining such information.

Furthermore, it is also possible that: the multimedia data receiving apparatus further includes a Java™ execution unit which executes a Java application, wherein the multimedia data or the association information of the multimedia data is obtained according to an instruction from the Java application.

According to this configuration, it becomes possible to reproduce a data broadcast conforming to a request of the Java application.

As described above, the present invention is a multimedia data transmitting apparatus which stores multimedia data including audio, video, and added information such as an MPEG section, which are received from a digital broadcast, and transmits the stored multimedia data to a multimedia data receiving apparatus via a network, in response to a request message from the multimedia data receiving apparatus, the multimedia data transmitting apparatus includes: an event information management unit which manages an event occurring in the stored multimedia data, and an occurrence timing of the event; and an information transmitting unit which transmits, to the multimedia data receiving apparatus, the multimedia data and the event information which are specified in the request message. With this, it is possible to manage event information associated with timing such as the time of an update included in multimedia data or the time of a data broadcast, or information for synchronization with video and audio, and transmit the event information to the multimedia data receiving apparatus.

### FURTHER INFORMATION ABOUT TECHNICAL BACKGROUND TO THIS APPLICATION

As further information about the technical background to this application, the disclosure of U.S. Provisional Application No. 60/910,264 filed Apr. 5, 2007, including specifications, drawings and claims, and the disclosure of U.S. Provisional Application No. 60/987,865 filed Nov. 14, 2007, including specifications, drawings and claims, are incorporated herein by reference in their entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a configuration diagram for the multimedia content delivery system in an embodiment of the present invention.

FIG. 2 is a configuration diagram for the multimedia data transmitting apparatus 101 in an embodiment of the present invention.

FIG. 3 is a diagram showing an example of an external view in the case where the input 201 unit is configured of a front panel.

FIG. 4 is a structure diagram showing an example of the program structure stored in the multimedia data transmitting apparatus 101 in an embodiment of the present invention.

FIG. 5A is a diagram showing an example of an on-screen display in the present invention.

FIG. 5B is a diagram showing another example of an on-screen display in the present invention.

FIG. 6 is a diagram showing an example of information stored in the second memory 203 of the present invention.

FIG. 7 is a diagram showing an example of information stored in the second memory 203 of the present invention.

FIG. 8A is a diagram showing an example of information stored in the second memory 203 of the present invention.

FIG. 8B is a diagram showing another example of information stored in the second memory 203 of the present invention.

FIG. 8C is a diagram showing another example of information stored in the second memory 203 of the present invention.

FIG. 9 is a diagram showing an example of information stored in the first memory 202 or the second memory 203 of the present invention.

FIG. 10 is a diagram showing an example of information stored in the first memory 202 or the second memory 203 of the present invention.

FIG. 11 is a diagram showing an example of information stored in the first memory 202 or the second memory 203 of the present invention.

FIG. 12 is a diagram showing an example of information stored in the first memory 202 or the second memory 203 of the present invention.

FIG. 13 is a diagram showing an example of a structure diagram for the program structure stored in the multimedia data transmitting apparatus 101 in an embodiment of the present invention.

FIG. 14 is a diagram showing an example of the configuration of the storage management library 1302 of the present invention.

FIG. 15A is a diagram showing an example of an on-screen display in the present invention.

FIG. 15B is a diagram showing another example of an on-screen display in the present invention.

FIG. 16 is a diagram showing an example of information stored in the first memory 202 or the second memory 203 of the present invention.

FIG. 17A is a diagram showing the information transmitted by the NPT Reference Descriptor.

FIG. 17B is a diagram showing the information transmitted by is the Stream Event Descriptor.

FIG. 18A is a diagram showing an example of the configuration of the storage management library 1302 of the present invention.

FIG. 18B is a diagram showing an example of the processing by the storage management library 1302 of the present invention.

FIG. 19 is a diagram showing an example of information stored in the first memory 202 or the second memory 203 of the present invention.

FIG. 20 is a diagram showing an example of information stored in the first memory 202 or the second memory 203 of the present invention.

FIG. 21 is a diagram showing an example of information stored in the first memory 202 or the second memory 203 of the present invention.

FIG. 22 is a diagram showing an example of information stored in the first memory 202 or the second memory 203 of the present invention.

FIG. 23A is a diagram showing an example of the configuration of the network library 405e of the present invention.

FIG. 23B is a diagram showing an example of the processing by the network library 405e of the present invention.

FIG. 24 is a configuration diagram for the multimedia data receiving apparatus 102 in an embodiment of the present invention.

FIG. 25 is a structure diagram for the program structure stored in the multimedia data receiving apparatus 102 in an embodiment of the present invention.

FIG. 26 is a diagram showing an example of information stored in the first memory 2402 or the second memory 2403 of the present invention.

FIG. 27 is a diagram showing an example of an on-screen display in the present invention.

FIG. 28 is a diagram showing an example of the configuration of the network library 2504d of the present invention.

FIG. 29 is a structure diagram of a DSM-CC.

FIG. 30 is a diagram showing an example of the configuration of the storage management library 1302 of the present invention.

FIG. 31 is a diagram showing an example of the configuration of the storage management library 1302 of the present invention.

FIG. 32 is a diagram showing an example of information stored in the first memory 202 or the second memory 203 of the present invention.

FIG. 33A is a diagram showing an example of information stored in the first memory 202 or the second memory 203 of the present invention.

FIG. 33B is a diagram showing an example of information stored in the first memory 202 or the second memory 203 of the present invention.

FIG. 34 is a diagram showing an example of information stored in the first memory 202 or the second memory 203 of the present invention.

FIG. 35A is a diagram showing an example of information stored in the first memory 202 or the second memory 203 of the present invention.

FIG. 35B is a diagram showing an example of information stored in the first memory 202 or the second memory 203 of the present invention.

FIG. 36A is a diagram showing an example of a DSM-CC Module, a DSM-CC Object in the present invention.

FIG. 36B is a diagram showing an example of a file system in the present invention.

FIG. 36C is a diagram showing an example of information stored in the first memory 202 or the second memory 203 in the present invention.

FIG. 37 is a diagram showing an example of information stored in the first memory 202 or the second memory 203 of the present invention.

FIG. 38 is a diagram showing an example of information stored in the first memory 202 or the second memory 203 of the present invention.

FIG. 39 is a diagram showing an example of information stored in the first memory 202 or the second memory 203 of the present invention.

FIG. 40 is a diagram showing an example of information stored in the first memory 202 or the second memory 203 of the present invention.

FIG. 41 is a diagram showing an example of information stored in the first memory 202 or the second memory 203 of the present invention.

FIG. 42 is a diagram showing an example of a DSM-CC Module and a DSM-CC Object in the present invention.

FIG. 43 is a diagram showing an example of information stored in the first memory 202 or the second memory 203 of the present invention.

FIG. 44 is a diagram showing an example of the configuration of the network library 2504d of the present invention.

FIG. 45 is a structure diagram for the program structure stored in the multimedia data transmitting apparatus 101 in the embodiment of the present invention.

FIG. 46 is a diagram showing an example of the structure of data stored in the second memory 203 in the embodiment of the present invention.

FIG. 47 is a diagram showing an example of the attribute information of multimedia data in the embodiment of the present invention.

FIG. 48 is a diagram showing an example of the attribute information table in the embodiment of the present invention.

FIG. 49 is a diagram showing an example of the URI table in the embodiment of the present invention.

FIG. 50 is an internal configuration diagram for the Rec 405j and the network library 405e.

FIG. 51 is a diagram showing an example of update-point information stored by the Rec 405j.

FIG. 52 is a configuration diagram for the multimedia data receiving apparatus 102 in the embodiment of the present invention.

FIG. 53 is a structure diagram for the program structure stored in the multimedia data receiving apparatus 102 in the embodiment.

FIG. 54 is an internal configuration diagram for the network library 2004d.

### DESCRIPTION OF THE PREFERRED EMBODIMENT(S)

Hereinafter, the embodiment of the present invention shall be described with reference to the drawings.

### First Embodiment

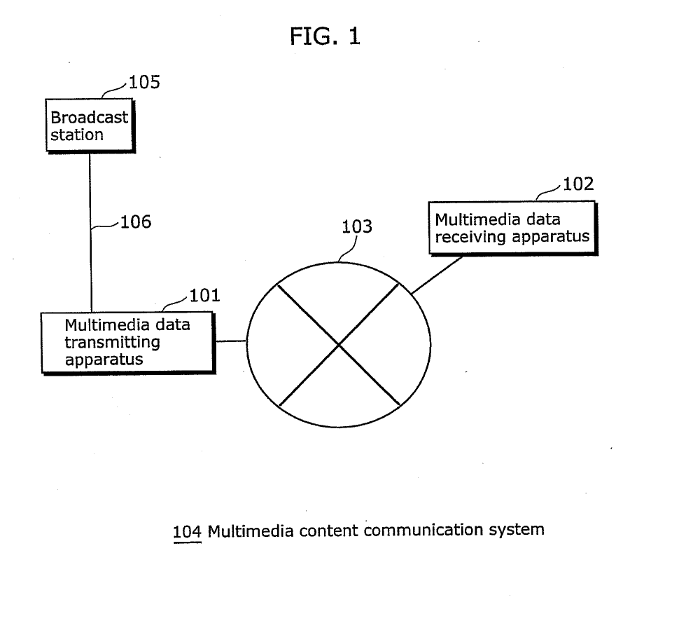

FIG. 1 is a configuration diagram for the multimedia content communication system in the embodiment of the present invention. In FIG. 1, 101 denotes a multimedia data transmitting apparatus in the present invention, 102 denotes a multimedia data receiving apparatus in the present invention, 103 denotes a network, and 104 denotes a multimedia content communication system made up of these elements. The multimedia data transmitting apparatus 101 and the multimedia data receiving apparatus 102 are connected to the network 103, and can communicate with each other via the network 103. In addition, 105 denotes a cable television broadcast station, 106 denotes a cable connecting the multimedia data transmitting apparatus 101 and the broadcast station 105.

The multimedia data transmitting apparatus 101 in the present embodiment is a CATV Set Top Box (STB) which includes a network interface and a storage unit for storing multimedia data. Note that, here, although the subject broadcasting system is described using a cable system, the present invention is not dependent on the broadcasting system of the digital broadcast and is, thus, applicable even with other systems such as satellite broadcasting and terrestrial broadcasting. The multimedia data transmitting apparatus 101 is connected to the broadcast station 105 via the cable 106. In addition, the multimedia data transmitting apparatus 101 stores the multimedia data of a digital broadcast content received from the broadcast station 105, in the storage unit. Furthermore, the multimedia data transmitting apparatus 101 is connected to the network 103 via the network interface. In addition, the multimedia data transmitting apparatus 101 receives, through the network 103, requests transmitted from the multimedia data receiving apparatus 102. Subsequently, in response to the requests, the multimedia data transmitting apparatus 101 transmits, to the multimedia data receiving apparatus 102, through the network 103, the information and attributes or the multimedia data of each of the contents of digital broadcasts received, or those of each of the stored contents.

Note that the digital broadcast content stored in the storage unit by the multimedia data transmitting apparatus 101 is data in the MPEG-2-TS format.

According to a request from the user, the multimedia data receiving apparatus 102 transmits, to the multimedia data transmitting apparatus 101, a transmission request for a list of contents that can be provided. Then, the multimedia data receiving apparatus 102 receives a list of contents from the multimedia data transmitting apparatus 101 as a response to the request, and presents the list to the user. In addition, the is multimedia data receiving apparatus 102 transmits, to the multimedia data transmitting apparatus 101, a transmission request for multimedia data of a content selected by the user. The multimedia data receiving apparatus 102 receives multimedia data as a response to the request, reproduces the received multimedia data and presents this to the user. Furthermore, upon receiving a request for trick play such as fast forward or reverse from the user, the multimedia data receiving apparatus 102 implements trick play through a method in which trick play is implemented by once terminating communication of multimedia data, successively issuing, as anew, transmission requests for portions required for trick play, and receiving and reproducing the multimedia data at each time, or through a method in which the reproduction speed for trick play requested by the user is transmitted to the multimedia data transmitting apparatus 101, and the multimedia data transmitting apparatus 101 successively selects specific sections of the multimedia data according to the requested reproduction speed, generates a stream with the selected data, and transmits the generated stream to the multimedia data receiving apparatus 102.

The network 103 is a home network established in the household, and is an IP network configured of the Ethernet, wireless LAN, and so on.

Hereinafter the communication and respective operations of the multimedia data transmitting apparatus 101 and the multimedia data receiving apparatus 102 shall be described.

When connected to the network 103, the multimedia data transmitting apparatus 101, which is a multimedia data server, notifies other devices that it is a server that can provide services, by broadcasting to the network 103. In addition, according to a request from another device connected to the network 103, the multimedia data transmitting apparatus 103 transmits a service provided and the access method thereof to the request-source apparatus. When connected to the network 103, the multimedia data receiving apparatus 102, searches for server devices connected to the network 103, and obtains what functions each of the server devices have. Since this communication is carried out as defined by the UPnP Device Architecture (DA), in the same manner as with DLNA, detailed description shall be omitted. With this, the multimedia data receiving apparatus 102 can recognize that the multimedia data transmitting apparatus 101 is a multimedia server which is connected to the network 103.

Hereinafter, the communication of multimedia data between the multimedia data transmitting apparatus 101 and the multimedia data receiving apparatus 102 shall be described in sequence. First, the multimedia data receiving apparatus 102 issues a transmission request for a list of contents that can be provided, to the multimedia data transmitting apparatus 101. Then, upon receiving the request, the multimedia data transmitting apparatus 101 retrieves the contents that can be provided, and replies to the multimedia data receiving apparatus 102, with the list. This communication can be carried out using the Browse or Search in the UPnP AV Content Directory Service (CDS), and thus detailed description shall be omitted.

Upon receiving, from the multimedia data receiving apparatus 102, the transmission request for the list of contents that can be provided, to the multimedia data transmitting apparatus 101 replies with a list of contents stored in the storage unit. Since a list defined by the UPnP AV or DLNA can be used for the list to be transmitted, detailed description shall be omitted.

Receiving the provided content list, the multimedia data receiving apparatus 102 presents this list to the user. Then, the multimedia data receiving apparatus 102 requests, to the multimedia data transmitting apparatus 101, the transmission of multimedia data of the content selected by the user. The multimedia data transmitting apparatus 101 reads the requested content data from the storage unit, and transmits this to the multimedia data receiving apparatus 102. In the communication of the multimedia, communication is performed using HTTP which is a mandatory protocol in DLNA.

Here, when trick play such as fast forward, reverse, and slow is requested by the user, the multimedia data receiving apparatus executes the requested trick play. This is implemented through a method in which trick play is performed by the multimedia data receiving apparatus 102 repeating: the judging of necessary data sections according to the type of trick play requested; receiving and reproducing data of such sections only; and displaying the reproduced data, and through a method in which the reproduction speed for trick play requested by the user is transmitted to the multimedia data transmitting apparatus 101, and the multimedia data transmitting apparatus 101 successively selects specific sections of the multimedia data according to the requested reproduction speed, generates a stream with the selected data, and transmits the generated stream to the multimedia data receiving apparatus 102. As such, when trick play is implemented through either method, there are cases where the multimedia data receiving apparatus 102 cannot obtain all the TS packets of the multimedia data. Therefore, problems occur in the implementation of data broadcast reproduction.

In general, the broadcast station 105 transmits data for data broadcasting using the carousel method in which data is transmitted repeatedly. The carousel method is known from ISO/IEC International Standard 13818-6 “MPEG-2 Digital Storage Media Command and Control” (hereafter called DSM-CC).

At this time, the broadcast station 105 transmits data broadcasting association information such as: section data carrying structure information of a stream or application information, and is update information of the section data, and in addition, data for data broadcasting used for data broadcasting, and update information of the data for data broadcasting, and in addition, time information for implementing synchronization of video and audio and a data broadcast, or information notifying the timing for synchronization. In addition, the broadcast station takes into consideration the association of the respective information in the data broadcasting association information, and transmits the information by encoding it into a stream at the appropriate timing.

As such, in the case where the multimedia data transmitting apparatus 101 transmits the stream to the multimedia data receiving apparatus 102, there is a need to transmit the data for data broadcasting at the same timing as the timing at which the data is received from the broadcast station 105. However, as described above, when the user performs trick play, a portion of the stream cannot be obtained and, thus, the multimedia data receiving apparatus 102 cannot reproduce the data broadcast. Note that the following information are given as examples of data broadcasting association information required for implementing data broadcasting.

Data for data broadcasting: Information required for obtaining/constructing actual data
Structure information of a stream, and application information
Structure information of data for data broadcasting
Actual data used during reproduction of a data broadcast

Event information: Information associated with timing
Update information and update timing of structure information of a stream, application information, structure information of data for data broadcasting
Time information for implementing synchronization of video and audio and a data broadcast, or the timing for synchronization

As such, in order for the multimedia data receiving apparatus 102 to implement data broadcasting, there is a need to obtain the aforementioned data for data broadcasting and event information, as the data broadcasting association information.

Consequentially, the present embodiment describes a method in which the multimedia data transmitting apparatus 101 includes event information, for which timing is important, in a stream for trick play of a content requested by the multimedia data receiving apparatus 102. Note that, here, the method for obtaining the data for data broadcasting from the stream of the content, and the as method described in the second embodiment described later are acceptable.

In addition, the second embodiment describes a method in which data broadcasting association information of the content is requested and obtained by the multimedia data receiving apparatus 102.

In addition, the third embodiment describes a method in which the management information of event information or the management information of data for data broadcasting, or both, which are managed by the multimedia data transmitting apparatus 101 in the first and second embodiments is/are provided to the multimedia data receiving apparatus 102, and the timing at which to obtain data broadcasting association information is judged by the multimedia data receiving apparatus 102.

Furthermore, the multimedia data receiving apparatus 102 reproduces a data broadcast using the data broadcasting association information obtained through the previously described methods.

Hereinafter, the multimedia data transmitting apparatus 101 and the multimedia data receiving apparatus 102 included in the multimedia content communication system 104 shall be described in more detail.

First, the multimedia data transmitting apparatus 101 shall be described.

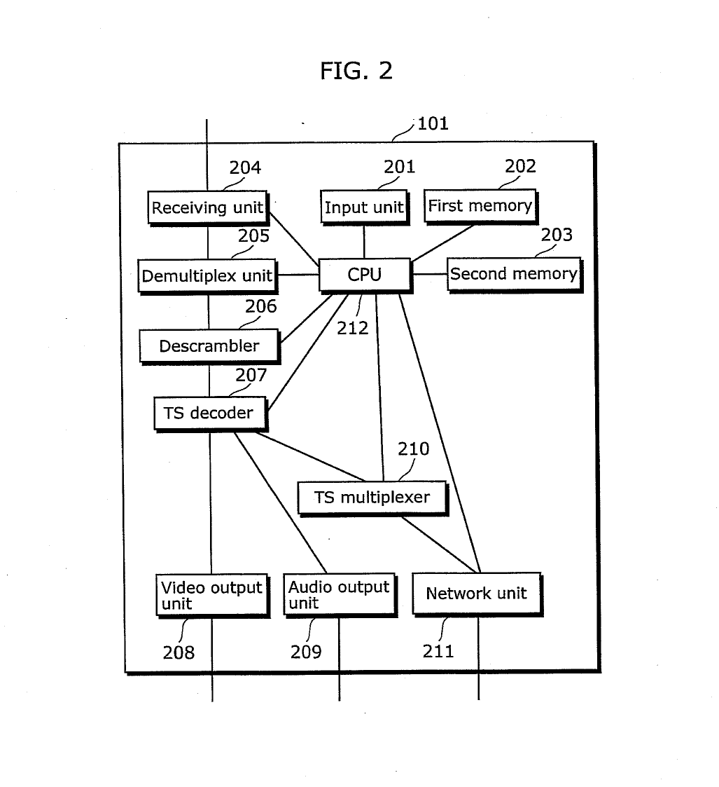

FIG. 2 is a block diagram showing the relationship of constituent elements included in the multimedia data transmitting apparatus 101 in the present embodiment. The multimedia data transmitting apparatus 101 includes an input unit 201, a first memory 202, a second memory 203, a receiving unit 204, a demultiplex unit 205, a descrambler 206, a TS decoder 207, a video output unit 208, an audio output unit 209, a TS multiplexer 210, a network unit 211, and a CPU 212.

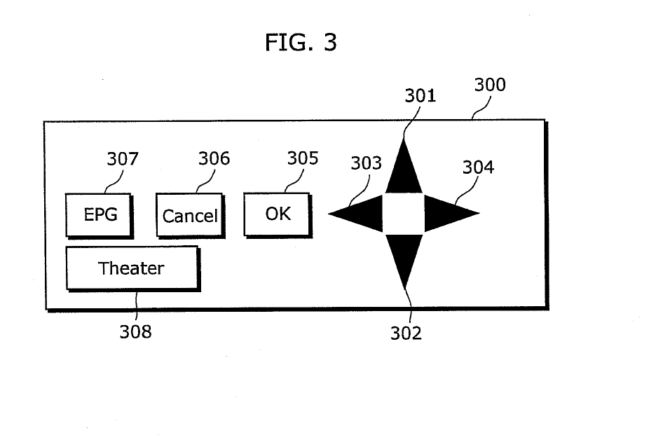

The input unit 201 is configured of a front panel, remote control signal receiver, and the like, and accepts an instruction, such as a channel selection, from a user. FIG. 3 shows an example of the input unit 201 in the case where it is configured of a front panel. 300 is a front panel configured of 8 buttons, namely, an up-cursor button 301, a down-cursor button 302, a left-cursor button 303, a right-cursor button 304, an OK button 305, a cancel button 306, an EPG button 307, and a theater button 308. When the user presses down a button, the identifier of such pressed button is notified to the CPU 212.

The first memory 202 is configured of a RAM, or the like, and is used when the CPU 212 temporarily stores data.

The second memory 203 is configured of a device that can hold information even when power is turned off, such as a flash memory, a hard disk, or the like, and stores a program executed by the CPU 212. For the second memory, a detachable storage device such as an SD memory card and the like may also be used.

The receiving unit 204 is connected to the cable from a CATV station from which it receives broadcast waves. The receiving unit 204 tunes to the frequency specified by the CPU 212, extracts an MPEG transport stream and passes the extracted MPEG transport stream to the demultiplex unit 205.

The demultiplex unit 205 receives the MPEG transport stream from the receiving unit 204, extracts information specified by the CPU 212 and passes it to the CPU 212. In addition, it passes the MPEG transport stream to the descrambler 206 as it is.

The descrambler 206 descrambles (=decrypts) the scrambled MPEG transport stream provided by the demultiplex unit 205, and passes the descrambled MPEG transport stream to the TS decoder 207. The descrambler 206 may be a module built-into the multimedia data transmitting apparatus 101, and may also be implemented through the CableCARD™ introduced in North American cable receivers. The specifications of CableCARD is described in the CableCARD Interface Specification laid out by the CableLabs in the United States, and thus description is omitted herein.

The TS decoder 207 receives, from the CPU 212, identifiers of audio data, video data, and section data such as PSI/SI information and so on. In addition, the TS decoder 207 extracts, from the descrambled stream received from the descrambler 206, data corresponding to the received identifiers of audio data, video data, and section data such as PSI/SI information and so on, and passes the extracted video data to the video output unit 208, and the audio data to the audio output unit 209. Furthermore, the TS decoder 207 passes both the extracted video data and audio data, as well as the section data, to the TS multiplexer 210. Passing of the data to the TS multiplexer 210 may be done in the TS packet format, or the data may be extracted from the TS packet and only the extracted data is passed.

The video output unit 208, which includes a video output terminal, converts the received video data to video data that complies with the terminal and outputs this. An example of the terminal is a composite cable terminal, and so on.

The audio output unit 209, which includes an audio output terminal, converts the received audio data to audio data that complies with the terminal and outputs this. Examples of the terminal are earphone terminals, a composite cable terminal, and so on.

The TS multiplexer 210 generates an MPEG-2 transport stream from the received video data, audio data, and section data, and passes the MPEG-2 transport stream to the network unit 211.

The PSI/SI information shall be rewritten as necessary. As an example of the rewriting, there are instances where the TS multiplexer 210 rewrites the PAT so as to include information of only specified contents. At this time, in the case where the data is passed in the TS packet format, the MPEG-2 transport stream may be generated by sequentially arranging the received TS packets as they are.

The network unit 211, which includes a network interface, converts the data received from the CPU 212 into a signal that is in accordance with the physical media of the network to which the network interface is connected to, and outputs this signal. Furthermore, the network unit 211 receives a signal from the network interface, converts the signal into a packet defined by the IP network, and passes the packet to the CPU 212.

The CPU 212 controls the receiving unit 204, the demultiplex unit 205, the descrambler 206, the TS decoder 207, the TS multiplexer 210, and the network unit 211 by executing a program stored in the second memory 203.

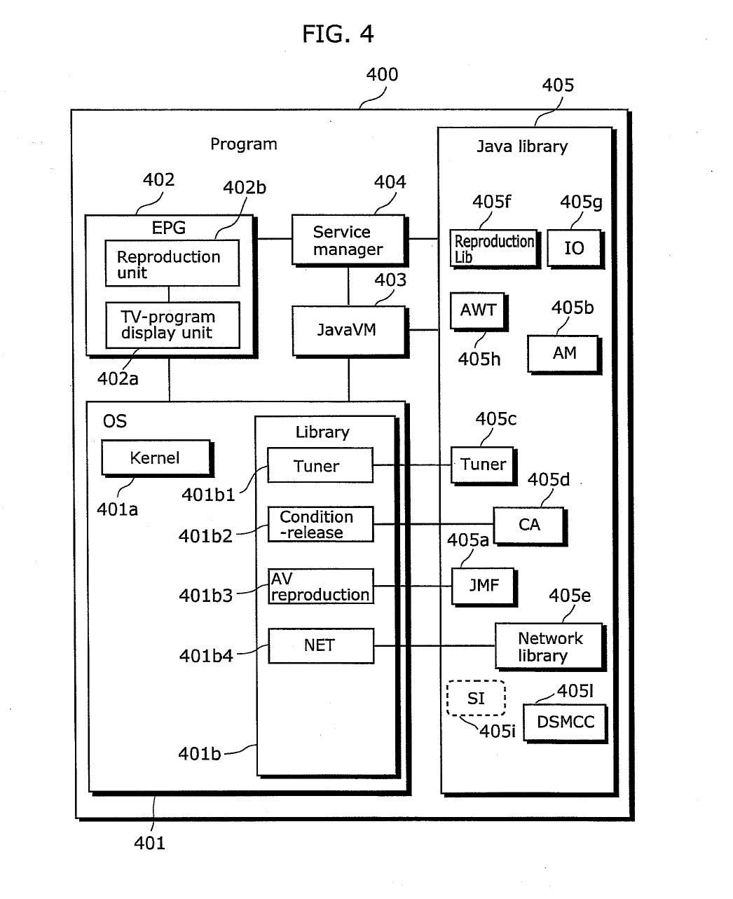

FIG. 4 is an example of a structure diagram of the program stored in the second memory 203 and executed by the CPU 212.

A program 400 is made up of plural subprograms, and is specifically made up of an OS 401 an EPG 402, a lava VM 403, a service manager 404, and a lava library 405.

The OS 401 is a subprogram activated on the CPU 212 when power to the multimedia data transmitting apparatus 101 is turned on. OS is the acronym for operating system, an example of which is Linux and the like. The OS 401 is a generic name for publicly known technology made up of a kernel 401a for executing a subprogram concurrently with another subprogram and of a library 401b, and therefore detailed description is omitted. In the present embodiment, the kernel 401a of the OS 401 executes the EPG 402 and the VM 403 as subprograms. Furthermore, the library 401b provides these subprograms with plural functions required for controlling the constituent elements held by the multimedia data transmitting apparatus 101.

In the present embodiment, the library 401b includes a tuner 401b1, condition-release 201b2, AV reproduction 401b3, and NET 401b4, as an example of functions.

The tuner 401b1 receives tuning information including a frequency from other subprograms or a Tuner 405c of the lava library 405, and passes the received tuning information to the receiving unit 204. The receiving unit 204 can perform demodulation based on the provided tuning information, and pass the demodulated data to the demultiplex unit 205. As a result, the other subprograms and the Tuner 405c of the Java library 205 can control the receiving unit 204 through the library 401b.

The condition-release 401b2 receives information from other subprograms or a CA 405d of the Java library 405, and passes the received information to the descrambler 206.

The AV reproduction 401b3 receives the audio packet ID and video packet ID from the other subprograms or a JMF 405a of the Java library 405. The AV reproduction 401b3 then provides the received audio packet ID and video packet ID to the TS decoder 207. As a result, the TS decoder 207 performs filtering based on the provided packet IDs, and implements the reproduction of audio/video.

The NET 401b4 creates packets of a protocol lower than the application layer defined by the IP network, for the data received from the other subprograms or a network library 405e of the Java library 405. A protocol lower than the application layer refers to, for example, a TCP packet, a UDP packet, an IP packet, and so on. By passing this to the network unit 211, messages and data are transmitted to another device via the network 103. Furthermore, when a message is received from another device via the network 103, the NET 401b4 converts the message to an application layer protocol packet and passes this packet to the other subprograms or the network library 405e of the Java library 405. An application layer protocol refers to, for example, HTTP, Real-time Transport Protocol (RTP), and so on.

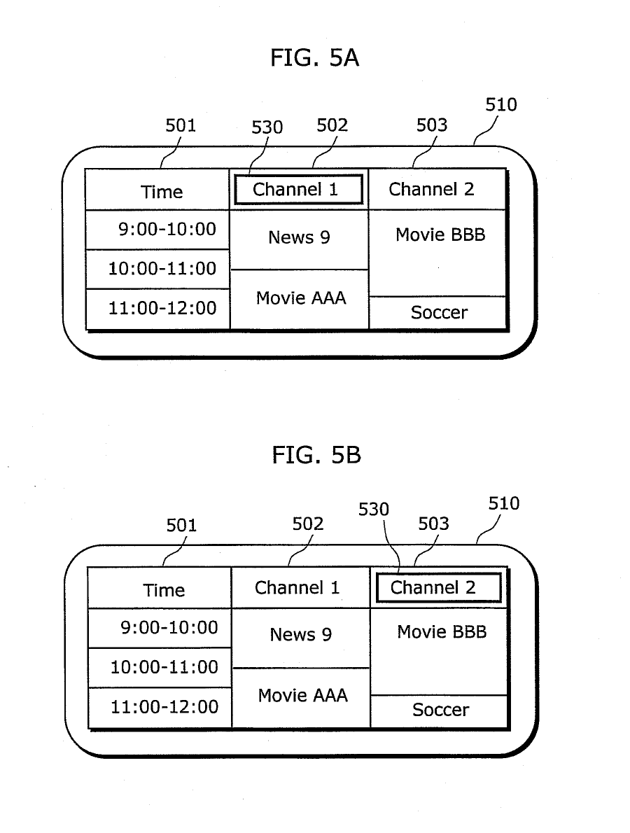

The EPG 402 is made up of a TV-program display unit 402a for displaying a list of TV-programs to the user as well as for accepting an input from the user, and a reproduction unit 402b for selecting channels. Here, EPG is an abbreviation of Electric Program Guide. The EPG 402 is activated by the kernel 401a when power to the multimedia data transmitting apparatus 101 is turned on. Inside the activated EPG 402, the TV-program display unit 402a and the reproduction unit 402b are activated at the same time. When activated, the TV-program display unit 402a waits for an input from the user through the input unit 201 of the multimedia data transmitting apparatus 101. Here, in the case where the input unit 201 is configured of a front panel as shown in FIG. 3, when the user presses down the EPG button 307 of the input unit 201, the identifier of such EPG button is notified to the CPU 212. The TV-program display unit 402a of the EPG 402, which is a subprogram running on the CPU 212, accepts this identifier, then creates TV-program information display data, and displays this on a monitor 510 using a monitor output unit that is not shown in the figure. The monitor 510 may be included in the multimedia data transmitting apparatus 101, and may also be a television connected to the multimedia data transmitting apparatus 101 by a composite cable, HDMI cable, or the like. The monitor 510 displays the received TV-program information display data. FIGS. 5A and 5B are examples of a TV-program list displayed on the monitor 510. Referring to FIG. 5A, TV-program information is displayed on the monitor 510 in a grid pattern. A column 501 displays time information. A column 502 displays a channel name “Channel 1” and TV-programs to be broadcast during time ranges corresponding to the respective times described in the column 501. The monitor 510 shows that, on “Channel 1”, a TV-program “News 9” is broadcast from 9:00 to 10:30, and “Movie AAA” is broadcast from 10:30 to 12:00. As in the case of the column 502, a column 503 displays a channel name “Channel 2” and TV shows to be broadcast during time ranges corresponding to the respective times described in the column 501.

A TV show “Movie BBB” is broadcast from 9:00 to 11:00, and “News 11” is broadcast from 11:00 to 12:00. 530 is a cursor. The cursor 530 moves at the press of the left-cursor 303 or the right-cursor 304 on the front panel 300. When the right-cursor 304 is pressed down in the state illustrated in FIG. 5A the cursor 530 moves towards the right as shown in FIG. 5B. Furthermore, when the left-cursor 303 is pressed down in the state illustrated in FIG. 5B the cursor 530 moves towards the left as shown in FIG. 5A.

When the OK button 305 on the front panel 300 is pressed down in the state shown in FIG. 5A, the TV-program display unit 402a notifies the reproduction unit 402b of the identifier of the “Channel 1”. When the OK button 305 on the front panel 300 is pressed down in the state shown in FIG. 5B, the TV-program display unit 402a notifies the reproduction unit 402b of the identifier of the “Channel 2”.

Furthermore, through the demultiplex unit 205, the TV-program display unit 402a regularly stores in advance, in the second memory 203, TV-program information to be displayed. Generally, it takes time to obtain TV-program information from the broadcast station. It is possible to quickly display a TV-program table by displaying the TV-program information previously stored in the second memory 203, at the press of the EPG button 307 of the input unit 201

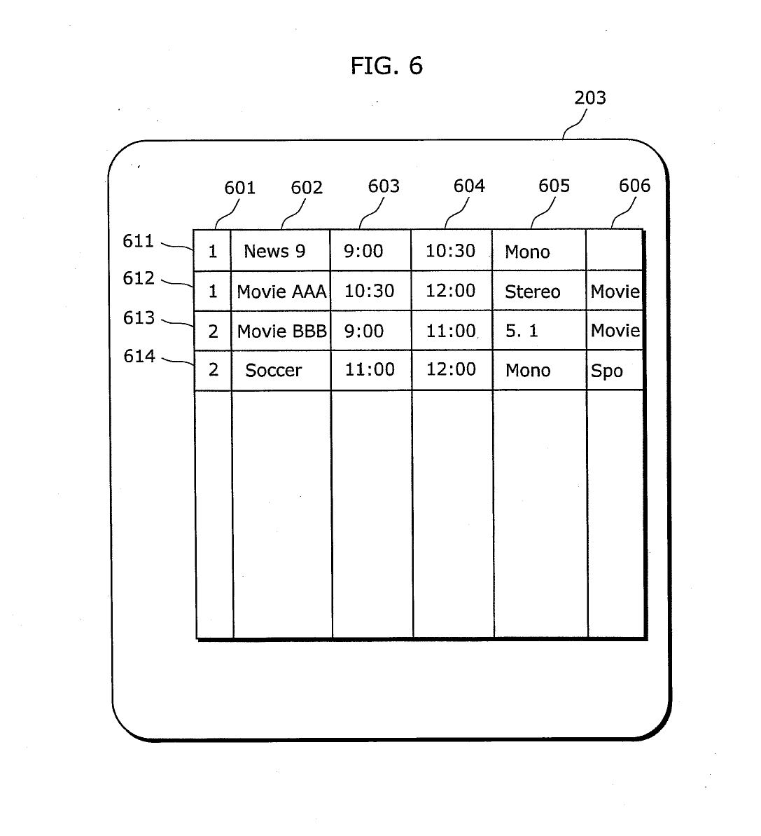

FIG. 6 shows an example of TV-program information stored in the second memory 203. The TV-program information is stored in tabular form. A column 601 describes the identifiers of channels. A column 602 describes TV-program names. A column 603 describes the broadcast start times of the TV-programs, and a column 604 describes the broadcast end times. A column 605 describes the sound type of the TV-programs, and indicates mono sound, stereo sound, and 5.1 channel sound as “mono”, “stereo”, and “5.1”, respectively. A column 606 describes the type of the TV-programs. A regular TV-program is described as an empty cell, a movie is described as “movie”, and a sports program is described as “spo”. Each of rows 611 to 614 describes information for one TV-program. In this example, one TV-program information is the set of the channel identifier, TV-program name, broadcast start time, broadcast end time, and TV-program sound type. For example, the row 611 describes a set which includes “1” as the channel identifier, “news 9” as the TV-program name, “9:00” as the broadcast start time, “10:30” as the broadcast end time, “mono” as the sound-type, and “regular” as the TV-program type.

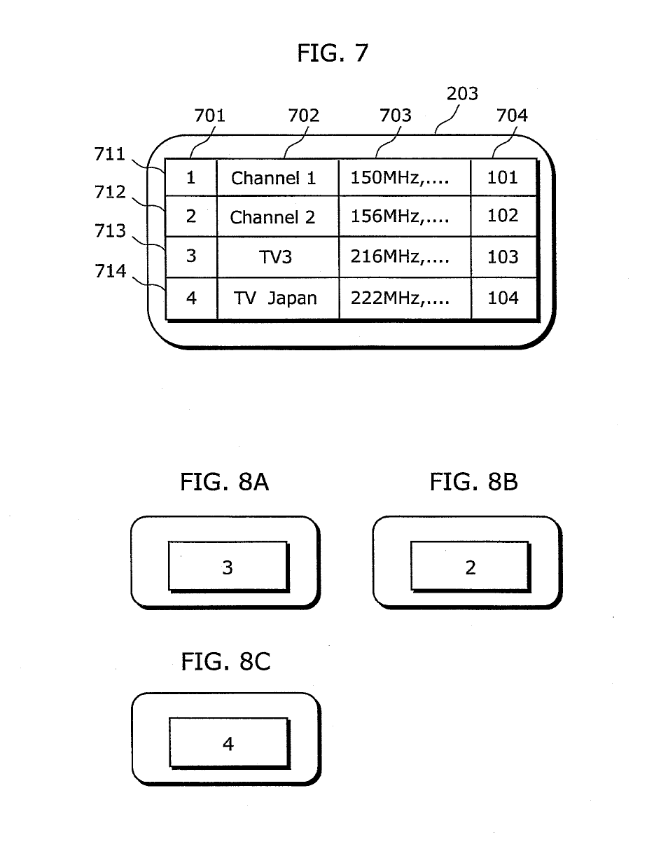

The reproduction unit 402b reproduces a channel using the received identifier of the channel. In other words, it reproduces the video and audio making up the channel. The relationship between channel identifiers and channels is pre-stored in the second memory 203 as channel information. FIG. 7 shows an example of the channel information stored in the second memory 203. The channel information is stored in tabular form. A column 701 describes the identifiers of channels. A column 702 describes is channel names. A column 703 describes tuning information. Here, the tuning information are values to be provided to the receiving unit 204, such as frequency, transmission rate, and coding ratio. A column 704 describes program numbers. Program numbers are numbers used to identify PMTs defined by the MPEG-2 standard. A description about PMT is given later. Each of rows 711 to 714 indicates a set of the identifier, channel name, and tuning information of each channel. The row 711 describes a set that includes “1” as an identifier, “Channel 1” as a channel name, a frequency of “150 MHz” as tuning information, and “101” as a as program number. The reproduction unit 402b passes the received identifier of the channel directly to the service manager 404 in order to reproduce the channel.

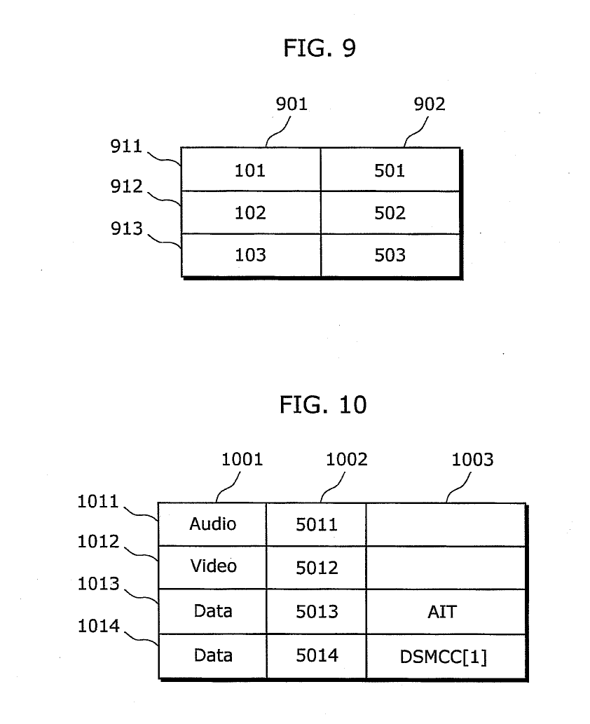

Moreover, when the user presses down the up-cursor 301 or the down-cursor 302 on the front panel 300 while the reproduction is taking place, the reproduction unit 402b receives a notification about such pressing from the input unit 201 through the CPU 212, and changes the channel being reproduced accordingly. When the up-cursor 301 is pressed down, a channel having the next lower channel identifier to that of the currently-reproduced channel is reproduced, and when the down-cursor 302 is pressed down, a channel having the next higher channel identifier to that of the currently-reproduced channel is reproduced. First, the reproduction unit 402b stores, in the second memory 203, the identifier of the channel that is currently reproduced. FIGS. 8A, 8B and 8C show example identifiers of channels stored in the second memory 203. FIG. 8A shows that an identifier “3” is stored, and by referring to FIG. 7, it is shown that a channel having the channel name “TV 3” is currently being reproduced. When the user presses down the up-cursor 301 in a state illustrated in FIG. 8A, the reproduction unit 402b refers to the channel information shown in FIG. 7, and passes the identifier “2” of a channel with the channel is name of “Channel 2” to the service manager 404 in order to switch reproduction to the channel with the channel name of “Channel 2” which is the channel having an identifier that is one value lower than that of the channel currently being reproduced. At the same time, the reproduction unit 402b rewrites the identifier stored in the second memory 203 to the channel identifier “2”. FIG. 8B shows the state in which the channel identifier has been rewritten. Furthermore, when the user presses down the down-cursor 302 in a state illustrated in FIG. 8A, the reproduction unit 402b refers to the channel information shown in FIG. 7, and passes the identifier “4” of as a channel having the channel name of “TV Japan” to the service manager 404 in order to switch reproduction to the channel having the channel name of “TV Japan” which is the channel having an identifier which is one value higher than that of channel currently being reproduced. At the same time, the reproduction unit 402b rewrites the identifier stored in the second memory 203 to the channel identifier “4”. FIG. 8C shows the state in which the channel identifier has been rewritten. The channel identifier is saved, even when power to the multimedia data transmitting apparatus 101 is cut-off, since it is stored in the second memory 203.

In addition, upon being activated when power to the multimedia data transmitting apparatus 101 is turned on, the reproduction unit 402b reads the channel identifier stored in the second memory 203. Then, the reproduction unit 402b passes such channel identifier to the service manager. With this, when power is turned on, the multimedia data transmitting apparatus 101 is able to start the reproduction of the last channel that was being reproduced at the time of its previous operation.

The Java VM 403 is a Java virtual machine that sequentially analyzes and executes programs written in the Java™ language. Programs written in the Java language are compiled into intermediate codes known as byte codes which are not dependent on hardware. A Java virtual machine is an interpreter that executes such byte code. Some Java virtual machines pass the byte code to the CPU 212 after translating the byte code into an execution format which can be interpreted by the CPU 212, and executes it. The Java VM 403 is activated, with a Java program to be executed being specified by the kernel 401a. In the present embodiment, the kernel 401a specifies the service manager 404 as the Java program to be executed. Details of the Java language are described in many publications such as “Java Language Specification (ISBN 0-201-63451-1)”. Here, such details are omitted. Furthermore, the detailed operation of the Java VM itself is described in many publications such as “Java Virtual Machine Specification (ISBN 0-201-63451-X)”. Here, such details are omitted.

The service manager 404, which is a Java program written in the Java language, is sequentially executed by the Java VM 403. It is possible for the service manager 404 to call or be called by another subprogram not written in the Java language, through the Java Native Interface (JNI). The JNI is also described in many publications such as in the book “Java Native Interface” and so on. Here, such details are omitted.

First, the process in the case of receiving a digital broadcast, and reproducing the received multimedia data shall be described.

The service manager 404 accepts the identifier of a channel from the reproduction unit 402b, through the JNI.

The service manager 404 first passes the identifier of the channel to the Tuner 405c in the Java library 405, and requests for tuning. The Tuner 405c refers to the channel information stored in the second memory 203, and obtains the tuning information. Now, when the service manager 404 passes the identifier “2” of the channel to the Tuner 405c, the Tuner 405c refers to the column 712 shown in FIG. 7, and obtains the corresponding tuning information “156 MHz”. The Tuner 405c passes the tuning information to the is receiving unit 204 through tuner 401b1 of the library 401b of the OS 401. The receiving unit 204 performs demodulation on the signal transmitted from the broadcast station, based on the provided tuning information, and passes the result to the demultiplex unit 205.

The service manager 404 requests the CA 405d in the Java library 405 to perform descrambling. The CA 405d provides the descrambler 206 with information required for descrambling, through the condition-release 401b2 of the library 401b in the OS 401. On the basis of such provided information, the descrambler 206 descrambles the signal provided by the receiving unit 204, and passes the result to the TS decoder 207.

The service manager 404 provides the identifier of the channel to a JMF 405a in the Java library 405, and requests for the reproduction of the video and audio.

First, the JMF 405a obtains, from a PAT and a PMT, packet IDs used to specify the video and audio to be reproduced. PAT and PMT are tables stipulated by the MPEG-2 standard that show the TV-program line-up included in an MPEG-2 transport stream. PAT and PMT are embedded in the payloads in packets included in an MPEG-2 transport stream, and sent together with audio and video.

Refer to the Specification for details. Here, only the outline shall be described. PAT, which is an abbreviation of Program Association Table, is stored and sent in packets with the packet ID “0”. In order to obtain the PAT, the IMF 405a specifies, to the demultiplex unit 205, the packet ID “0”, through the library 401b of the OS 401. The demultiplex unit 205 performs filtering based on the packet ID “0” and, by passing the result to the CPU 212, the IMF 405a collects the PAT packets. FIG. 9 is a chart which schematically shows an example of information of the collected PAT. A column 901 describes program numbers. A column 902 describes packet IDs. The packet IDs shown in the column 902 are used to obtain the PMT. Each of rows 911 to 913 is a pair of the program number of a channel and a corresponding packet ID. Here, three channels are defined.

The row 911 defines a pair of the program number “101” and the packet ID “501”. Now, when the channel identifier provided to the JMF 405a is “2”, the JMF 405a refers to the column 912 in FIG. 9, so as to obtain the corresponding program number “102”, and then refers to the column 912 in the PAT shown in FIG. 9, so as to obtain the packet ID “502” corresponding to the program number “102”. PMT, which is an abbreviation of Program Map Table, is stored and sent in packets of the packet ID stipulated in the PAT. In order to as obtain the PMT, the IMF 405a specifies the packet ID to the demultiplex unit 205, through the library 401b of the OS 401. Here, it is assumed that the packet ID specified is “502”. The demultiplex unit 205 performs filtering based on the packet ID “502” and, by passing the result to the CPU 212, the JMF 405a collects the PMT packets. FIG. 10 is a chart which schematically shows an example of information of the collected PMT. A column 1001 describes stream types. A column 1002 describes packet IDs. Information specified in the respective stream types is stored and sent in the payloads of packets with the packet IDs specified in the column 1002. A column 1003 describes supplementary information. Each of columns 1011 to 1014 is a pair of a packet ID and the type of information being transmitted, which is known as an elementary stream. The column 1011, which is a pair of the stream type “audio” and the packet ID “5011”, indicates that audio data is stored in the payload of the packet with the packet ID “5011”. The IMF 405a obtains, from the PMT, the packet IDs of the video and audio to be reproduced. Referring to FIG. 10, the JMF 405a obtains the audio packet ID “5011” from the row 1011, and the video packet ID “5012” from the row 1012.

Next, the JMF 405a passes the obtained audio packet ID and video packet ID to the AV reproduction 401b3 of the library 401b of the OS 401. Upon receiving this, the AV reproduction 401b3 provides the received audio packet ID and video packet ID to the TS decoder 207. The TS decoder 207 performs filtering based on such provided packet IDs. Here, the packet with the packet ID “5011” is passed to the audio output unit 209, and the packet with the packet ID “5012” is passed to the video output unit 208. The audio output unit 209 converts (for example, digital-analog conversion) the provided packet, as necessary, and outputs this. The video output unit 208 converts (for example, digital-analog conversion) the provided packet, as necessary, and outputs this.

Finally, the service manager 404 provides the channel identifier to an AM 405b in the lava library 405, and requests for data broadcast reproduction. Here, data broadcast reproduction refers to extracting a lava program included in the MPEG-2 transport stream, and having it executed by the lava VM 403. As a method of encapsulating a lava program in an MPEG-2 transport stream, a method referred to as DSM-CC, which is described in the MPEG Standard ISO/IEC 13818-6, is used. Here, detailed description of DSM-CC shall be omitted. The DSM-CC defines a method of encoding the file system made up of directories and files used by a computer in the packets of an MPEG-2 transport stream.

Here, the data obtained by the DSM-CC 4051 in the Java library 405 is data encoded according to the ObjectCarousel method which encodes with a data structure having a file structure. Furthermore, information about the Java program to be executed is embedded and sent in packets in the MPEG-2 transport stream in a format referred to as AIT. AIT is an abbreviation of Application Information Table defined in the 10th chapter of the DVB-MHP Standard (formally as, ETS TS101 812 DVB-MHP Specification V1.0.2).

First, in order to obtain the AIT, the AM 405b obtains the PAT and PMT as in the case of the JMF 405a, so as to obtain the packet ID of the packet that stores the AIT. Now, when “2” is the identifier is of the provided channel and the PAT shown in FIG. 9 and the PMT shown in FIG. 10 are being transmitted, the Rec 405j obtains the PMT shown in FIG. 10 according to the same procedure followed by the JMF 405a. The AM 405b extracts, from the PMT, the packet ID of the elementary stream having a stream type of “Data” and which has “AIT” as supplementary information. Referring to FIG. 10, the elementary stream in the row 1013 corresponds to such description, and therefore the AM 405b obtains the packet ID “5013”.

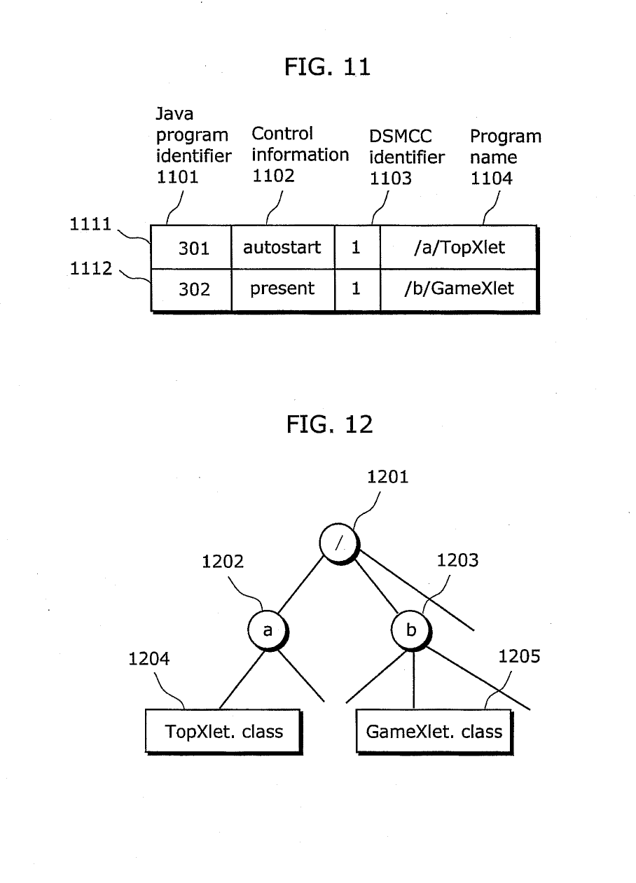

The AM 405b provides the packet ID of the AIT to the demultiplex unit 205, through the library 401b of the OS 401. The a5 demultiplex unit 205 performs filtering based on such provided packet ID, and passes the result to the CPU 212. As a result, the AM 405b can collect the packets of AIT. FIG. 11 is a chart which schematically shows an example of information of the collected AIT. A column 1101 describes the identifiers of Java programs. A column 1102 describes control information of the Java programs. The control information includes “autostart”, “present”, and “kill”. “autostart” means that the multimedia data transmitting apparatus 101 automatically executes the program immediately. “present” means that the program is not executed automatically. “kill” means that the program is to be terminated. A column 1103 describes DSM-CC identifiers for extracting packet IDs including a Java program in the DSM-CC format. A column 1104 describes program names of the Java programs. Each of rows 1111 and 1112 is a set of information about a Java program. The Java program defined in the row 1111 is a set of an identifier “301”, control information “autostart”, a DSM-CC identifier “1”, and a program name “a/TopXlet”. The Java program defined in the row 1112 is a set of an identifier “302”, control information “present”, a DSM-CC identifier “1”, and a program name “b/GameXlet”. Here, the two Java programs have the same DSM-CC identifier which indicates that two Java programs are included within a single file system encoded in the DSM-CC format. Here, only four items of information are stipulated for the respective Java programs, but more items of information are specified in actuality. Refer to the DVB-MHP standard for details.

The AM 405b finds the “autostart” Java program from within the AIT, and extracts the corresponding DSM-CC identifier and Java program name. Referring to FIG. 11, the AM 405b extracts the Java program in the row 1111, and obtains the DSM-CC identifier “1” and the Java program name “a/TopXlet”.

Next, using the DSM-CC identifier obtained from the AIT, the AM 405b obtains, from the PMT, the packet ID of packets that store Java programs in the DSM-CC format. More specifically, the AM 405b obtains, from within the PMT, the packet ID of the elementary stream whose stream type is “Data” and having a matching DSM-CC identifier in the supplementary information.

Now, assuming that such DSM-CC identifier is “1” and the PMT is that shown in FIG. 10, the elementary stream in the row 1014 matches, and the packet ID “5014” is to be extracted.

The AM 405b specifies the packet ID of the packet in which data is embedded in the DSMC format, to the demultiplex unit 205, through the library 401b of the OS 401. Here, the packet ID “5014” is provided. The demultiplex unit 205 performs filtering based on such provided packet ID, and passes the result to the CPU 212. As a result, the AM 405b can collect the required packets. The AM 405b reconstructs the file system from the collected packets, according to the DSM-CC format, and stores this in the first memory 202 or the second memory 203. Extracting the data of a file system, and the like, and storing this in the first memory 202 or the second memory 203 shall hereafter be referred to as download.

FIG. 12 shows an example of a downloaded file system. In the figure, a circle denotes a directory and a square denotes a file. 1201 denotes a root directory, 1202 denotes a directory “a”, 1203 is denotes a directory “b”, 1204 denotes a file “TopXlet.class”, and 1205 denotes a file “GameXlet.class.

Here, although an example of downloading a file system from an MPEG-2 transport stream is described, the OCAP (OpenCable Application Platform) specification, which is a North American digital cable standard, also stipulates downloading using an IP network, and so on. Furthermore, a method for identifying the location of a file system using information referred to as XAIT, instead of AIT, and downloading the file system is also stipulated.

Next, the AM 405 passes, to the Java VM 403, the Java program to be executed from within the file system downloaded into the first memory 202 or the second memory 203. Here, when the name of the Java program to be executed is “a/TopXlet”, the file “a/TopXlet.class”, having “.class” added to the end of the Java program name, is the file to be executed. “/” is a division of a directory and file name and, by referring to FIG. 12, the file 1204 is the Java program to be executed. Next, the AM 405b passes the file 1204 to the Java VM 403.

The Java VM 403 executes the Java program passed to it.

Upon receiving an identifier of an other channel, the service manager 404 terminates the execution, through the respective libraries included in the Java library 405, of the video/audio and Java program currently being reproduced likewise through the respective libraries included in the Java library 405, and performs the reproduction of video/audio and execution of a Java program based on the newly received channel identifier.

Furthermore, the service manager 404 also includes a function for receiving the identifier of a channel from a Java program executed on the Java VM 403, aside from the reproduction unit 402b.

Specifically, a Java language class for obtaining the identifier of the channel, and the method thereof, are provided. Upon receiving an identifier of a channel, the service manager 404 terminates the execution, though the respective libraries included in the Java library 405, of the video/audio and Java program currently being reproduced likewise through the respective libraries included in the Java library 405, and subsequently performs the reproduction of new video/audio and the execution of a Java program based on the newly received channel identifier.

In this manner, the Java program can perform service selection by using the service manager 404. The selection of a service, that is, the operation of performing tuning, video/audio reproduction and Java program activation, according to the received channel identifier, performed by the service manager 404 has been described up to this point.

Next, a method for recording a service, which is the main function of the present invention, and transmitting the recorded service, to the multimedia data receiving apparatus 102, by the multimedia data transmitting apparatus 101 shall be described.

Note that, although the recording of a service is the storing, in a recording region of the second memory 203, of video/audio included in the service, and a Java program included in the service, here, a method for recording data required for reproducing a data broadcast, on the multimedia data receiving apparatus 102 shall be described in particular.

Furthermore, with regard to the transmission to the multimedia data receiving apparatus 102, a method for transmitting data broadcasting association information to the multimedia data receiving apparatus 102, using information generated at the time of service recording as well as recorded data shall be described. Note that, here, the storage region used by multimedia data transmitting apparatus 101 may be a different terminal connected through a method of some kind such as a TCP/IP connection, a USB connection, an IEEE 1394 connection, and an infrared connection.

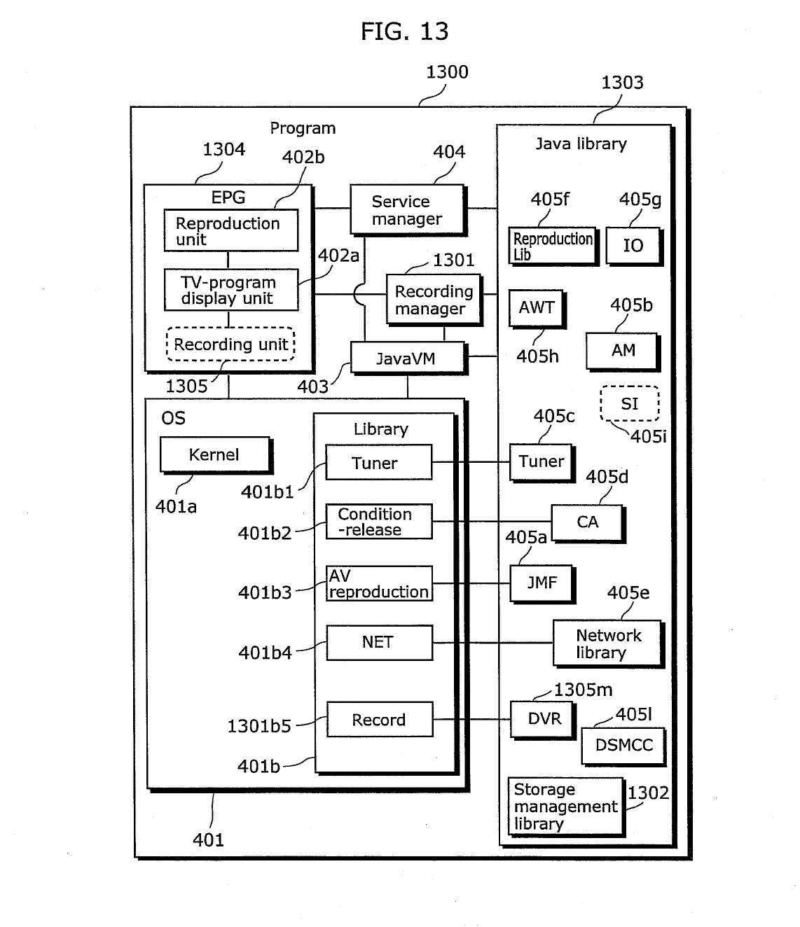

Henceforth, a recording manager 1301 having a function for is recording a service, a DVR 1305m, a storage management library 1302, and a recording library 1301b5, as shown in FIG. 13, are introduced.

FIG. 2 is a diagram showing a general hardware configuration of a digital broadcast receiver provided with a service recording function. With regard to the constituent elements in FIG. 2, description shall be omitted for constituent elements that are not associated with the recording of a service, as well as constituent elements of which processes remain unchanged.

The TS multiplexer 210 generates an MPEG-2 transport stream from received video data, audio data, and section data. At this time, PSI/SI information can be rewritten as necessary. As an example of the rewriting, there are instances where the TS multiplexer 210 rewrites the PAT so as to include information of only specified contents. Subsequently, when transmitting the MPEG-2 transport stream to the multimedia data receiving apparatus 102, the TS multiplexer 210 passes the MPEG-2 transport stream to the network unit 211. Furthermore, when recording the MPEG-2 transport stream on a recording medium such as the second memory 203, the TS multiplexer 210 passes the generated stream to the CPU 212, and the CPU 212 stores the received stream. At this time, in the case where the data is passed in the TS packet format, the MPEG-2 transport stream may be generated by sequentially arranging the received TS packets as they are.

Next, an example of the constituent elements of a program shown in FIG. 13 shall be described. In FIG. 13, constituent elements that are identified with the same numerical reference as in FIG. 4 perform the same processing as in FIG. 4 and, thus, their description shall be omitted.

A program 1300 includes the EPG 1304, the recording manager 1301, and a Java library 1303. In addition, the EPG 1304 includes a recording unit 1305; the library 401b includes the recording library 1301b5; and the Java library 1303 includes the DVR 1305m and the storage management library 1302.

In the case where the user issues a recording request with respect to EPG information displayed by the TV-program display unit 402a, the recording unit 1305 of the EPG 1304 obtains the channel identifier identifying the channel for which the user has requested a scheduled recording. The recording unit 1305 passes the channel identifier directly to the recording manager 1301, in order to record a content.

The recording library 1301b5 records, on a recording medium such as the second memory 203, multimedia data specified by the DVR 1305m.

The DVR 1305m of the Java library requests, to the recording library 1301b5, the recording request of the content specified by the recording manager 1301.

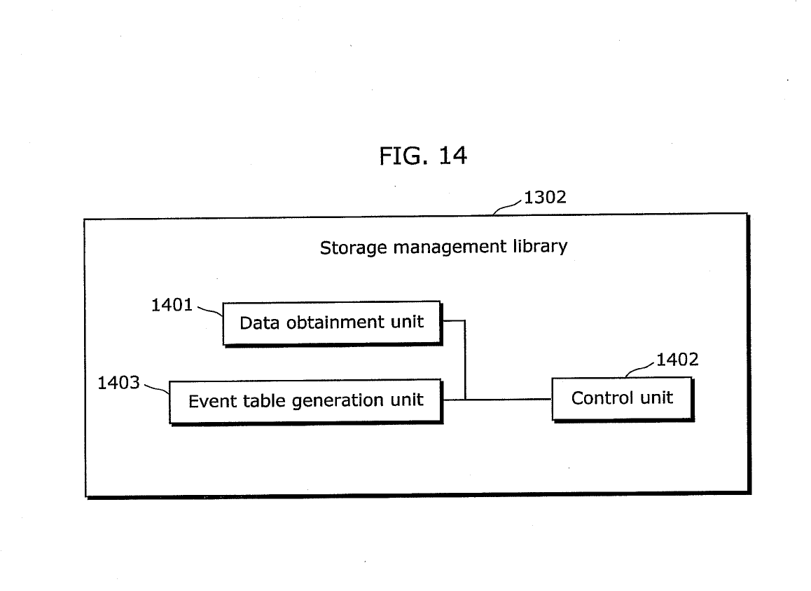

FIG. 14 shows the configuration of the storage management library 1302. The storage management library 1302 includes a data obtainment unit 1401, a control unit 1402, and an event table generation unit 1403.

The data obtainment unit 1401 of the storage management library 1302 has the functions for: obtaining, from among information required for implementing a data broadcast, an event that influences the data broadcast, as a trigger for receiving the section in particular; storing the event in the second memory 203; and at the same time notifying the event table generation unit 1403 which manages events.

The control unit 1402 of the storage management library 1302 manages the management table, the storage location and required data for respective data stored in the second memory 203.

The event table generation unit 1403 of the storage management library 1302 has a function for generating an event table, using the information and timing notified by the data obtainment unit 1401.

The detailed recording method, management method, obtainment method for respecting data, used for the storage management library 1302, and required data such as a time stamp are described later.

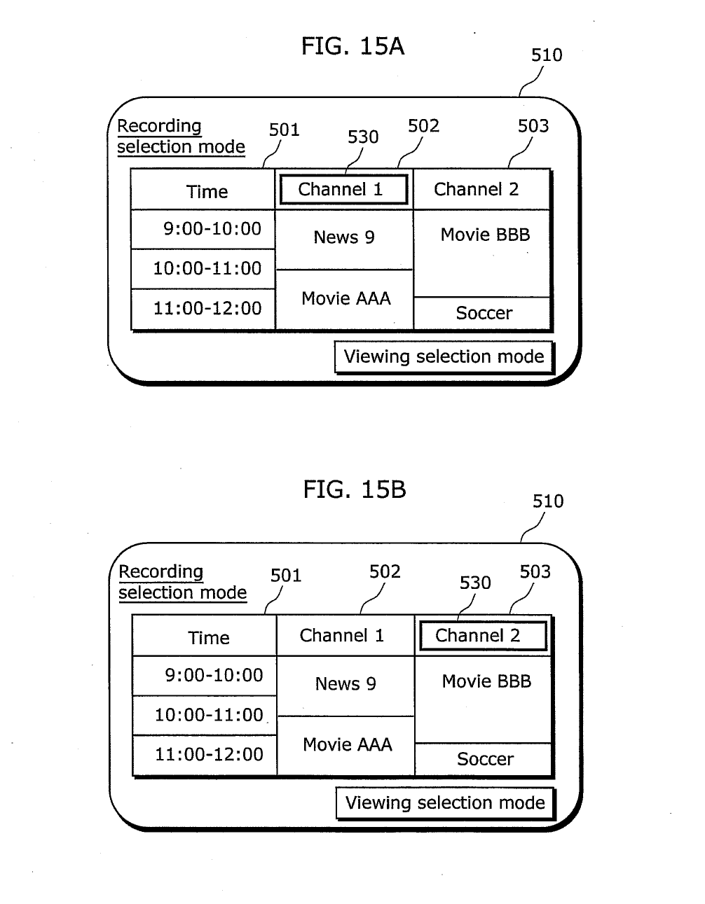

The EPG 1304 includes, in addition to the configuration of the EPG 402, the recording unit 1305 which performs recording of a specified channel (service Record), according to an input by the user received by the TV-program display unit. FIGS. 15A and 15B show an example of a TV-program table displayed on a monitor by the TV-program display unit 402a of the EPG 1304 which is a subprogram operating on the CPU 212, when the EPG button 307 of the input unit 201 is pressed down by the user. Since the EPG 1304 includes a channel selection function and a channel recording function, the TV-program display unit 402a is assumed to provide, for example, a recording selection mode and a viewing selection mode. FIGS. 15A and 15B are assumed to show a screen providing the recording selection mode. In FIGS. 15A and 15B, constituent elements affixed with the same numerical reference as in the case of FIGS. 5A and 5B have the same functions as in the case of FIGS. 5A and 5B, and their description shall be omitted.

When the OK button 305 on the front panel 300 is pressed down in the state shown in FIG. 15A, the TV-program display unit 402a notifies the DVR 1305m of the channel identifier of the “Channel 1”. When the OK button 305 on the front panel 300 is pressed down in the state shown in FIG. 15B, the TV-program display unit 402a notifies the DVR 1305m of the channel identifier of the “Channel 2”. Here, in a digital broadcast receiver provided with service recording and reproduction functions, the channel identifier is an identifier that uniquely identifies one service from the services transmitted from the broadcast station and the services stored in a recording medium such as the second memory 203.

The DVR 1305m records a content, using the received channel identifier. The relationship between the channel identifier and the channel is as described earlier with reference to FIG. 7. The DVR 1305m passes the received channel identifier directly to the recording manager 1301, in order to record the channel.

The lava VM 403 specifies the recording manager 1301 as the Java program to be executed, at the time of service recording (channel recording).

The recording manager 1301, which is a lava program written in the Java language, is sequentially executed by the lava VM 403. It is possible for the recording manager 1301 to call or be called by another subprogram not written in the lava language, through the Java Native Interface (JNI).

The recording manager 1301 receives the channel identifier from the DVR 1305m, through the JNI.

The recording manager 1301 first passes the channel identifier to the Tuner 405c in the Java library 405, and requests for tuning. Here, the processing by the Tuner 405c in the case where tuning is requested by the recording manager 1301 at the time of service recording is the same as the processing in the case where tuning is requested by the service manager 404 at the time of service selection, and thus description shall be omitted.

Next, the recording manager 1301 requests descrambling to the CA 405d. Here, the processing by the CA 405d in the case where descrambling is requested by the recording manager 1301 at the time of service recording is the same as the processing in the case where descrambling is requested by the service manager 404 at the time of service selection, and thus description shall be omitted.

Note that, when requested by the recording manager 1301 to perform descrambling, the CA 405d may adopt a method in which cryptography of a unique format is applied after descrambling, and the like.

Note that it is also acceptable to adopt a method in which, at the time of recording, the recording is performed without the descrambling by the CA 405d, with descrambling being performed at the time of reproduction.

Note that the present invention can be implemented regardless of whether or not there is a descrambling request from the recording manager 1301 to the CA 405d.

Next, the recording manager 1301 provides the channel identifier to the DVR 1305m in the Java library 1303, and requests the recording of video/audio.

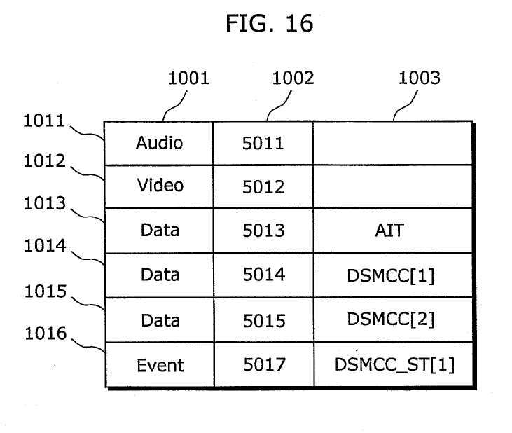

First, the DVR 1305m obtains, from the PAT, PMT, the PID for identifying the video and audio to be recorded. In order to obtain the PAT, the DVR 1305m specifies, to the demultiplex unit 205, the PID “0” and the table_id “0”, through the library 401b of the OS 401. The demultiplex unit 205 performs filtering based on the PID “0” and the table_id “0” and, by passing the result to the CPU 212 through the first memory 202, the DVR 1305m collects the PAT. Here, FIG. 9 is given as an example of the PAT. Now, when the channel identifier provided to the DVR 1305m is “1”, the DVR 1305m refers to the row 711 in FIG. 7, so as to obtain the corresponding program number “101”, and then refers to the row 911 in the PAT shown in FIG. 9, so as to obtain the PID “501” corresponding to the program number “101”. In order to obtain the PMT, the DVR 1305m specifies the PID obtained from the PAT and the table_id “2”, to the demultiplex unit 205 through the library 401b of the OS 401. Here, the specified PID is assumed to be “501”. The demultiplex unit 205 performs filtering based on the PID “501” and the table_id “2” and, by passing the result to the CPU 212 through the first memory 202, the DVR 1305m collects the PMT. Here, FIG. 16 is given as an example of the PMT. Here, the constituent elements in FIG. 16 that are the same as those in FIG. 10 are affixed with the same numerical reference and their description shall be omitted. In FIG. 16, the ES indicated in row 1015 is an ES which transmits a section for data, and is constructed from TS packets having a PID of 5015, and added information of DSM-CC “2” (DSM-CC identifier is 2). Note that the ES indicated in row 1016 in FIG. 16 is constructed from TS packets having supplemental information of a stream type “event” and a DSM-CC stream event “DSM-CC_ST [1]”. The DVR 1305m obtains, from the PMT, the PIDs of the video and audio to be recorded. Referring to FIG. 16, the DVR 1305m obtains the audio PID “5011” from the row 1011, and the video PID “5012” from the row 1012.

Next, the DVR 1305m provides the obtained video/audio PIDs to the TS decoder 207 through the library 401b of the OS 401. The TS decoder 207 performs filtering based on the provided PIDs. Here the PES packets of the PIDs “5011” and “5012” are passed to the TS multiplexer 210. Note that the PES packets may be re-encoded, as necessary, prior to being passed to the TS multiplexer 210. The TS multiplexer 210 generates an MPEG-2 transport stream from received video data, audio data, and section data. Note that PSI/SI information can be rewritten as necessary.

As an example of the rewriting, there are instances where the TS multiplexer 210 rewrites the PAT so as to include information of only specified contents. Furthermore, the TS multiplexer 210 may generate an MPEG-2 transport stream that includes data matching the conditions of the specified PID and table_id. The MPEG-2 transport stream for recording that is generated by the TS multiplexer 210 is stored in the second memory 203. Furthermore, the TS multiplexer 210 may, in the case where the data is passed in the TS packet format, generate the MPEG-2 transport stream by sequentially arranging the received TS packets as they are.

Note that, here, the present invention can be implemented even when: the storage management library 1302 is assumed to be provided with a function for storing, in the second memory 203, the is MPEG-2 transport stream for recording, in association with the identifier of the stream; and the DVR 1305m stores the MPEG-2 transport stream for recording in the second memory 203 by passing, to the control unit 1402 of the storage management library 1302, the channel identifier specified by the recording manager 1301 and the MPEG-2 transport stream for recording, and requesting the storing of the MPEG-2 transport stream for recording in the second memory 203.

Lastly, the recording manager 1301 provides the channel identifier to the control unit 1402 of the storage management library as 1302 in the lava library 1303, and requests the storing of the data broadcast. Here, the storing of the data broadcast is the extraction, from an MPEG-2 transport stream, of data for data broadcasting required for implementing reproduction of a data broadcast, and the storing of the extracted data for data broadcasting into the second memory 203, performed by the multimedia data receiving apparatus 102 which is a client connected to the network.

The data broadcasting association information required for implementing the reproduction of the data broadcast by the multimedia data receiving apparatus 102 include event information associated with the timing of the data broadcast, and data for data broadcasting which is information required for obtaining/constructing actual data. Among these, since the event associated with the data broadcast involves timing, it needs to be notified to the client before the phenomenon of such event occurs. As an example of data broadcast-associated events, information for detecting the event, and the details of the information are shown below.

Updating-associated information for data broadcasting association information

| | Detected | |
|---|---|---|
| Event | information | Details |
| Module | Module Version up | When version up of a DII |
| update | | section including structure |
| | | information of a carousel |
| | | stipulated by the DSMCC |
| | | Standard occurs, the Module (*1) |
| | | in which the version up |
| | | has occurred can be detected |
| | | by finding, among modules |
| | | included in the DII section, the |
| | | module of which version has |
| | | changed. |
| Carousel | DSI Version up | In the case where there is a |
| disable | | version up of a DSI section |
| | | including structure information |
| | | of a carousel stipulated by the |
| | | DSMCC Standard, it is judged |
| | | that the carousel has become |
| | | invalid. |
| Stream | PAT/PMT Version | In the case where version up of |
| information | up | PAT or PMT occurs, and a |
| update | | change occurs in the stream |
| | | transmitting the carousel, it is |
| | | judged that the carousel has |
| | | become invalid. |
| AIT update | AIT Version up | When version up of the |
| | | previously described AIT |
| | | occurs, and the control |
| | | information (col. 1102 in FIG. |
| | | 11) corresponding to the |
| | | application requesting the |
| | | downloading of the carousel |
| | | changes to “Kill”, it is judged |
| | | that the request for obtaining |
| | | the carousel has ended. |

(*1): In the case where version up of the Module occurs, it is assumed that version up has occurred in any or all of the objects included in such Module.

Time information and timing information of the data for data broadcasting

| | Information | |
|---|---|---|
| | detected by | |
| Notified | transmitting | |
| item | apparatus | Details |
| NPT | NPT Reference | Record the timing at which the |
| changed | Descriptor | following status changes for |
| | | the NPT Reference Descriptor |
| | | occur. |
| | | A change in the speed |
| | | (=scale Numerator/scale |
| | | Denominator) at which the |
| | | NPT Reference Descriptor |
| | | transmits an NPT |
| | | The timing at which |
| | | receiving of the NTP |
| | | Reference Descriptor stops |
| | | The timing at which the |
| | | NPT Reference Descriptor |
| | | re-appears |
| Stream | Stream Event | Receive Stream Event |
| Event | Descriptor | Descriptor |

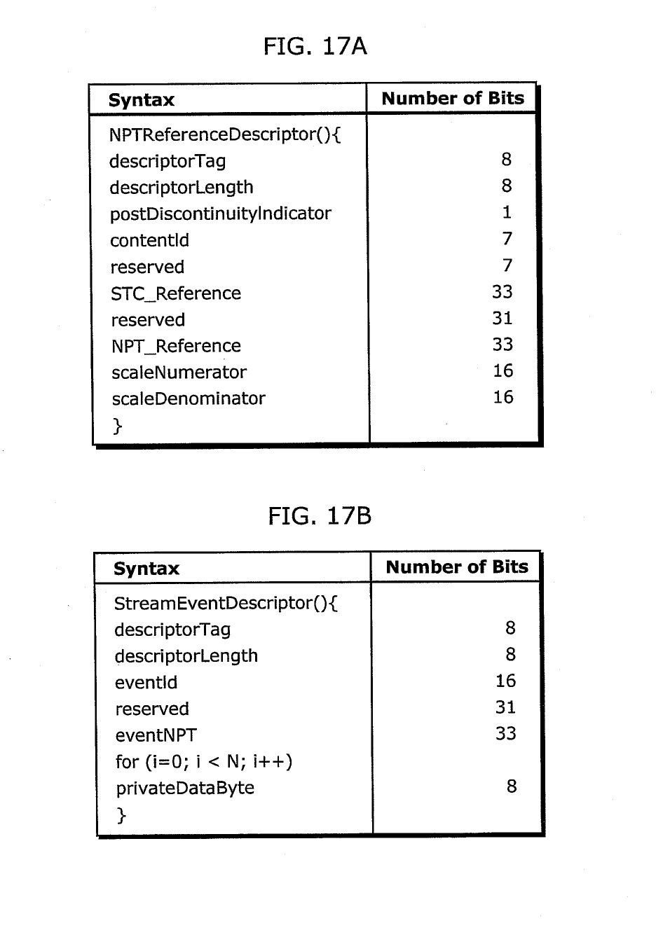

FIG. 17A shows the information transmitted by the NPT Reference Descriptor. Furthermore, FIG. 17B shows the information transmitted by the Stream Event Descriptor. Note that the section in which these are transmitted is called a DSM-CC stream section.

The NPT Reference Descriptor notifies a time identified by a contentID and the speed for that time. The time of the NPT can be obtained from the values of an NPT_Reference, an STC_Reference, and an STC of the terminal, and the increment at which the time is advanced can be known as the speed at which the time ticks by calculating scale Numerator/scale Denominator.

Meanwhile, the Stream Event Descriptor notifies, through an eventNPT, the timing at which to notify an event identified by an eventID.

These Descriptors are used in the implementation of a data broadcast that is synchronized with AV. For example, in a quiz TV-program, “the motions of an emcee to be displayed on a monitor through video/audio” and “the answer delivered through a data broadcast” are synchronized and displayed on the monitor. In order to implement such a data broadcast TV-program, the broadcast station delivers the application to be operated together with the quiz TV-program, as well as data used by the application, and delivers, through the NPT Reference Descriptor, the time information with which the quiz TV-program runs. Then, by notifying the timing in which the answers are required in the quiz TV-program, through a Stream Event Descriptor, the receiving apparatus receiving the broadcast signal can notify such timing to the application, together with the eventID identifying the event. Through the displaying of the data on the monitor by the application receiving such an event, data broadcasting that is synchronized with video/audio can be implemented. Note that Steam Event Descriptors include a “Scheduled Event” notifying an NPT time for issuing an event as that previously described, and a “do it now” event which requests immediate issuance of an event at the timing of its receipt. Refer to the DSM-CC standard for details.

With regard to event data as that described above, data obtained by the data obtainment unit 1401 based on the PID set by the control unit 1402 is managed through the generation of an event table by the event table generation unit 1403.

(Event Table Generation on the Multimedia Data Transmitting Apparatus 101)

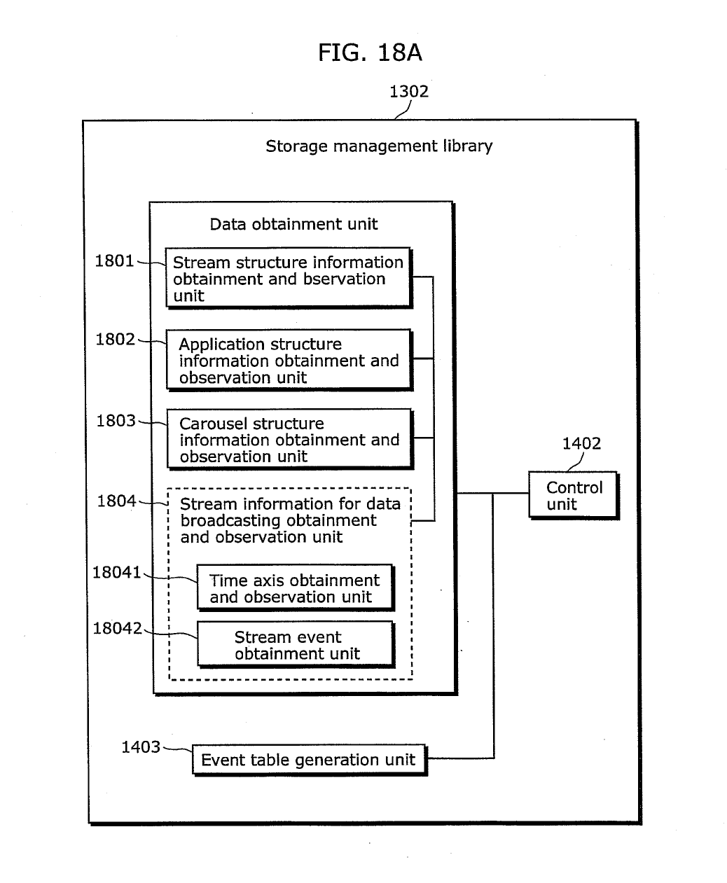

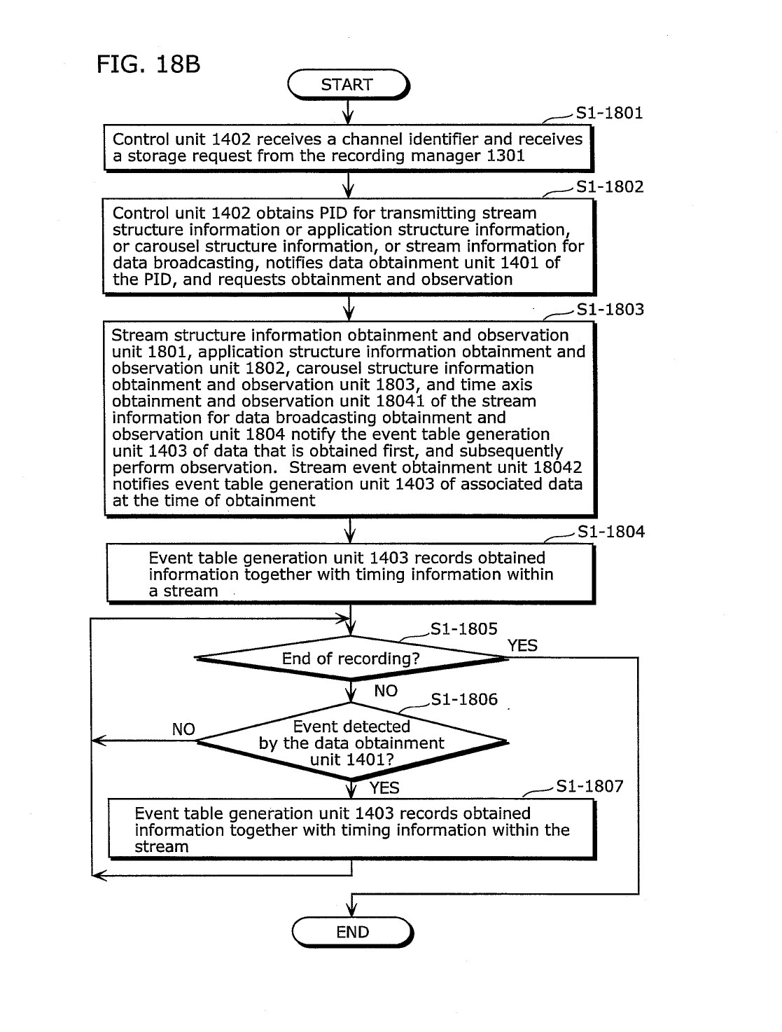

Here, the detailed recording method, management method, obtainment method process of respective data of the storage management library 1302 of the multimedia data transmitting apparatus 101 shall be described. The control unit 1402 obtains and sets, to the data obtainment unit 1401, the PID of the elementary stream carrying the Download Server Initiate (DSI) and Download Info Indication (DII) which are the PAT, PMT, AIT, and DSM-CC sections, as well as the PID of the elementary stream carrying the DSM-CC stream section. Note that FIG. 18A shows a configuration diagram of the data obtainment unit 1401. The data obtainment unit 1401 includes a stream structure information obtainment and observation unit 1801, an application structure information obtainment and observation unit 1802, a carousel structure information obtainment and observation unit 1803, and a stream information for data broadcasting obtainment and observation unit 1804. The respective constituent elements shall be described later. Note that although the main processes in the respective processes shall be described later, the main process by the storage management library is described in FIG. 18B. The control unit 1402 of the storage management library 1302 receives a channel identifier and receives a storage request from the recording manager 1301 (S1-1801). The control unit 1402 obtains is the PID for transmitting stream structure information or application structure information, or carousel structure information, or stream information for data broadcasting, notifies the PID to the data obtainment unit 1401, and requests obtainment and observation (S1-1802). The stream structure information obtainment and observation unit 1801, the application structure information obtainment and observation unit 1802, the carousel structure information obtainment and observation unit 1803, and a time axis obtainment and observation unit 18041 of the stream information for data broadcasting obtainment and observation unit 1804, of the as data obtainment unit 1401, notify the event table generation unit 1403 of the data that is obtained first, and subsequently perform observation. A stream event obtainment unit 18042 notifies the event table generation unit 1403 of associated data at the time of obtainment (S1-1803). The event table generation unit 1403 records the obtained information, together with the timing information within a stream (S1-1804). In the data obtainment unit 1401, event detection is observed (S1-1806), and repeated until the end of recording (S1-1805). Note that, when an event is detected in the observation of event detection (S1-1806), the event table generation unit 1403 records the obtained information together with the timing information within the stream (S1-1807). At this point, event table generation is carried out. Details of each process are described below.

Now, when “1” is the identifier of the provided channel and the PAT shown in FIG. 9 and the PMT shown in FIG. 16 are being transmitted, the control unit 1402 obtains the PID “501” of the PMT based on the provided channel identifier, in the same manner as the IMF 405a and the DVR 1305m. Here, the control unit 1402 passes, to the stream structure information obtainment and observation unit 1801 of the data obtainment unit 1401, a PID “0” of the PAT and a PID “501” of the PMT.

Next, in order to obtain the PID of the AIT, the control unit 1402 obtains the PMT in FIG. 16, in the same manner as the JMF 405a. The control unit 1402 of the storage management library 1302 extracts, from the PMT, the PID of the elementary stream having a stream type of “Data” and which has “AIT” as supplementary information. Referring to FIG. 16, the elementary stream in the row 1013 corresponds to such description, and therefore the PID “5013” is obtained. Here, the control unit 1402 passes the PID “5013” of the AIT, to the application structure information obtainment and observation unit 1802 of the data obtainment unit 1401.

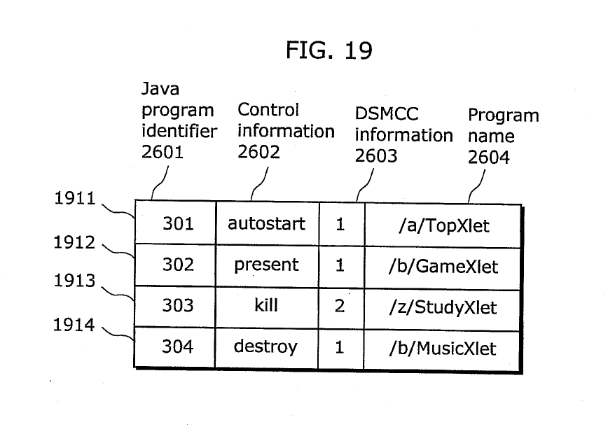

Next, in order to obtain the PIDs of the DSI and DII of the DSM-CC section, the control unit 1402 of the storage management library 1302, provides the PID of the AIT and the table_id “0x74” to the TS decoder 207, through the library 401b of the OS 401. The TS decoder 207 performs filtering based on such provided PID and table_id, and passes the result to the CPU 212 through the first memory 202. As a result, the storage management library 1302 can collect the AIT. FIG. 19 schematically shows an example of the collected AIT information. The constituent elements in FIG. 19 that are the same as those in FIG. 11 are affixed with the same numerical reference and their description shall be omitted. Row 1911 to row 1914 denote sets of information on the Java program. The Java program defined in the row 1911 is a set of a Java program identifier “301”, control information “autostart”, a DSM-CC identifier “1”, and a program name “a/TopXlet”. The Java program defined in the row 1912 is a set of a Java program identifier “302”, control information “present”, a DSM-CC identifier “1”, and a program name “b/GameXlet”. The Java program defined in the row 1913 is a set of a Java program identifier “303”, control information “kill”, a DSM-CC identifier “2”, and a program name “z/StudyXlet”. The Java program defined in the row 1914 is a set of a Java program identifier “304”, control information “destroy”, a DSM-CC identifier “1”, and a program name “b/MusicXlet”. Next, the control unit 1402 of the storage management library 1302 finds all the Java programs described in the AIT, and extracts the corresponding DSM-CC identifiers. Referring to FIG. 19, the storage management library 1302 extracts the Java program in the row 1911, the Java program in the row 1912, the Java program in the row 1913, and the Java program in the row 1914, and obtains the DSM-CC identifier “1” and the DSM-CC identifier “2”. Next, using the DSM-CC identifier obtained from the AIT, the control unit 1402 of the storage management library 1302 obtains, from the PMT, the PID of TS packets that store data for data broadcasting such as Java programs in the DSM-CC format. More specifically, the control unit 1402 obtains, from within the PMT, the PID of the elementary stream whose stream type is “Data” and having matching DSM-CC identifiers in the supplementary information. Now, assuming that such DSM-CC identifiers are “1” and “2” and the PMT is that shown in FIG. 16, the elementary streams in the row 1014 and the row 1015 match, and the PID “5014” and “5015” are extracted. Here, the control unit 1402 passes, to the carousel structure information obtainment and observation unit 1803 of the data obtainment unit 1401, the PIDs “5014” and “5015” for transmitting the DSM-CC sections.

The control unit 1402 obtains the PMT, and obtains the PID “5017” of the elementary stream having a supplementary information of a stream type “event” (StreamType=0C) indicated in the row 1016 in FIG. 16, and which is constructed from TS packets to of DSM-CC stream event “DSM-CC ST [1]”. Here, the control unit 1402 passes, to the stream information for data broadcasting obtainment and observation unit 1804 of the data obtainment unit 1401, the PID “5017” for transmitting the DSM-CC sections.

Next, the constituent elements of the data obtainment unit 1401 of the storage management library 1302 shall be described. FIG. 18A shows the constituent elements of the data obtainment unit 1401. In FIG. 18A, 1801 denotes the stream structure information obtainment and observation unit, 1802 denotes the application structure information obtainment and observation unit, 1803 denotes the carousel structure information obtainment and observation unit, 1804 denotes the stream information for data broadcasting obtainment and observation unit, 18041 denotes the time axis obtainment and observation unit in the stream information for data broadcasting obtainment and observation unit 1804, and 18042 denotes the stream event obtainment unit in the stream information for data broadcasting obtainment and observation unit 1804.

The stream structure information obtainment and observation unit 1801 obtains and records, on the second memory 203, the PAT and PMT at the start of service recording, and observes for version up of the recorded PAT and PMT during the service recording.

Furthermore, the stream structure information obtainment and observation unit 1801 notifies the referencing to the PAT and PMT recorded at the start of the service recording, to event table generation unit 1403. Furthermore, in the case where version up occurs, the stream structure information obtainment and observation unit 1801 notifies this fact to the event table generation unit 1403. Here, although a method in which information which indicates the occurrence of version up, and the version number thereof are notified as the information notified to the event table generation unit 1403, and the version-upped table is recorded on to the second memory 203 shall be described, aside from this, it is also acceptable to adopt a method which notifies details that have changed due to the version up, or a method which notifies the version-upped section itself or information equivalent to it.

The application structure information obtainment and is observation unit 1802 obtains and records, on the second memory 203, the AIT at the start of service recording, and observes for version up of the recorded AIT during the service recording.

Furthermore, the application structure information obtainment and observation unit 1802 notifies the referencing to the AIT recorded at the start of the service recording, to event table generation unit 1403. In addition, in the case where version up occurs, the application structure information obtainment and observation unit 1802 notifies this fact to the event table generation unit 1403.

Here, although a method in which information which indicates the occurrence of version up, and the version number thereof are notified as the information notified to the event table generation unit 1403, and the version-upped table is recorded on the second memory 203 shall be described, aside from this, it is also acceptable to adopt a method which notifies details that have changed due to the version up, or a method which notifies the version-upped section itself or information equivalent to it.

The carousel structure information obtainment and observation unit 1803 obtains and records, on the second memory 203, the DSI and DII at the start of data broadcast obtainment following the start of service recording, and observes for version up of the recorded DSI and DII during the service recording. Furthermore, the carousel structure information obtainment and observation unit 1803 notifies the referencing to the DSI and DII recorded at the start of the service recording, to event table generation unit 1403. In addition, in the case where version up occurs, the carousel structure information obtainment and observation unit 1803 notifies this fact to the event table generation unit 1403. Here, although a method in which information which indicates the occurrence of version up, and a Transaction ID including version information of the DSI and DII are notified as the information notified to the event table generation unit 1403, and the version-upped table is recorded on the second memory 203 shall be described, aside from this, it is also acceptable to adopt a method which notifies details that have changed due to the version up, or a method which notifies the version-upped section itself or information equivalent to it.

The stream information for data broadcasting obtainment and observation unit 1804 obtains a section carrying a DSM-CC stream descriptor transmitted with a table_id=“3D”, from an elementary stream having supplementary information of stream type “event” (StreamType=0C) in the same PMT at the start of service recording. In addition, in the case when the obtained DSM-CC stream section carries an NPT Reference Descriptor, the stream information for data broadcasting obtainment and observation unit 1804 passes the section to the time axis obtainment and observation unit 18041. Furthermore, in the case where the DSM-CC stream section is transmitting a Stream Event Descriptor, stream information for data broadcasting obtainment and observation unit 1804 passes the stream to the stream event obtainment unit 18042.

The time axis obtainment and observation unit 18041 notifies the event table generation unit 1403 when a change occurs in the time axis speed (=scaleNumerator/scaleDenominator) called NPT transmitted by the NPT Reference Descriptor. In addition, although the NPT Reference Descriptor is encoded into a broadcast stream at a fixed interval, in the case where the timing of the stopping of the reception of the NPT Reference Descriptor, or its reception once again, is detected, the time axis obtainment and observation unit 18041 notifies this fact to the event table generation unit 1403. Here, a method is described in which, as the information notified to the event table generation unit 1403 when the speed of the NPT changes, information identifying change in the speed of the NPT (assumed here as an NPTSpeedChange flag) is notified, and a ContentID identifying the changed NPT time, a scaleNumerator and is scaleDenominator that indicate speed information of the changed NPT, and an NPT time at which the event is received are notified. However, a method that notifies an NPT_Reference and STC_Reference that are used for obtaining the NPT time, instead of the NPT time, may also be adopted. Furthermore, as another method, it is also acceptable to adopt a method that notifies the event table generation unit 1403 of only information on the changing of the speed, and a ContentID identifying the changed NPT time and records, and records, on the second memory 203, the table whose speed of the NPT changed. Furthermore, when reception of the NPT Reference Descriptor steps, the time axis obtainment and observation unit 18041 notifies the event table generation unit 1403 of information identifying the stoppage of the reception of the NPT Reference Descriptor (assumed here as an NPTDiscontinuity flag), and the ContentID identifying the changed NPT time. In addition, when the reception of the NPT Reference Descriptor is re-started, it is also acceptable to adopt a method that notifies: a ContentID identifying the re-started NPT time; the NPT_Reference and STC_Reference required for obtaining the NPT time; and NPT speed information, or a method that notifies information indicating the re-starting of the reception of the NPT Reference Descriptor, and a ContentID identifying the NPT time, and records the table whose speed of the NPT changed, on the second memory 203.

When a Stream Event Descriptor is received, the stream event obtainment unit 18042 always notifies this to the event table generation unit 1403. At this time, the event table generation unit 1403 notifies the event table generation unit 1403 of: information indicating whether the obtained event is transmitting either a “do it now” event or a “Scheduled event”; an eventID identifying the DSM-CC stream event transmitted by the Stream Event Descriptor; and an eventNPT which is an NPT time for issuing the stream event. Alternatively, it is also acceptable to adopt a method that notifies the event table generation unit 1403 of only: the information indicating whether the obtained event is transmitting either a “do it now” event or a “Scheduled event”; and the eventID identifying the DSM-CC stream event transmitted by the Stream Event Descriptor, and records, on the second memory 203, a table that transmits such Stream Event Descriptor.

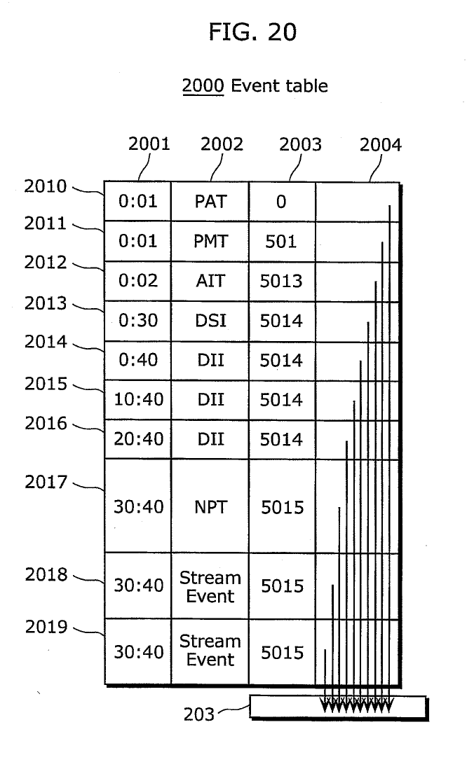

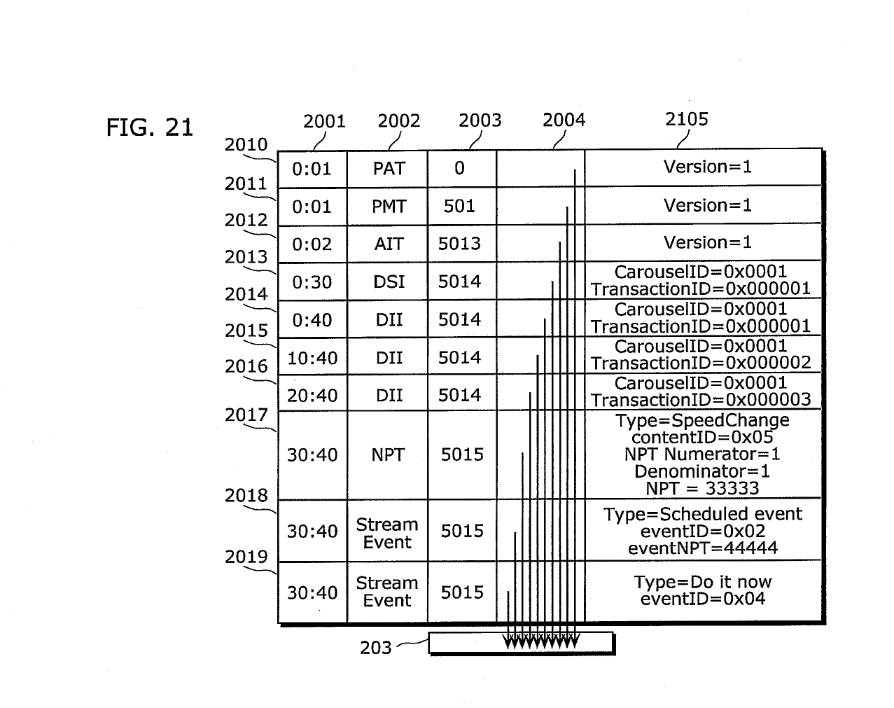

The event table generation unit 1403 records the timings, and information of the timings, from the stream structure information obtainment and observation unit 1801, the application structure information obtainment and observation unit 1802, the carousel structure information obtainment and observation unit 1803, notified by the stream information for data broadcasting obtainment and observation unit 1804. An example of the event table generated by the event table generation unit 1403 is shown in FIG. 20 and FIG. 21. Note that although, here, a method is described that records a time of 0 (called media time here) for the start of service recording, as the timing for recording, other information is also acceptable as long as it is information that can identify the timing at which notification is received from the stream structure information obtainment and observation unit 1801, the application structure information obtainment and observation unit 1802, the carousel structure information obtainment and observation unit 1803, and the stream information for data broadcasting obtainment and observation unit 1804, that is, the timing at which version up, and the like, occurs. In addition, hereinafter, when description is made regarding media time, other information, such as Byte position indicated by the data amount from the stream start position, or NPT (NormalPlayTime) are also acceptable as long as it is information that can identify timing at all times.

Next, FIG. 20 shows an example of an event table managed by the data management unit 1402 of the storage management library 1302. In FIG. 20, 2000 represents an event table. A column 2001 denotes the time at which a notification is received from the stream structure information obtainment and observation unit 1801, the application structure information obtainment and observation unit 1802, the carousel structure information obtainment and observation unit 1803, and the stream information for data broadcasting obtainment and observation unit 1804 (as an example, the column 2001 is the media time). Next, 2002 denotes the identifier of an event. Note that the PAT and PMT are used as information identifying the detection, by the stream structure information obtainment and observation unit 1801, of a version up of the PAT and PMT. Furthermore, AIT is used as information identifying the detection, by the application structure information obtainment and observation unit 1802, of a version up of the AIT. Furthermore, DSI and DII are used as information identifying the detection, by the carousel structure information obtainment and observation unit 1803, of a version up of the DSI and DII. Furthermore, NPT is used as information identifying information through which the time axis obtainment and observation unit 18041 of the stream information for data broadcasting obtainment and observation unit 1804 notifies a change of the speed of the NPT time, as well as the discontinuity, and restart of reception, of the section carrying the NPT time; and StreamEvent is used as information identifying the reception of Stream Event Descriptor by the stream event obtainment unit 18042 of the stream information for data broadcasting obtainment and observation unit 1804. 2003 denotes the PID at which the occurrence of each event is discovered. 2004 denotes the storage location of each section (for example, address information of the second memory indicating a beginning position of data corresponding to the section). Furthermore, a column 2105 in FIG. 21 indicates added information at the time notification of each event is received from the stream structure information obtainment and observation unit 1801, the application structure information obtainment and observation unit 1802, the carousel structure information obtainment and observation unit 1803, and the stream information for data broadcasting obtainment and observation unit 1804.

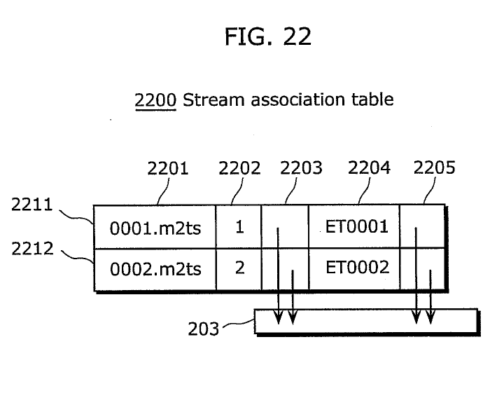

FIG. 22 shows an example of the recorded stream and the association with the event table, and the stream and the storage location in the event table. In FIG. 22, 2200 represents a stream association table. Furthermore, a column 2201 denotes an identifier such as the name of the recorded stream. A column 2202 denotes a channel identifier including the recorded stream. A column 2203 denotes the storage location of the recorded stream (for example, address information of the second memory indicating a beginning position of data corresponding to the recorded stream). A column 2204 denotes an identifier such as a name of an associated event table; a column 2205 denotes the storage location of the event table (for example, address information of the second memory indicating a beginning position of data corresponding to the event table).

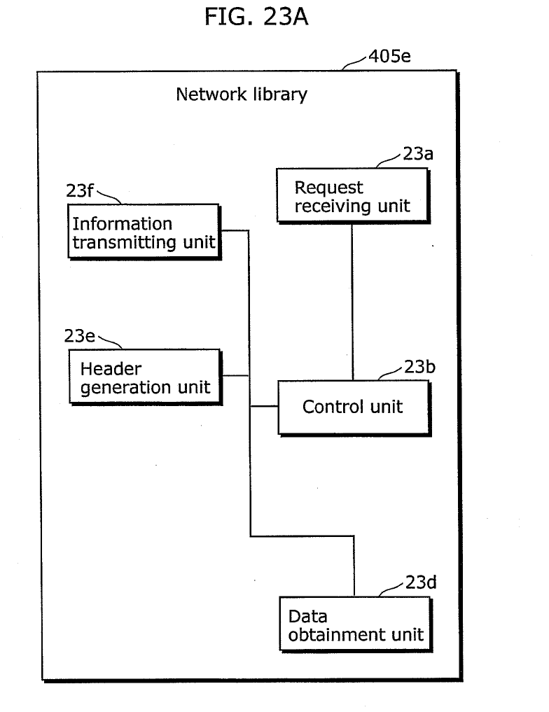

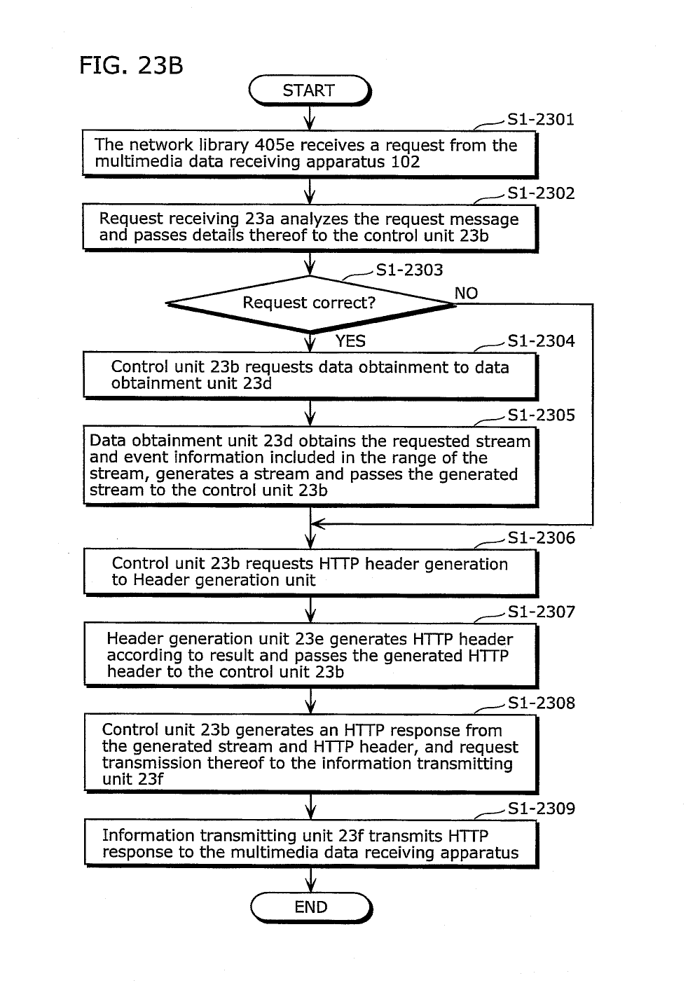

Here, FIG. 23A shows a block diagram showing an example of the internal configuration of the network library 405e shown in the configuration diagram of the program illustrated in FIG. 4. In FIG. 23A, the network library 405e includes a request receiving unit 23a, a control unit 23b, a data obtainment unit 23d, a header generation unit 23e, and an information transmitting unit 23f. FIG. 23B shows the sequence for the network library 405e shown in FIG. 23A. Hereinafter, the case where the following message is received by the network library 405e from the multimedia data receiving apparatus 102 (S1-2301) is exemplified and the operation of each constituent element is described. Furthermore, 2200 shown in FIG. 22 is used as a stream association table, and 2000 shown in FIG. 20 is used as an event table.

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

PlaySpeed.dlna.org:speed=5

The request receiving unit 23a analyzes a request message transmitted from a request-source terminal, and passes the details thereof to the control unit 23b (S1-2302). In the case where the above-described request message is received, the request receiving unit 23a obtains, from the request message, at least the URI (http://192.168.0.3/AVData/0001.m2ts in the aforementioned example) of the requested content, and passes this to the control unit 23b.

The control unit 23b generates and sends, to the request-source terminal, a response message by controlling the other constituent elements of the network library 405e, according to the information received from the request receiving unit 23a. The control unit 23b first judges whether the request message received by the request receiving unit is valid (S1-2303). In the case of an invalid request message, or in the case where an error notification is generated from another constituent element of the network library 405e, the control unit 23b requests the Header generation unit 23e (S1-2306) to generate a corresponding HTTP error message (S1-2307), passes the error message to the information transmitting unit 23f (S1-2308) so as to transmit the error message to the request-source terminal (S1-2309), thereby ending the process. When the received request message is valid, the control unit 23b obtains, from the URI of the content specified by the client, an identifier such as the name of the recorded stream (here, 0001.m2ts) and the reproduction speed (here, speed=5), and passes these to the data obtainment unit 23b. Note that in the case where “PlaySpeed.dina.org: speed=” does not exist in the request message, it is assumed that reproduction speed=1 (reproduction speed equivalent to normal reproduction).

The data obtainment unit 23d reads the stream association table 2200 by requesting the IO 405g. The data obtainment unit 23d checks for the existence of a content associated with the identifier received from the control unit 23b, by referring to the identifier received from the control unit 23b and the column 2201 and comparing identifiers such as the name of the recorded stream. In the case where an associated content does not exist, the data obtainment unit 23d notifies such error details to the control unit 23b, and the process ends. On the other hand, when an associated content exists, the data obtainment unit obtains the storage location 2203 of the recorded stream that matches the identifier, the identifier 2204 such as the name of the event table, and the storage location 2205 of such event table. Next, the data obtainment unit 23d obtains the event table 2000 based on the identifier 2204 such as the name of the event table, and the storage location 2205 of such event table.

The data obtainment unit 23d reads the stream from the storage location 2203 of the recorded stream, and generates stream data for reproduction at the reproduction speed received from the control unit 23b. At this time, the data obtainment unit 23d refers to the event table 2000, and obtains the section described in the event table 2000, from the storage location 2004 of the section in accordance with the time from the start of the stream, inserts the obtained section in the stream to be generated, and passes the generated stream and a successful result to the control unit 23b (S1-2305). In particular, in the case where reproduction is requested specifying a reproduction speed that is faster than the normal reproduction speed, not all of the stream indicated by the storage location 2203 of the recorded stream, and stream data of fragmentary sections is generated. However, conventionally, if data (for example, a section) required for the fragmentary sections is not included, the required data cannot be transmitted to the client. However, in the present embodiment, by adopting the above-described configuration, it becomes possible for the data obtainment unit 23d to definitely insert the required data in the stream to be generated, even when reproduction is requested at a reproduction speed that is faster than in normal reproduction. With this, in either of the cases of normal reproduction and trick play, the client can certainly receive the section described in the event table, and events required in data broadcasting can be obtained without missing to obtain an event. Note that, in the case where an event table does not exist, the data obtainment unit 23d generates a stream based on the received recorded stream and reproduction speed, passes the fact of the event table non-existence and the generated stream to the control unit 23b.

Furthermore, although, here, a method is described in which, during the generation of the event table 2000, the section is taken in advance and stored in the storage location 2004 of the section, another method may be used for this method as long as, even during trick play, section data that must be notified to the client is inserted in a stream transmitted to the client.

For example, it is also acceptable to adopt a method in which the event table 2000 does not hold a section storage location 2004 and, near the media time described in 2001, the section which is included in the recording section is definitely inserted in a stream to be transmitted to the client.

Furthermore, it is also acceptable to adopt a method in which the event table 2000 does not hold a section storage location 2004 and, in place of the media time 2001, the range of each section is described, from the section start position, by Byte positions, and the TS packet carrying the section is definitely inserted.

The control unit 23b generates the header of the HTTP message by passing, to the Header generation unit 23e, information required in the generation of a header of the response such as the result from the data obtainment unit 23d, and the ContentType (S1-2306).

The Header generation unit 23e generates the HTTP response header based on data required for header generation such as the result for the HTTP request, received from the control unit 23b, and the stream generated by the data obtainment unit 23d, and returns the generated header to the control unit 23b (S1-2307).

The control unit 23b generates an HTTP response based on the generated HTTP response header and the stream generated or obtained by the data obtainment unit 23, and passes the generated HTTP response to the information transmitting unit 23f. Note that the control unit 23b repeats the transmission until the connection with the client ends or the content ends (S1-2308).

The information transmitting unit 23f transmits, to the request-source terminal, the header generated by the Header generation unit 23e and the stream generated by the data obtainment unit 23d that are received from the control unit 23b.

An example of the HTTP response transmitted by the information transmitting unit 23f is shown below.

### HTTP/1.1 200 OK

### Date: Thr Jan 11 15:00:01 2007 GMT

### Server: AVT Server

### Connection: Keep-Alive

Content-Type: video/mpeg

### (Empty Line)

[Data of the stream generated by the data obtainment unit 23d]

With the above-described process, since the events associated with the data broadcast within a stream can be transmitted to the client in either of the cases of normal reproduction and trick play, data broadcasting can be reproduced even on the client terminal.

Next, the multimedia data receiving apparatus 102 included in the multimedia content communication system 104 shall be described.

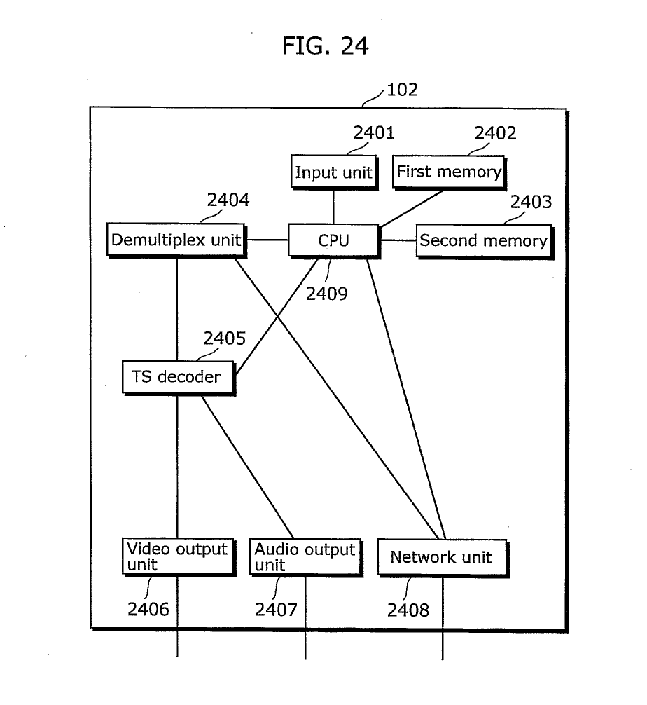

FIG. 24 is a block diagram showing the relationship of constituent elements of the multimedia data receiving apparatus 102 in the present embodiment. The multimedia data receiving apparatus 102 includes an input unit 2401, a first memory 2402, a second memory 2403, a demultiplex unit 2404, a TS decoder 2405, a video output unit 2406, an audio output unit 2407, a network unit 2408, and a CPU 2409.

The input unit 2401, the first memory 2402, and the second memory 2403 are identical to the input unit 201, the first memory 202, and the second memory 203 of the previously described multimedia data transmitting apparatus 101 in the present embodiment. Note that the multimedia data receiving apparatus 102 stores, in the second memory 2403, TV-program information such as the identifier, title, broadcast date and time, broadcast channel, and so on, of the multimedia data in the content list, EPG data, and so on, received from the multimedia data transmitting apparatus 101.

The demultiplex unit 2404 receives an MPEG transport stream from the CPU 2409, extracts information specified by the CPU 2409, and passes the extracted information to the CPU 2409. In addition, demultiplex unit 2404 passes the MPEG transport stream directly to the TS decoder 2405.

The TS decoder 2405 receives the identifiers of audio data and video data from the CPU 2409. In addition, the TS decoder 2405 extracts data corresponding to the received identifiers of audio data and video data, from the stream received from the demultiplex unit 2404. The TS decoder 2405 passes extracted video data to the video output unit 2406, and audio data to the audio output unit 2407.

The video output unit 2406 and the audio output unit 2407 are identical to the video output unit 208 and the audio output unit 209, respectively, of the previously described multimedia data transmitting apparatus 101 in the present embodiment.

The network unit 2408, which includes a network interface, converts the data received from the CPU 2409 into a signal that is in accordance with the physical media of the network to which the network interface is connected to, and outputs this signal. Furthermore, the network unit 2408 receives a signal from the network interface, converts the signal into a packet defined by the IP network, and passes the packet to the CPU 2409.

The CPU 2409 controls the demultiplex unit 2404, the TS decoder 2405 and the network unit 2409 by executing a program stored in the second memory 2403.

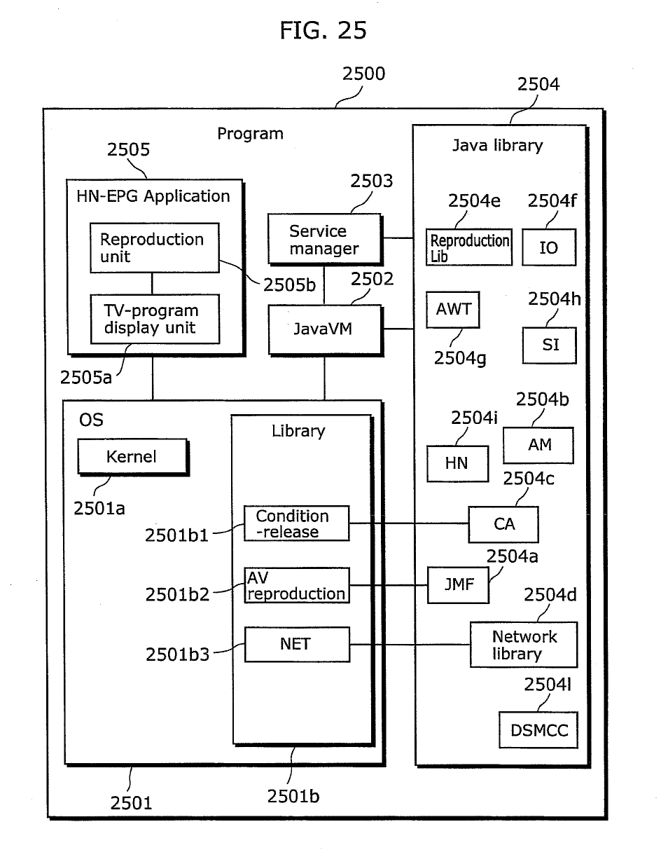

FIG. 25 is an example of a structure diagram of the program stored in the second memory 2403 and executed by the CPU 2409.

A program 2500 is made up of plural subprograms. Specifically, it is made up of an OS 2501, a Java VM 2502, a service manager 2503, a Java library 2504, and an HN-EPG application 2505.

The OS 2501 is a subprogram activated by the CPU 2409 when power to the multimedia data receiving apparatus 102 is turned on. OS is the acronym for operating system, an example of which is Linux and the like. The OS 2501 is a generic name for publicly known technology made up of a kernel 2501a for executing another subprogram concurrently, and of a library 2501b, and therefore detailed description is omitted. In the present embodiment, the OS 2501 and the kernel 2501a execute the Java VM 2502 as a subprogram. Furthermore, the library 2501b provides these subprograms with plural functions for controlling the constituent elements held by the multimedia data receiving apparatus 102. In the present embodiment, the library 2501b includes condition-release 2501b1, AV reproduction 2502b2, and NET 2501b3, as an example of functions.

The condition-release 2502b1 receives information from other subprograms or a CA 2504c of the Java library 2504, enables the AV reproduction 2501b2, and permits the reproduction of the multimedia data received from the network.

The AV reproduction 2502b2 receives an audio packet ID and a video packet ID from other subprograms or a JMF 2504a of the Java library 2504. The AV reproduction 2502b2 then provides the received audio packet ID and video packet ID to the TS decoder 2405. As a result, the TS decoder 2405 performs filtering based on the provided packet IDs, and implements the reproduction of audio/video.

The NET 2501b3 creates packets of a protocol lower than the application layer defined by the IP network, for the data received from the other subprograms or a network library 2504d of the lava library 2504. A protocol lower than the application layer refers to, for example, a TCP packet, a UDP packet, an IP packet, and so on. By passing this to the network unit 2408, messages and data are transmitted to another device via the network 103. Furthermore, when a message is received from another device via the network 103, the NET 2501b3 converts the message to an application layer protocol packet and passes this to the other subprograms or the network library 2504d of the Java library 2504. An application layer protocol refers to, for example, HTTP, RTSP or RTP, and so on.

The HN-EPG 2505 includes: a TV-program display unit 2505a which displays, to the user, a list of multimedia data held by the multimedia data transmitting apparatus 101 on the network; and a reproduction unit 2505b which reproduces a received content. The HN-EPG 2505 is activated by the kernel 2501a when power to the multimedia data receiving apparatus 102 is turned on. When activated, the TV-program display unit 2505a waits for an input from the user through the input unit 2401.

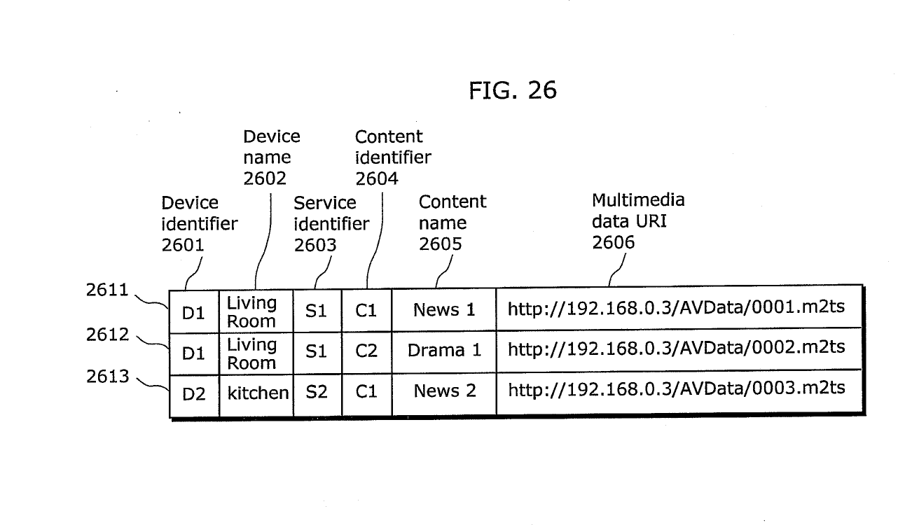

Here, in the case where the input unit 2401 is made up of the front panel illustrated in FIG. 3, when the user presses down the EPG button 307 on the input unit 251, the CPU 2409 is notified of the identifier of such EPG button. The TV-program display unit 2505a as of the HN-EPG 2505 which is a subprogram running on the CPU 2409 receives the identifier and, in order to create TV-program information display data recorded by a device in the home network, obtains, through an HN 2504i of the Java library, information on devices connected to the network, information on services possessed by each device, and information on the multimedia data recorded on an device providing the service of a multimedia content server. The HN 2504i has the functions of obtaining and recording network-connected device, service, and content information. The operation of the HN 2504i shall be described later. Here, FIG. 26 shows an example of the information on the network-connected devices, services, and contents, obtained by the TV-program display unit 2505a from the HN 2504i. Note that the multimedia data information on the network shown in FIG. 26 may be in a format in which it is obtained by the TV-program display unit 2505a from the HN 2504i, and held by the TV-program display unit 2505a, or may also be in a format in which the TV-program display unit 2505a obtains required data from the HN 2504i, at a timing in which the information is required. 2601 denotes a network-connected device identifier, and 2602 denotes the device name. 2603 denotes the identifier of a service held by a device. Note that although the types of the service are defined in the UPnP standard, here, it is assumed that service refers to a MediaServer having a function for providing contents. Furthermore, 2604 denotes the identifier of a recorded content possessed by a service; 2605 denotes the content name; and 2606 denotes the multimedia data URI for accessing the content.

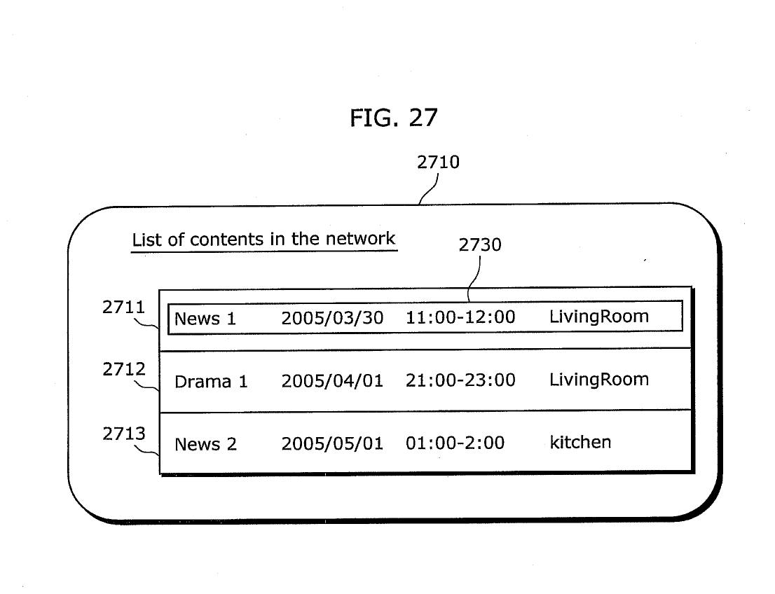

Next, based on the obtained device, service, and multimedia information, the TV-program display unit 2505a outputs data to a monitor 2710, through a monitor output unit not shown in the figure. The monitor 2710 may be included in the multimedia data receiving apparatus 102, and may also be a television connected to the multimedia data receiving apparatus 102 by a composite cable, HDMI cable, or the like. The monitor 2710 displays the received TV-program information display data. FIG. 27 shows an example of contents recorded by devices connected to the home network, displayed by the monitor 2710. In FIG. 27, 2711 indicates that a content having a content name “News 1” and a recorded time and data of “2005/03/30 11:00-12:00” exists in a device “Living Room”. Furthermore, 2712 indicates that a content having a content name “Drama 1” and a recorded time and data of “2005/04/01 21:00-23:00” exists in the device “Living Room”; and 2713 indicates that a content having a content name “News 2” and a recorded time and data of “2005/05/01 1:00-2:00” exists in a device “Kitchen”. In addition, in FIG. 27, the cursor 2703 selects the content in 2711.

When the OK button 305 on the front panel 300 is pressed down in the state shown in FIG. 27, the TV-program display unit 2505a notifies the reproduction unit 2505b of the content name and device information as the information of the selected content 2711.

Based on the multimedia data information on the network as shows in FIG. 26, the reproduction unit 2505b obtains the content identifier, service identifier, and device identifier, using the received content name and device name. In order to reproduce the multimedia data on the network, selected by the user, the reproduction unit 2505b passes the obtained content identifier, service identifier and device identifier to the service manager 2503.

The service manager 2503 is identical to the service manager 404 of the previously described multimedia data transmitting apparatus 101 in the present embodiment except for the following points of difference. The service manager 404 receives a channel identifier from the reproduction unit 402b of the EPG 1304; passes the identifier to the Tuner 405c and causes the Tuner 405c to perform tuning; performs descrambling by requesting the CA 405d, and requests the reproduction of video and audio by providing the channel identifier to the JMF 405a. Whereas, the service manager 2503 receives the device identifier, the service identifier, and the content identifier from the HN-EPG 2505; passes these identifiers to the JMF 2504a; then requests for the reproduction of content existing in the network.

Note that with regard to trick play such as fast forward, rewind, and so on, the service manager 2503 requests trick play to the JMF 2504a described later, and performs trick play by using the network library 2504d, and causing it to sequentially receive data necessary for trick play.

The Java library 2504 is a collection of plural Java libraries stored in the second memory 2403. In the present embodiment, the Java library 2504 includes the JMF 2504a, an AM 25045b, a CA 2504c, the network library 2504d, a reproduction Lib 2504e, and the HN 2504i.

The AM 25004b, the reproduction Lib 2504e, an IO 2504f, an AWT 2504g, an S12504h are identical to the AM 405b, the reproduction Lib 405f, the IO 405g, the AWT 405h, and the S1405i, respectively, which are located in the Java library 405 of the previously described multimedia data transmitting apparatus 101 in the present embodiment.

The JMF 2504a obtains, from the HN 2504i, information such as the IP address of the multimedia data transmitting apparatus 101 as well as the URI of the content, based on the received device identifier, service identifier, and content identifier. Then, the JMF 2504a provides the obtained information to the network library 2504d, and requests for the issuance, to the multimedia data transmitting apparatus 101, of a multimedia data transmission request as well as the reception of the multimedia data transmitted from the multimedia data transmitting apparatus 101. Upon receiving the request, the network library 2504d connects to the multimedia data transmitting apparatus 101, and issues the transmission request for the multimedia data. Subsequently, the network library 2504d records the data transmitted by the multimedia data transmitting apparatus 101, on the first memory 2402 and notifies the JMF 2504a of the recorded data.

By passing the multimedia data recorded on the first memory, to the demultiplex unit 2404, the JMF 2504a performs the reproduction of the multimedia data.

The CA 2504c manages rights processing of the multimedia data, such as the copy control for the multimedia data transmitted via the network 103. Copy control information may be transmitted from he multimedia data transmitting apparatus 101, the content providers such as the broadcast station 105, or an external server specified by the rights holder. Or, it is also be acceptable that copy control information included in the PMT in a transport stream transmitted from the multimedia data transmitting apparatus 101.

The HN 2504i has the functions for obtaining and recording: a server device connected to the network, such as the multimedia data transmitting apparatus 101; a service possessed by the server device; and information on multimedia content provided by the service. Furthermore, the HN 2504i can perform, through the network library 2504d, searching for the server device connected to the network 103, and the obtainment of the service provided by the server device, information on the multimedia content, and the content data. Note that the configuration in which the HN 2504i is included in the network library 2504d is acceptable. Furthermore,

FIG. 26 shows an example of the information on multimedia data on the network, managed by the HN 2504i. Note that although in the present embodiment, an example is shown in which information on the multimedia data on the network shown in FIG. 26 is provided to the TV-program display unit 2505a of the HN-EPG 2505, and the TV-program display unit 2505a also holds this information, it is also acceptable to have a format in which, at the timing in which the information is required, the TV-program display unit 2505a makes an inquiry to the HN 2504i, without holding the information.

The network library 2504d communicates with the multimedia data transmitting apparatus 101 connected to the network 103, through the NET 2501b3 of the OS 2501b. The communication with the multimedia data transmitting apparatus 101 includes multimedia data list transmission/reception, multimedia data transmission request issuance and reception of the multimedia data.

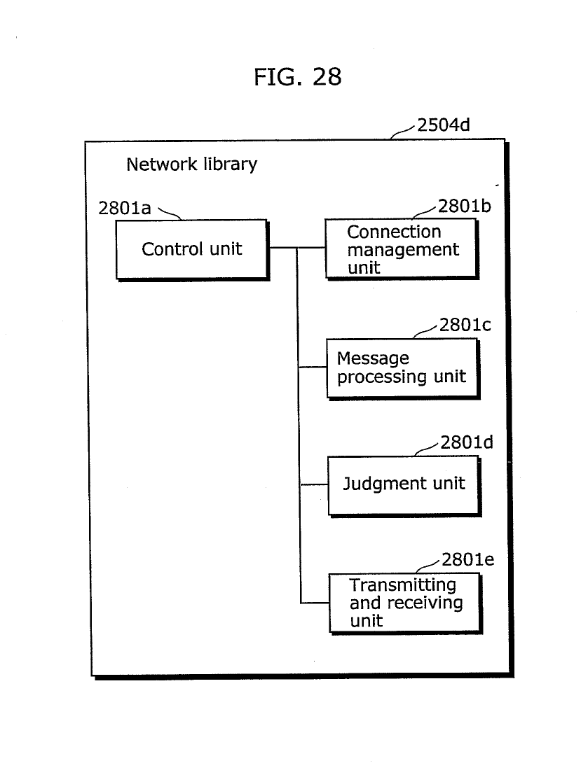

FIG. 28 is a block diagram showing an example of the internal configuration of the network library 2504d. The network library 2504d includes a control unit 2801a, a connection management unit 2801b, a message processing unit 2801c, a judgment unit 2801d, and a transmitting and receiving unit 2801e. Note that the network library 2504d may include other functions associated with the IP network.

The control unit 2801a provides Java APIs to the downloaded Java application, the service manager 2503, or other constituent elements such of the Java library 2504, all of which are executed on the multimedia data receiving apparatus 102, and enables them to use the functions implemented by the network library 2504d. The connection management unit 2801b, which operates upon a request from the control unit 2801a, manages a network connection with external devices on the network 103, such as the multimedia data transmitting apparatus 101. The message processing unit 2801c, which operates upon a request from the control unit 2801a, generates a message transmitted to the external device connected through the network, based on information received from the control unit 2801a. The judgment unit 2801d, which operates upon a request from the control unit 2801a, receives the response message from the external device, from the control unit 2801a, interprets the response message, and notifies the details thereof to the control unit 2801a. The transmitting and receiving unit 2801e, which operates upon a request from the control unit 2801a, transmits data received from the control unit 2801a through the network connection managed by the connection management unit 2801b and received from the control unit 2801a, and receives data from the network connection and passes the received data to the control unit 2801a. The respective operations are described below.

First, the operation for obtaining a list of contents provided by the external device connected to the network 103 shall be described.

First, the control unit 2801a obtains a list of devices connected to the network 103, according to a request from the downloaded Java application, the service manager 2503, and the like. This device list can be generated by carrying out communication defined in UPnP DA. Furthermore, the communication defined in UPnP DA includes the case of receiving a notification from an external device, and a case of inquiring from the multimedia data receiving apparatus 102, that is, the control unit 2801a. In the case where a notification is received from an external device, the control unit 2801a causes the judgment unit 2801d to interpret the UPnP DA-defined message received by the transmitting and receiving unit 2801e, and obtains the details of the interpreted message. The message is a message notifying that the is server device or the service provided by the server device can be used, through the network 103. Next, the control unit 2801a causes the message processing unit 2801c to generate an inquiry message, to the notifying external device, for information on the server device or the service. In addition, the control unit 2801a provides the created message to the transmitting and receiving unit 2801e and causes the transmitting and receiving unit 2801e to transmit the message, as well as to receive a response message from the server device. In addition, the control unit 2801a is able to know the details of the server device and the service provided by the server device by providing the response message to the message processing unit 2801c and causing the message processing unit 2801c to interpret the response message. Note that network connections used in these communications is managed by the connection management unit 2801b.

On the other hand, in the case of an inquiry from the control unit 2801a, the control unit 2801a generates a UPnP DA-defined message inquiring about the existence of a device, by requesting the message processing unit 2801c. Then, the control unit requests the message processing unit 2801c to broadcast the generated message. Next, the control unit 2801a requests the connection management unit 2801b to accept a connection request for receiving a response to the broadcasted message. When the acceptance of the connection is notified from the connection management unit 2801b, the control unit 2801a causes the transmitting and receiving unit 2801e to receive the message by requesting it. In addition, the control unit 2801a requests the judgment unit 2801d to interpret the received message, and obtains the information of the interpreted message. Furthermore, the control unit 2801a requests the message processing unit 2801c to generate a message inquiring about the service and capability provided by the device, and requests the transmitting and receiving unit 2801e to transmit the generated message to the external device. In addition, the control unit 2801a requests the transmitting and receiving unit 2801e to receive a response message to the transmitted message, causes the judgment unit 2801d to interpret the received message by providing the received message thereto, and obtains the details of the response message. With this, the control unit 2801a can obtain information on a certain external device.

By repeating the above-described process, the multimedia data receiving apparatus 102 can obtain a server device connected to the network 103 and a list of services provided by the server device.

Next, the control unit 2801a obtains a list of contents provided by a specific external device connected to the network 103, according to a request from the downloaded lava application, the service manager, and the like. Hereinafter, description is carried out with the multimedia data transmitting apparatus 101 as the specific external device.

First, the control unit 2801a generates a content list transmission message defined by the UPnP AV, by requesting the message processing unit 2801c. At this time, when a condition for the content is received from a Java application, and the like, the control unit generates an appropriate message by providing the condition to the message processing unit 2801c. Next, the control unit 2801a provides, to the connection management unit 2801b, information such as the IP address of the multimedia data transmitting apparatus 101, provided from the Java application, and obtains information on the network connection with the multimedia data transmitting apparatus 101. Then, the control unit 2801a provides the obtained information to the transmitting and receiving unit 2801e. At this time, in the case where the network connection with the multimedia data transmitting apparatus 101 is not yet established, the connection management unit 2801b establishes a new network connection with the multimedia data transmitting apparatus 101. Next, the control unit 2801a provides the content list transmission message generated by the message processing unit 2801c, to the transmitting and receiving unit 2801e so as to cause transmission of the message to the multimedia data transmitting apparatus 101. In addition, the control unit 2801a requests the transmitting and receiving unit 2801e to receive a response message from the multimedia data transmitting apparatus 101. In addition, the control unit 2801a provides the received response message to the judgment unit 2801d for interpretation, and obtains a content list which is the details of the interpreted response message. The control unit 2801a passes the obtained content list to the HN 2504i.

Next, the process of receiving multimedia data, and data associated therewith, from the multimedia data transmitting apparatus 101 and reproducing the received data, according to a request from the JMF 2504a, shall be described. Hereinafter, although processing according to a request from the JMF 2504a is exemplified, it shall be the same even when a request from the downloaded lava application or a request from the service manager 2503 is received.

The JMF 2504a obtains, from the HN 2504i, information such as the IP address of the multimedia data transmitting apparatus 101 as well as the URI of the content, based on the device identifier, service identifier, and content identifier received from the service manager 2503. In addition, the JMF 2504a provides the information to the network library 2504d and performs the multimedia data obtainment request.

Upon receiving the multimedia data obtainment request, the control unit 2801a of the network library 2504d provides, to the connection management unit 2801b, at least the IP address of the multimedia data transmitting apparatus 101, the port number for the network connection, and so on, and requests the connection management unit 2801b to establish a network connection with the multimedia data transmitting apparatus 101.

The connection management unit 2801b establishes a network connection with the multimedia data transmitting apparatus 101 using the received information. Network connection means, for example, a TCP connection for performing HTTP, in the case where multimedia data is transmitted by HTTP. Note that although, in the present embodiment the IP address of the multimedia data transmitting apparatus 101 and the port number are provided to the connection management unit 2801b, it is also acceptable that the connection management unit 2801b is provided with the URI of the data to be obtained and obtains such information by interpreting the provided URI. Furthermore, it is also acceptable that connection management unit 2801b is provided with the content identifier and obtains such information.

Next, in order to request the obtainment requests to the multimedia data transmitting apparatus 101, the control unit 2801a generates a corresponding HTTP request by requesting the message processing unit 2801c.

The message processing unit 2801c sets the URI of the requested multimedia data, in the HTTP request. In addition, in the case where trick play is performed, the message processing unit 2801c sets the reproduction speed of the multimedia data, in the HTTP request. The setting of the reproduction speed can be performed by using a “PlaySpeed.dlna.org” extension header defined by DLNA. For example, in the case of 5-time speed reproduction, “PlaySpeed.dina.org: speed=5” is added to the HTTP response header. An example of the HTTP request in the case where the URI of the multimedia data is assumed to be http://192.168.0.3/AVData/0001.m2ts and the requested trick play is 5-fold speed reproduction is shown.

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

PlaySpeed.dlna.org:speed=5

Next, the control unit 2801a provides the HTTP request as generated in the above manner, to the transmitting and receiving unit 2801e and causes it to transmit the HTTP request to the multimedia data transmitting apparatus 101.

In addition, the control unit 2801a requests the transmitting and receiving unit 2801e to receive an HTTP response from the multimedia data transmitting apparatus 101. An example of the received HTTP response is shown below.

### HTTP/1.1 200 OK

### Date: Thr Jan 11 15:00:01 2007 GMT

### Server: AVT Server

### Connection: Keep-Alive

Content-Type: video/mpeg
PlaySpeed.dlna.org:speed=5

### (Empty Line)

[Data of the stream generated by the data obtainment unit 23d of the multimedia data transmitting apparatus 101]

Then, the control unit 2801a passes the received HTTP response message to the judgment unit 2801d, and requests for the interpretation of it.

First, judgment unit 2801d checks the response code of the is HTTP response. When the result is 200 OK, the judgment unit 2801d notifies the fact to the control unit 2801a. Then, at which point, the control unit 2801a records, on the first memory 2402, the received multimedia data in the body portion of the HTTP response, and notifies the JMF 2504a (or the library making the content obtainment request).

Subsequently, the JMF 2504a passes, to the TS decoder 2405, the transport stream of the notified multimedia data recorded in the first memory. At this time, in order to obtain the PAT, the JMF 2504 specifies the PID “0” of the PAT, to the TS decoder 2405 through the library 2501b of the OS 2501. The TS decoder 2405 performs filtering based on the PID “0” and the table_id “0” and, by passing the result to the CPU 2409 through the first memory 2402, the JMF 2504a collects the PAT. Since the PAT obtained from the network is rewritten by the multimedia data transmitting apparatus 101 so that only one program exists, the PID for transmitting the PMT of the program included in the PAT is obtained. Here, the case where the multimedia data transmitting apparatus 101 selects 911, from the PAT in FIG. 9, as the unique program, (the case where the programs 912 and 913 are deleted) is assumed, and “501” is obtained as the PID of the PMT. Next, in order to obtain the PMT, the JMF 2504a specifies PID “501” to the TS decoder 2405, filtering is performed and the result is passed to the CPU 2409 through the first memory 2402, thereby allowing the JMF 2504a to collects the PAT. As an example, the case where JMF 2504a obtains the PMT in FIG. 16 shall be described. Referring to FIG. 16, the JMF 2504a obtains the audio PID “5011” from the row 1011, and the video PID “5012” from the row 1012. The JMF 2504a then provides the received audio packet ID and video packet ID to the TS decoder 2405. As a result, the TS decoder 2405 performs filtering based on the provided packet IDs, and implements the reproduction of audio/video.

Lastly, the service manager 2503 provides the device is identifier, the service identifier, and the content identifier to the AM 2504b in the Java library 2504, and requests data broadcast reproduction. Since the processing by the AM 2504b is the same as that of the AM 405b of the multimedia data transmitting apparatus 101, description shall be omitted.

In this manner, in the present embodiment, since the section notifying the occurrence of an event associated with data broadcasting is definitely included in the stream obtained from the network, by the multimedia data transmitting apparatus 101, the multimedia data receiving apparatus 102 can implement data broadcasting by handling the received transport stream in the same manner as the stream received from a broadcast wave.

### Second Embodiment

In the first embodiment, a method is described in which, when the multimedia data receiving apparatus 102 reproduces a data broadcast, required event data is definitely inserted into the stream by the multimedia data transmitting apparatus 101, even during trick play. In other words, in the first embodiment, the method does not perform special processing on the data for data broadcasting, and obtains the event data from the data for data broadcasting included in the file system, and essentially encoded repeatedly inside the stream, through the DSM-CC format. The technique in the first embodiment assumes the case where, since the data for data broadcasting transmitted through DSM-CC is sufficiently small to be included repeatedly within the stream, even when there are cases where the multimedia data receiving apparatus 102 cannot obtain the data for data broadcasting during trick play, the data for data broadcasting is included inside the stream again within a time that is acceptable to the user, and the multimedia data receiving apparatus 102 can obtain the data for data broadcasting.

On the other hand, the present embodiment assumes the case is where the data for data broadcasting transmitted through DSM-CC is large, and in the case where data obtainment was not possible due to trick play, and the like, and it is not possible to wait until the time of the next inclusion of the data for data broadcasting in the stream. Consequently, in the present embodiment, a technique for obtaining data for data broadcasting using a method other than the stream shall be described.

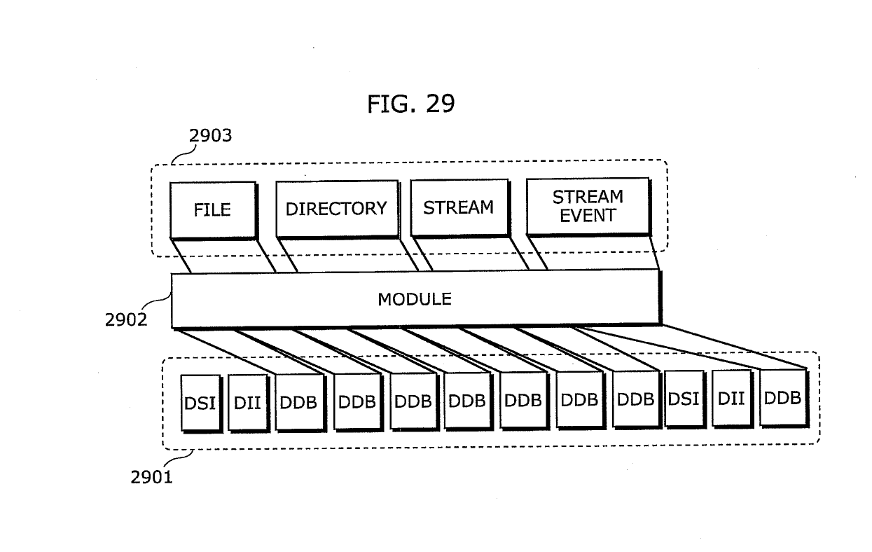

Here, FIG. 29 shows the DSM-CC structure. FIG. 29 represents the association between a DSM-CC section defined in the DSM-CC standard and an object such as a file or a directory. In a as DSM-CC section 2901, there exist DSI and DII sections which include structure information of the data to be transmitted, and sections called DDB which include the actual data. A Module 2902 is structured by combining the DDB based on the information of the DSI and DII, and an Object 2903 such as a file and a directory can be obtained by separating the Module 2902 according to the DSM-CC regulations. As such, a method using these three data formats is considered in the communication between the multimedia data transmitting apparatus 101 and the multimedia data receiving apparatus 102.
A format of communicating using a DSM-CC section
A format of communicating using a DSM-CC Module
A format of communicating using a DSM-CC Object such as a file and a directory

First, the multimedia data transmitting apparatus 101 in the present embodiment shall be described.

An example of the block diagram showing the relationship of the constituent elements configuring the multimedia data transmitting apparatus 101 in the present embodiment is the same as that in FIG. 2. Furthermore, since an example of a structure diagram of the program stored in the second memory 203 and executed by the CPU 212 is the same as that in FIG. 13, description shall be omitted. However, since the internal configuration of the storage management library 1302 is different, an example of such configuration is shown below.

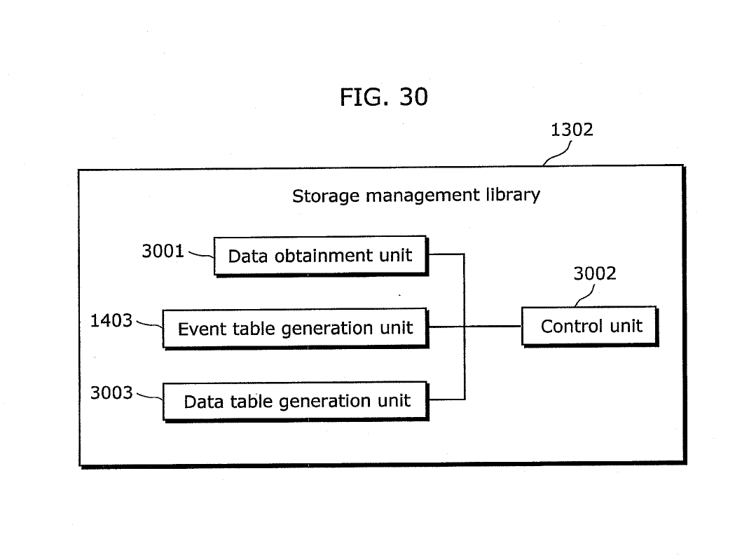

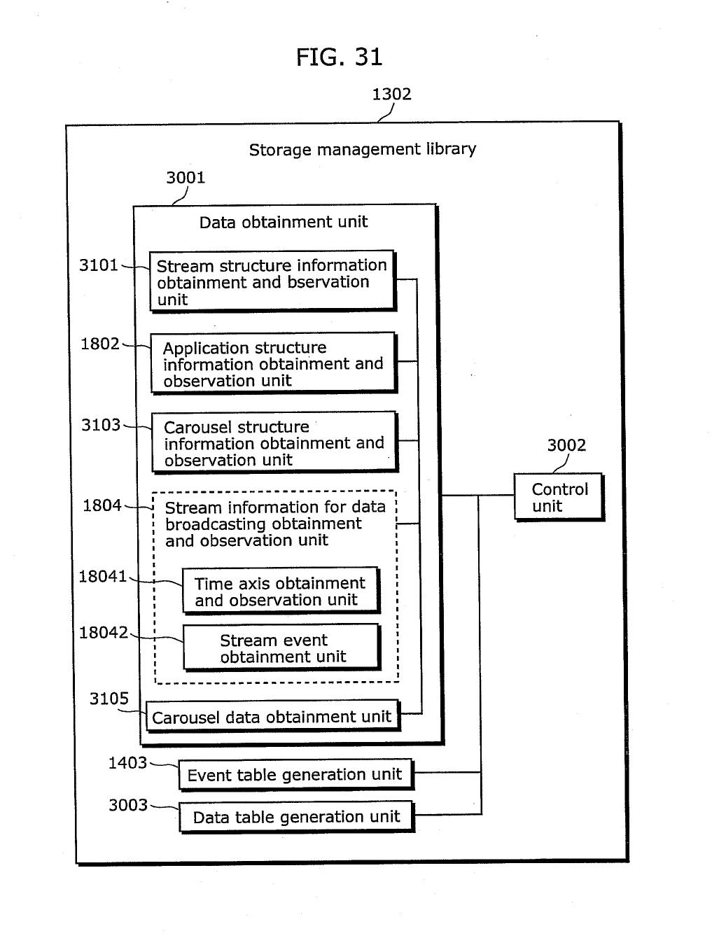

FIGS. 30 and 31 show the configuration of the storage management library 1302 in the present embodiment.

In FIG. 30, the storage management library 1302 includes a data obtainment unit 3001, a control unit 3002, and an event table generation unit 1403, and a data table generation unit 3003. Since, among these constituent elements, the event table generation unit 1403 performs the same processing as the event table generation unit 1403 in the first embodiment, its description shall be omitted.

The data obtainment unit 3001 of the storage management library 1302 has functions for obtaining data for data broadcasting, and storing the obtained data in the second memory 203 together with notifying the data table generation unit 3003 or the control unit 3002 or both, in addition to the functions for obtaining the previously described event required for reproducing the data broadcast, storing the event in the second memory 203, and notifying the event table generation unit 1403 which manages events, described previously.

With respect to the constituent elements of the data obtainment unit 3001, the application structure information obtainment and observation unit 1802 and the stream information for data broadcasting obtainment and observation unit 1804, shown in FIG. 18A, perform the same processing as in the first embodiment.

On the other hand, in addition to the stream structure information obtainment and observation unit 1801, a stream structure information obtainment and observation unit 3101 passes the data of the PAT and PMT obtained at the start of service recording as well as the PAT and PMT for which version up has occurred, to the control unit 3002 or a carousel data obtainment unit 3105 or to both.

In addition to the carousel structure information obtainment and observation unit 1803, the carousel structure information obtainment and observation unit 3103 passes the data of the DSI and DII obtained at the start of service recording as well as the DSI and DII for which version up has occurred, to the control unit 3002 or the carousel data obtainment unit 3105 or to both.

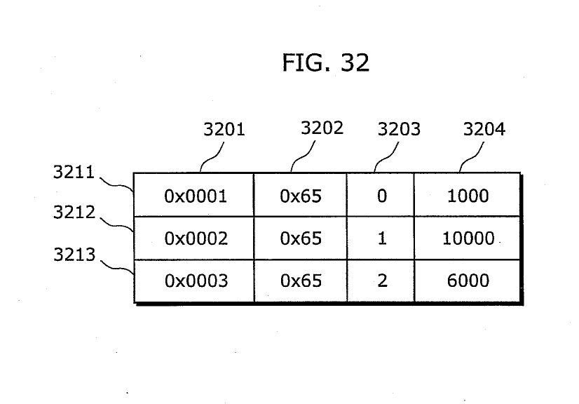

The carousel data obtainment unit 3105 refers to the DSI, not shown in the figure, received from the carousel structure information obtainment and observation unit 3103, and obtains a as relevant DII based on a DII identifier included in the DSI. FIG. 32 is a chart which schematically shows an example of information of the collected DSI. In FIG. 32, 3201 includes a Module identifier. 3202 includes an Association tag identifying an elementary stream transmitting the Module. With the Association tag, it is possible to obtain PID of the elementary stream in which an Association tag Descriptor including an Association tag identical to the specified Association tag, exists by referring to the PMT. 3203 indicates the version of the Module. 3204 indicates the size of the Module. Note that the DII includes plural Module information as in 3211 to 3213. Here, the Module is transmitted through a section called a DBB of the DSM-CC section. As such, obtainment of a module means that:
DDB sections are obtained by setting, to the TS decoder, the PID and table_id “3b” obtained using the Association tag in column 3202, and performing filtering.
Since the order of arrangement of a DDB section is included in the section_number of each DDB section, DDB sections are arranged according to the obtained section_number. Note that, since the data size to be transmitted is included in each DDB section, the data size of the obtained DDB sections are summed-up, and obtainment is performed until the Module size in 3204 is reached.

Moreover, refer to the previously mentioned DSM-CC Standard 13818-6 and the MHP/OCAP Standard for details.

(Method of Communicating Using a DSM-Cc Section)

First, the case of transmitting, as a DSM-CC section, actual data used for reproduction in the data for data broadcasting, from the multimedia data transmitting apparatus 101 to the multimedia data receiving apparatus 102, shall be described. According to the above-described method, the carousel data obtainment unit 3105 obtains DBB sections included in the Module, according to the Module information 3211 to 3213 included in the DII, and records the obtained DBB section in the first memory 202. In addition, the carousel data obtainment unit 3105 notifies this fact to the data table generation unit 3003.

Next, upon receiving a version up of at least one of the PAT, PMT, and DSI from the stream structure information obtainment and observation unit 3101 or the carousel structure information obtainment and observation unit 3103 or the control unit 3002, the carousel data obtainment unit 3105 terminates the DSM-CC section obtainment.

Furthermore, upon receiving a DII version up from the carousel structure information obtainment and observation unit 3103, the carousel data obtainment unit 3105 checks the TransactionID of the DII before the version up, held by the carousel data obtainment unit 3105, and obtains the DII before the version up. Then, the carousel data obtainment unit 3105 detects a Module having a Module version that is changed from that shown in row 3203, by comparing the pre-version up DII and the post-version up DII. Accordingly, since it is possible to identify a Module for which version up has occurred, the carousel data obtainment unit 3105 obtains an Association tag transmitting a Module changed according to the newest DII, and obtains the PID of the elementary stream. Then, carousel data obtainment unit 3105 obtains, anew, the DSM-CC section transmitting the Module and stores this in the first memory 202. In addition, the carousel data obtainment unit 3105 notifies this fact to the data table generation unit 3003.

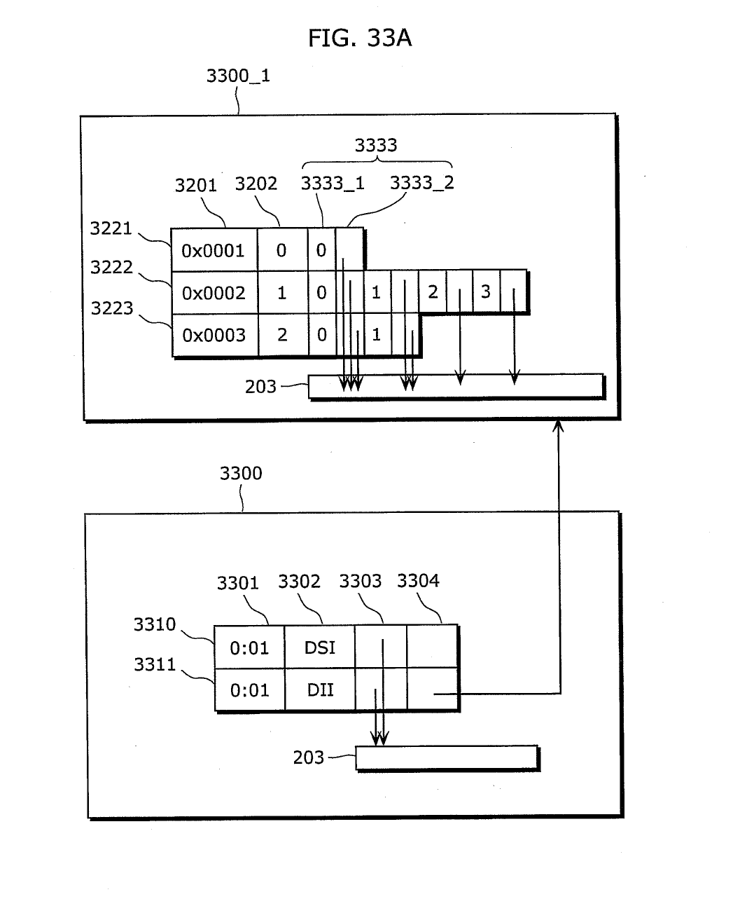

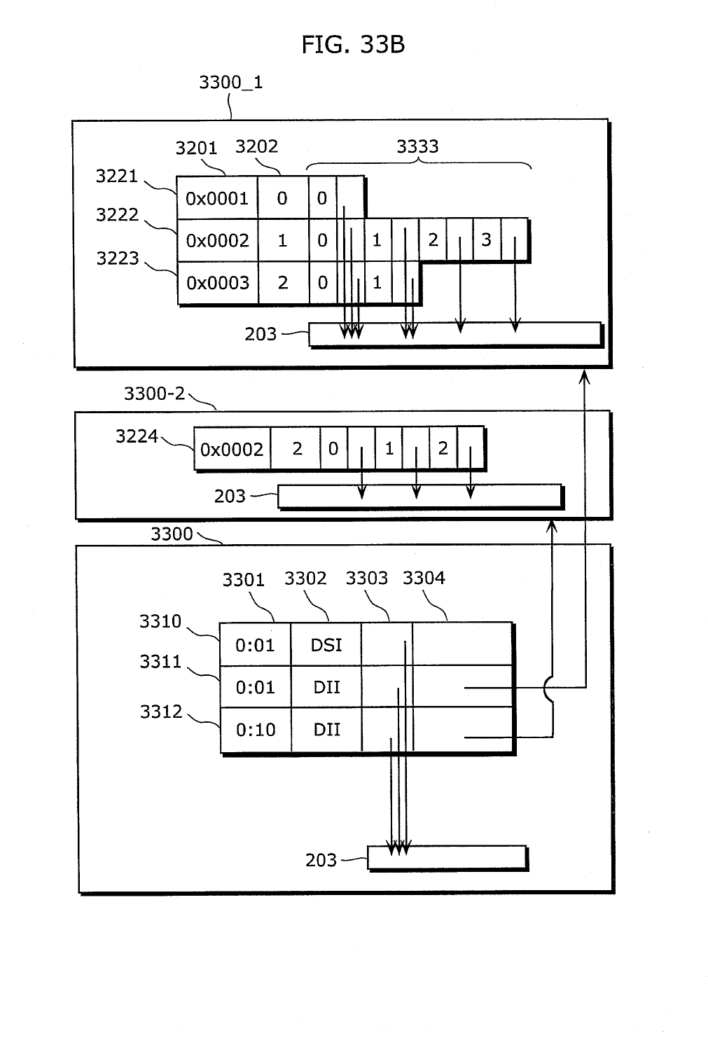

The data table generation unit 3003 generates a table for managing the storage location of data associated with a data broadcast, records, in the second memory 203, data associated with a data broadcast such as the DSM-CC section obtained by the carousel data obtainment unit 3105, and manages the data. FIG. 33A shows an example of the table generated by the data table generation unit 3003. Note that the data table in FIG. 33A is includes a main table 3300 showing information of the DSI and DII, and a DII reference information management table 3300-1 showing information included in the DII. 3301 indicates a media item. Note that this time may be other information as long as it is information that allows identification of the position from the start of the recorded stream. 3302 indicates the identifier of a received section. 3303 indicates the storage location of each section data (for example, the address information of the second memory indicating the beginning position of data corresponding to the section data). 3304 indicates referencing to the DII reference information management table 3300-1 for managing sections included in information referred to from the DII. Note that, here, the DII in FIG. 32 is exemplified in order to describe the DII reference information management table 3300-1. 3331 is the Module identifier. 3332 indicates the version of the Module. 3333 indicates referencing to the DDB section transmitting actual data of the Module in 3331. 3333-1 indicates the BlockNumber of the DDB section. The BlockNumber indicates the order of arrangement of DDB sections included in the Module. 3333-2 indicates the storage location of the DDB section (for example, the address information of the second memory indicating the beginning position of data corresponding to the DDB section). Note that data from henceforth are also held, in the same format, under the set of the BlockNumber and storage location of the DDB section. It is known from 3321 that the Module identifier is “0x0001”, the Model version is “0”, and as DDB sections making up the Module, the Module is structured from a DDB section having a BlockNumber “0”. It is known from 3322 that the Module identifier is “0x0002”, the Model version is “1”, and as DDB sections making up the Module, the Module is structured from the 4 DDB sections, from the DDB section having the BlockNumber “0” to the DDB section having the BlockNumber “3”.

Next, FIG. 33B shows an example of the table when a version up of the DII occurs. Upon receiving the DII, the table generation unit 3003 adds received DII information to 3312 and compares this with the DII 3311 before the version up. Then, upon discovering that the updated Module is the Module 0x0002, the table generation unit 3003 generates a DII reference information management table 3300-2. Not that although, as a DII reference information management table, an example is shown here in which only 0x0002 for which a version up has occurred is managed using the DII reference information management table 3300-2, other methods may also be used as long as it is a method that can manage the version-upped Module.

Note that although a format is adopted here in which, in the data table, the storage location of data is stored by holding the referencing to the second memory 203 recorded by the carousel data obtainment unit 3105, it is also acceptable to adopt a method in which the carousel data obtainment unit 3105 does not record the data for data broadcasting separately from the stream, the position of the recorded stream specified by column 2203 of the stream association table 2200 in FIG. 22, which exists in the second memory 203, is notified to the data table generation unit 3003, and when there is an obtainment request for data for data broadcasting from the multimedia data receiving apparatus 102, the data for data broadcasting is obtained from the recorded stream by referring to the table generated by the table generation unit 3003.

The control unit 3002 of the storage management library 1302 manages the management table or the storage location and required data for respective data stored in the second memory 203. Furthermore, upon receiving a version up notification from the stream structure information obtainment and observation unit 3101, the control unit 3002 compares the PAT or PMT used for specifying a PID to the stream structure information obtainment and observation unit 3101, and, in the case where the PID of the ES transmitting the relevant DSM-CC identifier has changed, notifies this fact to the carousel data obtainment unit 3105 and the table generation unit 3003.

Next, description shall be carried out using the example in which the following request message is received by the network library 405e of the multimedia data transmitting apparatus 101, from the multimedia data receiving apparatus 102.

### <Section Request 1>

GET http://192.168.0.3/AVData/0001.m2ts?type=Section&pid=0x5014&table_id=0x3B HTTP/1.1

### Host: 192.168.0.3

### Date: Thr Jan 11 15:00:00 2007 GMT

### User-Agent: AVT Client

### Connection: Keep-Alive

In this example, a request for a section is included in the URI included in the request message. In this example, the request is a request for obtaining a section from a stream represented by /AVData/0001.m2ts in a server having the IP address 192.168.0.3. It shows that “type=section” represents a request for section obtainment, “pid=0x5014” indicates that the “pid” of the requested section is “0x5014”, and “table_id=0x3B” indicates that the table_id of the requested section is “0x3B”.

Furthermore, the section obtainment request may be issued by adding an extension header X-Section-Request to the HTTP request. In this case, it is assumed that in the extension header X-Section-Request, the type of the section within the requested multimedia data, and section information for which transmission is requested are delimited by a semicolon “;”. An example of the generated extension header is shown below.

X-Section-Request: type=section; pid=0x5014; tablie_id=0x3B

Therefore, an HTTP request such as the example below is transmitted from the multimedia data receiving apparatus 102 to the multimedia data transmitting apparatus 101.

### <Section Request 2>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Section-Request: type=section; pid=0x5014; tablie_id=0x3B

In this manner, as long as it is a method that can specify information indicating the request for a section, and information that can identify the section to be obtained, such as a PID or a table_id, other identifiers may be used, and any kind of request may be used.

Furthermore, in order to obtain a section updated through a is version up, the timing for obtaining the requested section is notified so that the section to be obtained by the multimedia data receiving apparatus 102 can be identified. Note that although, as an example of a method for notifying the timing, a method using media time is described here, as a method for notifying the timing, the specification format may be any method as long as it is information that allows identification of the position within a stream, such as media time or NPT, a byte position within the stream, and so on.

### <Section Request 3>

GET http://192.168.0.3/AVData/0001.m2ts?type=Section&pid=0x5014&table_id=0x3B&media_time=00:10:00 HTTP/1.1

### Host: 192.168.0.3

### Date: Thr Jan 11 15:00:00 2007 GMT

### User-Agent: AVT Client

### Connection: Keep-Alive

Furthermore, in the case of successively obtaining sections from the start time onward, from a specified timing onward, “-” is specified after the media time specification (the example below shows an example for requesting successive obtainment of sections from the media time start time of “00:10:00” onward, by specifying “-” after specifying “00:10:00” as the start time of the “media time”)). As such, in the case of issuing an obtainment request for sections up to the end of a recorded stream, the request is as follows.

### <Section Request 4>

GET http://192.168.0.3/AVData/0001.m2ts?type=Section&pid=0x5014 &table_id=0x3B& media_time=00:10:00-HTTP/1.1

### Host: 192.168.0.3

### Date: Thr Jan 11 15:00:00 2007 GMT

### User-Agent: AVT Client

### Connection: Keep-Alive

Furthermore, aside from specifying the start position, a method which specifies the range for issuing the obtainment request is also acceptable. In this case, the range is represented by connecting the timing for starting and the timing for ending with a “-”. As such, in the case of issuing an obtainment request with a specified range (for example media time is “00:10:00-00:30:00”), the request is as follows.

### <Section Request 5>

GET http://192.168.0.3/AVData/0001.m2ts?type=Section&pid=0x5014&table_id=0x3B& media_time=00:10:00-00:30:00 HTTP/1.1

### Host: 192.168.0.3

### Date: Thr Jan 11 15:00:00 2007 GMT

### User-Agent: AVT Client

### Connection: Keep-Alive

Note that aside from the aforementioned specification method, any kind of request may be adopted as long as it is information that allows identification of the requested section, such as a method which specifies the range of the media time by using a TimeSeekRange.dlna.org extension header defined by the DLNA, or specifying the range of byte positions of a stream by using a Range header defined in HTTP 1.1.

Except for the following points of difference, the network library 405e performs the same processing as that with constituent elements shown in FIG. 23A in the first embodiment. Hereinafter, constituent elements having a different processing are described in detail.

In the case where a request message is received, the request receiving unit 23a obtains, from the request message, at least the requested content and section information, and passes these to the control unit 23b.

When the received request message is valid, the control unit 23b obtains the identifier of the recorded stream specified by the client (here, 0001.m2ts) and the obtainment condition for the section (PID=0x5014, table_id=3B, MediaTime=00:10:00), and passes these to the data obtainment unit 23b. The control unit 23b generates the header of the HTTP response message by passing, to the Header generation unit 23e, information required in the generation of a header, such as the result from the data obtainment unit 23d, and the ContentType. Note that the control unit 23b generates the HTTP response, including the section obtained by the data obtainment unit 23d. Note that, at this time, in the case of transmitting plural sections, it is acceptable to adopt a method in which the plural sections are transmitted successively, and each section is obtained by analyzing the received data at the multimedia data receiving apparatus 102. Furthermore, a method for forming a chunk for each section and transmitting the formed section, using the Chunked Transfer Coding defined in HTTP 1.1, may also be adopted. Subsequently, the control unit 23b transmits the generated HTTP message to the request-source terminal by passing it to the information transmitting unit 23f. Note that the control unit 23b repeats the transmission until the request from the client is satisfied, or the connection ends, or the recorded stream ends.

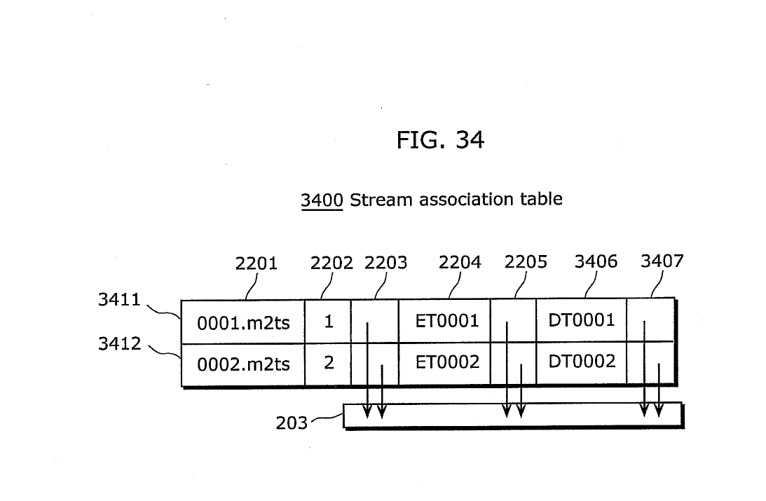

Next, FIG. 34 shows a stream association table (3400) indicating the association between a recorded stream, an event table, and a data table. A column 3406 is the identifier of a data table, and a column 3407 indicates the storage location of the data table (for example, the address information of the second memory indicating the beginning position of data corresponding to the data table).

Hereinafter, description is carried out using 3400 shown in FIG. 34 as the stream association table, 2000 shown in FIG. 20 as the event table, and 3300 shown in FIG. 33A or FIG. 33B as the data table. The data obtainment unit 23d reads the stream association table 3400 shown in FIG. 34 by requesting the IO 405g. The data obtainment unit 23d checks for the existence of a content associated with the identifier received from the control unit 23b, by referring to the identifier received from the control unit 23b and the column 3401 and comparing recorded stream identifiers. In the case where an associated content does not exist, the data obtainment unit 23d notifies such error details to the control unit 23b, and the process ends. On the other hand, when an associated content exists, the data obtainment unit 23d obtains the data table identifier 3406 and the storage location 3407 of such data table. Next, the data obtainment unit 23d obtains the data table 3300 based on the obtained: identifier 3406, such as the name of the event table; and the storage location 3407 of such data table.

The data obtainment unit 23d checks the specified table_id. As the table_id, it is assumed that the PAT is “0”, the PMT is “2”, the AIT is “74”, DSI/DII is “3B”, and DDB is “3C”. In the case where table_id “0”, table_id “2”, and table_id “74” are specified, the data obtainment unit 23d obtains the event table 2000, refers to the specified media time and PID, and obtains the requested request-associated section from the event table 2000. Note that, in the case of table_id “3B”, the data obtainment unit 23d may refer to the event table 2000, or to the data table 3300.

Here, in the case where a section having a “pid” of “0x5014”, a table_id of “0x3B”, and media time of “10:00” is requested through the section request 3, for example, the event table 2000 is referred to, and it is known that the DII section stored in the storage location indicated in column 2004 of row 2015 matches the condition. Furthermore, in the case where the section request 4 and section request 5 are received, the DII stored in the storage location indicated in column 2004 of row 2016 matches the condition. Consequentially, the data obtainment unit 23d obtains the DII section matching the condition and sends the obtained DII section to the control unit 23b. Note that in the case where a relevant section does not exist, and the like, it is acceptable to adopt a method which notifies the control unit 23b of the fact that a relevant section does not exist. Further, it is also acceptable to adopt a method which obtains the specified content from the storage location 2203 of as recorded stream of the stream association table 2200, and passes the corresponding section to the control unit 23b by extracting a relevant section from the recorded stream.

Furthermore, in the case where the specified section has table_id “3C”, the data obtainment unit 23d obtains the data table 3300, selects the DSI and DII that are valid for the time of the specified media time, refers to the DSI and DII recorded in the storage location and obtains all the Module identifiers transmitted using the specified PID, and sequentially passes the sections recorded in association with the relevant Module identifiers. Moreover, here, since the case where information identifying a section is specified in a request is described, sections are transmitted to the multimedia data receiving apparatus according to the section condition such as the specified PID. However, it is also acceptable to adopt a method which specifies a DSM-CC identifier, such as a CarouselID, through a request, and transmit all sections associated with the specified DSM-CC identifier to the multimedia data receiving apparatus 102.

The Header generation unit 23e generates the HTTP response header based on data required for header generation such as the result for the HTTP request, received from the control unit 23b, and returns the generated header to the control unit 23b.

The information transmitting unit 23f transmits, to the request-source terminal, the HTTP response header generated by the Header generation unit 23e and data obtained by the data obtainment unit 23d, that are received from the control unit 23b.

An example of the HTTP response transmitted by the information transmitting unit 23f is shown below.

### HTTP/1.1 200 OK

### Date: Thr Jan 11 15:00:01 2007 GMT

### Server: AVT Server

### Connection: Keep-Alive

Content-Type: application/octet-stream

### (Empty Line)

[Requested section data]

Note that the Header generation unit 23e may generate an extension header indicating the type of section data included in the HTTP response. As an example, it is assumed that the extension header X-Section-Info is used to indicate the filtering condition for data included in the HTTP response, such as the PID and table_id, as well as media time which is the timing at which the section exists within the stream. Naturally, a condition specified by the HTTP request may be included. Note that the information included in the extension header X-Section-Info may be other information as long as it is information that allows identification of data included in the HTTP response.

X-Section-Info: type=section; pid=0x5014; tablie_id=0x3B; media_time=00:10:00

In other words, the HTTP response which includes the extension header including the information of data included in the is HTTP response is a response as shown below.

### HTTP/1.1 200 OK

### Date: Thr Jan 11 15:00:01 2007 GMT

### Server: AVT Server

### Connection: Keep-Alive

Content-Type: application/octet-stream
X-Section-Info: type=section; pid=0x5014; tablie_id=0x3B; media_time=00:10:00

### (Empty Line)

[Requested section data]

Furthermore, although a method which describes information included in the HTTP response, using an extension header, is described here, notification to the multimedia data receiving apparatus 102 may be carried out through other formats.

With the above-described process, it is possible to transmit data making up a section in response to a request from the multimedia data receiving apparatus 102.

(A Format of Communicating Using a DSM-CC Module)

Next, the case of transmitting, as a DSM-CC Module, actual data used during reproduction of the broadcast data of data for broadcasting, from the multimedia data transmitting apparatus 101 to the multimedia data receiving apparatus 102, shall be described.

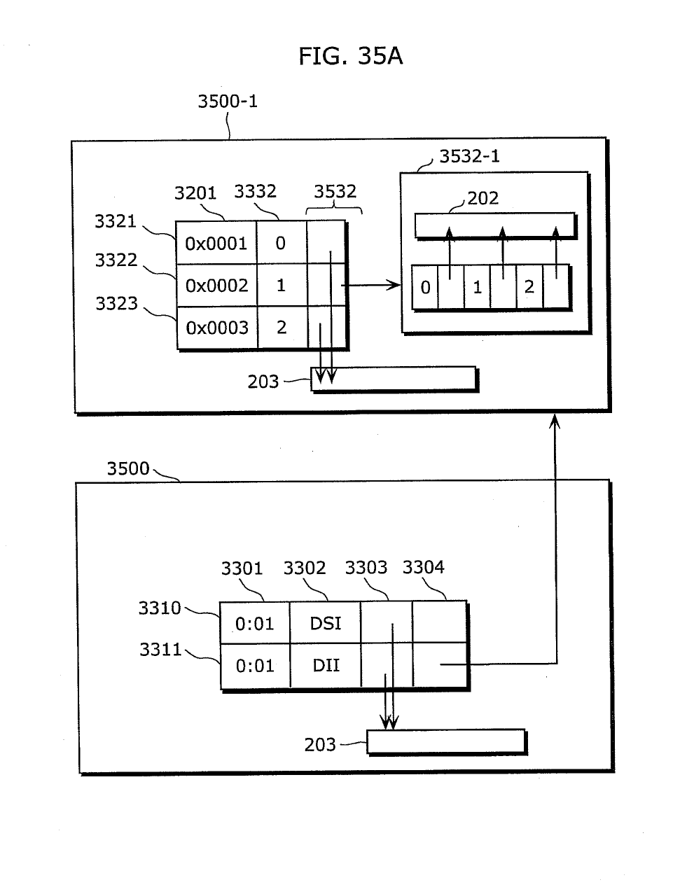

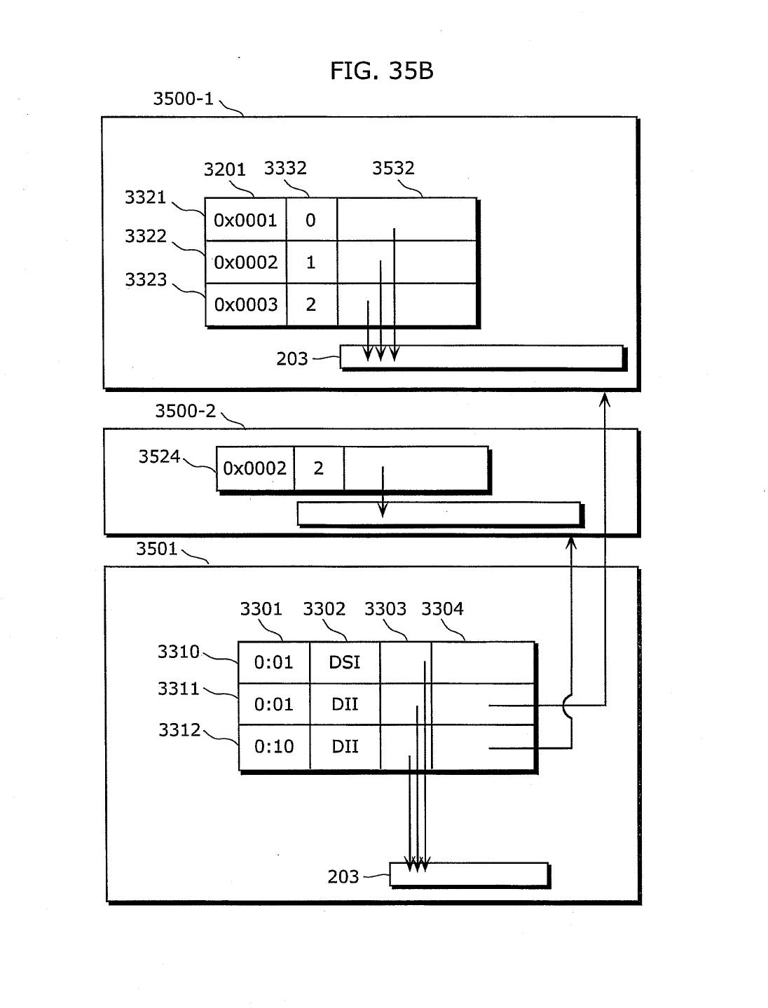

The same processing is performed in the case of transmitting using a Module as in the case of transmitting using a section. However, in the case of communicating by DSM-CC section, the data recorded on the second memory 203 by the data table generation unit 3003 is recorded as a DSM-CC section; whereas, in the case of communicating by DSM-CC Module, it is acceptable to adopt a method which, when storing in the second memory, records by changing from the DSM-CC section to a Module. Note that in a method for generating a Module from DSM-CC sections, a Module can be generated by using the BlockNumber order on the DSM-CC sections making up the Module, to connect the payloads of each section. Here, FIGS. 35A and 35B show an example of the table generated by the data table generation unit 3003. Note that elements affixed with the same numerical reference as in FIGS. 33A and 33B have the same details as in FIGS. 33A and 33B, and thus their description shall be omitted. In FIG. 35A, 3532 of a DII reference information management table 3500-1, upon receiving DSM-CC sections using the first memory 202, the carousel data obtainment unit 3105 manages (for example: 3532-1) the sections in the first memory 202 before all of the DSM-CC sections making up a Module are collected, generates Module data when all the DSM-CC sections making up a Module are collected, and records the Module data on the second memory 203 (for example, the storage location indicated in column 3532 of row 3321, and the storage location indicated in column 3532 of row 3323). Furthermore, the case where a version up of DII occurs is also the same, and FIG. 35B is an example of the generation and recording, on the second memory 203, of a Module when DSM-CC sections making up a Module are all collected.

Naturally, it is also acceptable to adopt a method in which the data recorded on the second memory 203 are recorded as DSM-CC sections, and a module is constructed and transmitted in response to a request by the multimedia data receiving apparatus 102. Next, description shall be carried out using the example in which the following request message is received by the network library 405e of the multimedia data transmitting apparatus 101, from the multimedia data receiving apparatus 102.

### <Module Request 1>

GET http://192.168.0.3/AVData/0001.m2ts?type=Module&Carous el_id=0x0001&ModuleId=0x0001&ModuleVersion=0 HTTP/1.1

### Host: 192.168.0.3

### Date: Thr Jan 11 15:00:00 2007 GMT

### User-Agent: AVT Client

### Connection: Keep-Alive

In this example, a request for a Module is included in the URI included in the request message. In this example, the request is a request for obtaining a Module from a stream represented by /AVData/0001.m2ts in a server having the IP address 192.168.0.3. It shows that “type=Module” represents a request for Module obtainment, “Carousel_id=0x0001” indicates that the “Carousel_id” of the requested Module is “0x00011”, “Moduleid=0x0001” indicates that the Module_id of the requested Module is “0x0x0001”, and “ModuleVersion=0” indicates that the version of the requested Module is “0”.

Furthermore, the Module obtainment request may be issued by adding an extension header X-Module-Request to the HTTP request. In this case, it is assumed that in the extension header X-Module-Request, the type of the Module within the requested multimedia data, and Module information for which transmission is requested are delimited by a semicolon “;”. An example of the generated extension header is shown below.

X-Module-Request: type=module; carouselID=0x001; ModuleID=0x0001; ModuleVersion=0

Therefore, an HTTP request such as the example below is transmitted from the multimedia data receiving apparatus 102 to the multimedia data transmitting apparatus 101.

### <Module Request 2>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Module-Request: type=module; carouselID=0x0001; ModuleID=0x0001; ModuleVersion=0

Here, although a method which specifies CarouselID, ModuleID, and ModuleVersion as information for identifying a Module, other information may be used and any manner of specifying is acceptable, as long as it allows identification of a Module included in a Carousel.

Furthermore, although a method which identifies a Module by specifying the version of the Module is described here, it is also acceptable to adopt a method of specification by specifying the timing of the requested Module in the request, and a Module which is valid at that timing is selected by the multimedia data transmitting apparatus 101. As an example of such timing, other information may be used as long as it is information allowing identification of a timing such as a request using media time. For the request method for specifying such timing, it is possible to use the same method specified in the above-described section requests 3 to 5. As an example, the following is a Module request 3 corresponding to the section request 3.

### <Module Request 3>

GET http://192.168.0.3/AVData/0001.m2ts?type=Module&Carous el_id=0x0001&ModuleId=0x0002&media_time=00:00:15 HTTP/1.

### Host: 192.168.0.3

### Date: Thr Jan 11 15:00:00 2007 GMT

### User-Agent: AVT Client

### Connection: Keep-Alive

Except for the following points of difference, the network library 405e performs the same processing as that with constituent elements shown in FIG. 23A in the first embodiment. Hereinafter, constituent elements having a different processing are described in detail.

In the case where the above-described request message is received, the request receiving unit 23a obtains, from the request message, at least the requested content and Module information, and passes these to the control unit 23b.

When the received request message is valid, the control unit 23b obtains the identifier of the recorded stream specified by the client (here, 0001.m2ts) and the Module obtainment condition (CarouselID=0x0001, ModuleID.=0x0001, ModuleVersion=0), and passes these to the data obtainment unit 23b. The control unit 23b generates the header of the HTTP response message by passing, to the Header generation unit 23e, information required in the generation of a header, such as the result from the data obtainment unit 23d. Note that the control unit 23b generates the HTTP response, including the section obtained by the data obtainment unit 23d. Note that, here, since description is carried out assuming the case where information identifying a Module is specified in the request, a method is described in which the specified Module is transmitted to the multimedia data receiving apparatus 102. However, it is also acceptable to adopt a method which specifies, using a request, information identifying the DSM-CC such as the CarouselID, and the like, and transmits all the modules associated with the identifier of the requested DSM-CC to the multimedia data receiving apparatus 102. Subsequently, the control unit 23b transmits the generated HTTP message to the multimedia data receiving apparatus 102 by passing it to the information transmitting unit 23f. Note that the control unit 23b repeats the transmission until the request from the client is satisfied, or the connection ends, or the recorded stream ends.

The data obtainment unit 23d reads the data table 3500 and the stream association table 3400 by requesting the IO 405g. The data obtainment unit 23d checks for the existence of a content associated with the identifier received from the control unit 23b, by referring to the identifier received from the control unit 23b and the column 3401 and comparing recorded stream identifiers. In the case where an associated content does not exist, the data obtainment unit 23d notifies such error details to the control unit 23b, and the process ends. On the other hand, when an associated content exists, the data obtainment unit 23d obtains the data table identifier 3406 and the storage location 3407 of the data table. Next, the data obtainment unit 23d obtains the data table 3500 based on the obtained identifier 3406, such as the name of the data table; and the storage location 3407 of such data table.

The data obtainment unit 23d checks the specified CarouselID, refers to row 3310 of the data table 3500, and compares the specified CarouselID with the CarouselID held by the DSI recorded in the storage location indicated in column 3303 of row 3310. In the case where the CarouselIDs match, the data obtainment unit 23d obtains the DII recorded in the storage location indicated in column 3303 of row 3311, and checks whether the same CarouselID is also specified for the DII. Then, the data obtainment unit 23d checks whether the Module identifier and Module version specified in the request matches with the DII. At this time, when the CarouselID, the Module identifier, and the Module version do not match, the data obtainment unit 23d checks another DII. Here, assuming the DII recorded the storage location indicated in column 3303 of row 3311 to be a DII for which the Module identifier and is Module version specified in the request match, the data obtainment unit 23d obtains the DII recorded in the storage location indicated in column 3303 of row 3311, which holds the Module specified in the request. Then, referring to the reference information to the DII reference information management table indicated in column 3304 of row 3311, the data obtainment unit 23d obtains the DII reference information management table 3500-1 which includes the specified Module. In addition, the data obtainment unit 23d notifies the control unit 23b of the Module (row 3321, column 3532) matching the requested Module identifier “0x0001” and Module version “0”.

As another example, the case of receiving the request of Module request 3, when the data table is 3501 shown in FIG. 35B, shall be described. Note that description shall be omitted for cases in which the same processing is performed as when the table is that in FIG. 35A.

The data obtainment unit 23d checks the CarouselID specified in the request, and compares the specified CarouselID with the CarouselID held by the DSI (3310) in the data table 3501. When the CarouselIDs are identical, the data obtainment unit 23d obtains the DII holding the Module whose identifier is identical to the specified Module identifier. However, since the DII in 3311 and the DII in 3312 after the version up exist in FIG. 35B, the data obtainment unit 23d obtains the DII in 3312 which is valid for the specified Media_time=00:00:15, and notifies the control unit 23b of the Module of the specified ModuleID=2.

The Header generation unit 23e generates the HTTP response header based on data required for header generation such as the result for the HTTP request, received from the control unit 23b, and returns the generated header to the control unit 23b.

The information transmitting unit 23f transmits, to the request-source terminal, the header generated by the Header generation unit 23e and the data obtained by the data obtainment is unit 23d, that are received from the control unit 23b.

An example of the HTTP response transmitted by the information transmitting unit 23f is shown below.

### HTTP/1.1 200 OK

### Date: Thr Jan 11 15:00:01 2007 GMT

### Server: AVT Server

### Connection: Keep-Alive

Content-Type: application/octet-stream

### (Empty Line)

### [Requested Module Data]

Note that the Header generation unit 23e may generate an extension header indicating the type of Module included in the HTTP response. As an example, the extension header X-Module-Info may be used to indicate the obtainment condition for data included in the HTTP response, such as the CarouselID and ModuleID, as well as media time which is the timing at which the section exists within the stream. Naturally, a condition specified by the HTTP request may be included. Note that the information included in the extension header X-Module-Info may be other information as long as it is information that allows identification of data included in the HTTP response.

X-Module-Info: type=module; carouseID=0x0001; ModuleID=0x0001; ModuleVersion=0

In other words, the HTTP response which includes the extension header including the information of data included in the HTTP response is a response as shown below.

### HTTP/1.1 200 OK

### Date: Thr Jan 11 15:00:01 2007 GMT

### Server: AVT Server

### Connection: Keep-Alive

Content-Type: application/octet-stream
X-Module-Info: type=module; carouselID=0x0001 ModuleID=0x0001; ModuleVersion=0

### (Empty Line)

### [Requested Module Data]

Furthermore, although a method which describes information included in the HTTP response, using an extension header, is described here, notification to the multimedia data receiving apparatus 102 may be carried out through other formats.

With the above-described process, it is possible to transmit data making up a Module in response to a request from the multimedia data receiving apparatus 102.

(A Format of Communicating Using a DSM-CC Object)

Next, the case of transmitting, as a DSM-CC Object, actual data used during reproduction of the broadcast data of data for broadcasting, from the multimedia data transmitting apparatus 101 to the multimedia data receiving apparatus 102, shall be described.

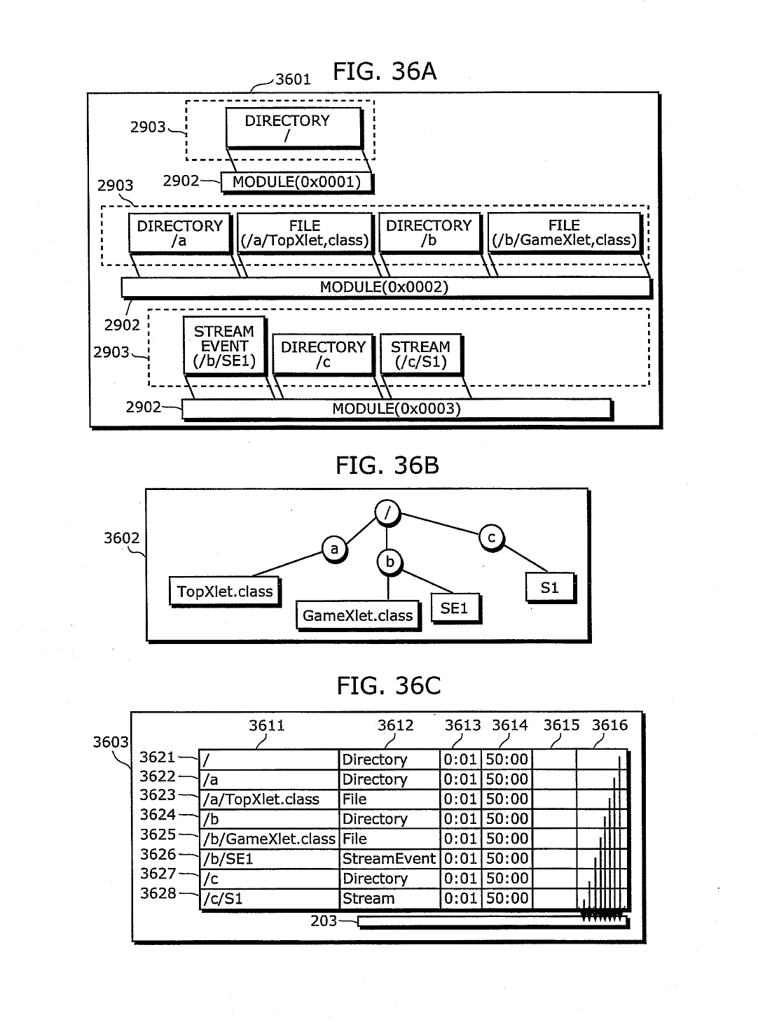

FIGS. 36A to 36C show an example of the relationship between a DSM-CC Module, a DSM-CC Object, and a file system. 3601 shows types (FILE, DIRECTORY, STREAM, STREAMEVENT) of actual Objects and paths existing in the file system shown in 3602, in the Module and Object relationship shown in FIG. 29. For example, Module “0x0001” includes information of a DIRECTORY Object existing in a path “/”. For example, Module “0x0001” includes information of a DIRECTORY Object existing in a path “/a”, information of a FILE Object existing in a path “/a/TopXlet.class”, a DIRECTORY Object existing in a path “/b”, and a FILE Object existing in a path “/b/GameXlet.class”. In addition, Module “0x0003” includes information of a STREAMEVENT Object existing in a path “/b/SE1”, a DIRECTORY Object existing in a path “/c”, and a STREAM Object existing in a path “/c/S1”. An example of a file system structured from information transmitted through such a Module is 3602. Next, 3603 is an example of the data table generated by the data table generation unit 3003. 3611 indicates the path of an Object existing in a file tree transmitted through DSM-CC. 3612 indicates the Type of the Object. 3613 indicates the timing at which each Object becomes valid. Examples of the timing at which an Object becomes valid may be the timing at which each Object is as obtained, the timing at which the Module transmitting each Object appeared, the timing at which the DII transmitting each Object appeared, and so on. Note that here, the timing at which an Object becomes valid is shown as the timing at which the DII transmitting each object appeared.

Next, 3614 indicates the timing at which each object is no longer transmitted in the stream. Examples of the timing at which each object is no longer transmitted in the stream may be the timing at which the Module transmitting the Object is changed due to a version up of the DII, and the Object ceases to exist, the timing at which the Module transmitting the Object is deleted from the DII, the timing at which the stream ends or the timing of the version up of the PAT, PMT, DSI, and so on. Note that here, the timing at which each object is no longer transmitted in the stream is shown as the timing at which the stream ends.

3615 indicates the timing at which each Object is updated. Examples of the timing at which an Object is updated may be the timing at which details of the Object are updated, or may be the timing at which the Module transmitting the Object is updated due to the version up of the DII. Note that here, the timing at which an Object is updated is shown as the timing at which a version up occurs for the Module transmitting each Object. In FIGS. 36A to 36C, nothing is written since a DII version up does not occur.

3616 indicates the storage location of each Object (for example, the address information of the second memory indicating the beginning position of data corresponding to each Object).

Note that, here, an example of data table generation in accordance with the version up of DII is shown. Moreover, here, the case where the Object included in each Module is 3601 is described.

### Example 1

### Module Addition

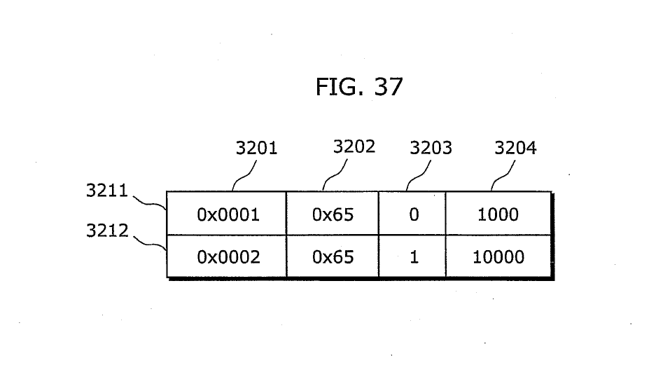

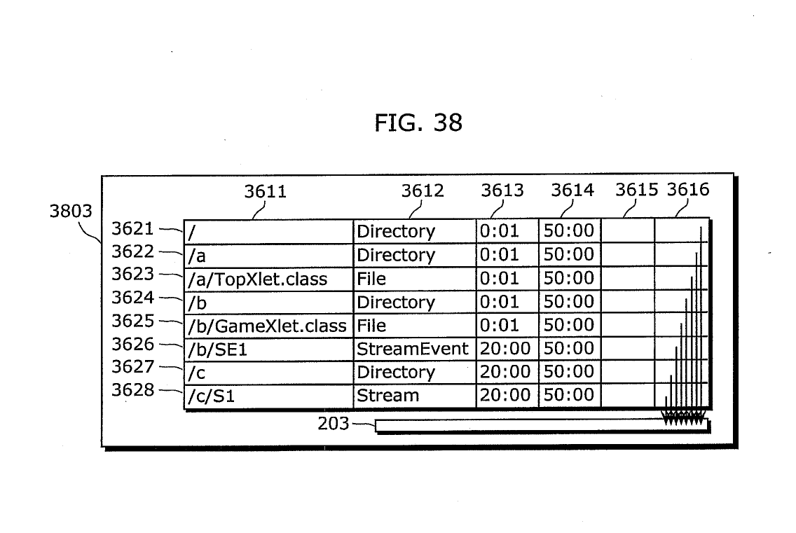

FIG. 38 shows an example of a data table when the DII in FIG. 37 is transmitted and version-upped to the DII in FIG. 32 at a media time “20:00”. In the case where the DII is changed from that in FIG. 37 to that in FIG. 32, since a Module “0x0003” is added, the timing at which the Object transmitted by the Module “0x0003” becomes valid is assumed to be “20:00” (rows 3626 to 3628 of column 3818) at which the DII was received.

### Example 2

### Module Deletion

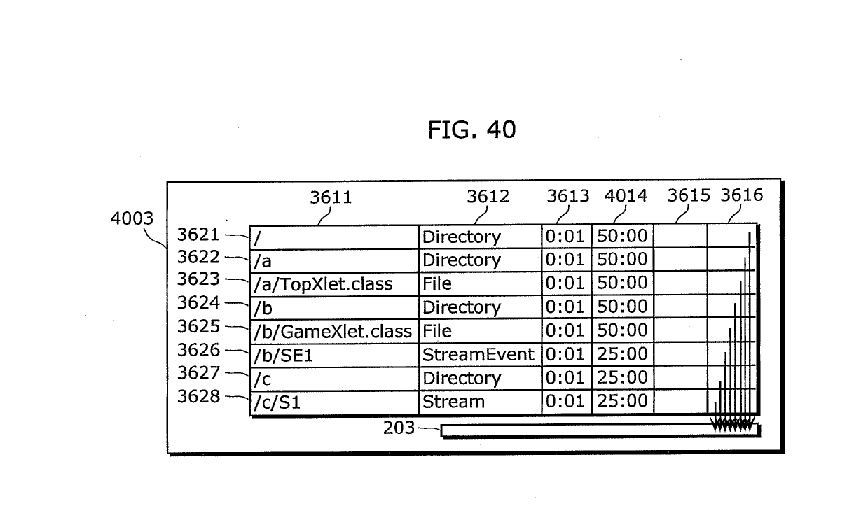

FIG. 40 shows an example of a data table when the DII in FIG. 32 is transmitted and version-upped to the DII in FIG. 37 at a media time “25:00”. In the case where the DII is changed from that in FIG. 32 to that in FIG. 37, since the Module “0x0003” is deleted, the timing at which the Object transmitted by the Module “0x0003” becomes deleted is assumed to be “25:00” (rows 3626 to 3628 of column 4014) at which the DII was received.

### Example 3

### Module Upgrading

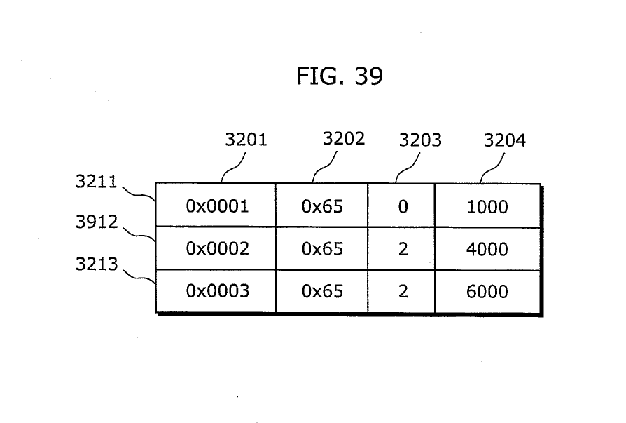

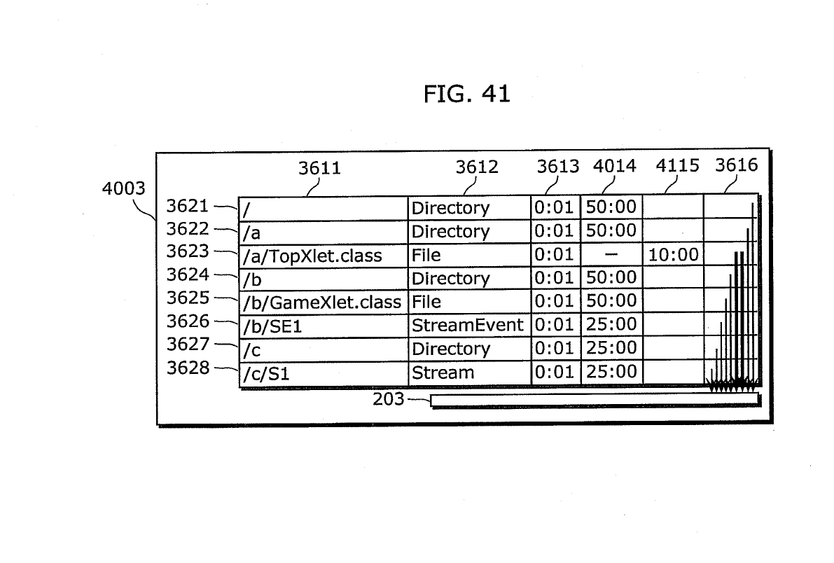

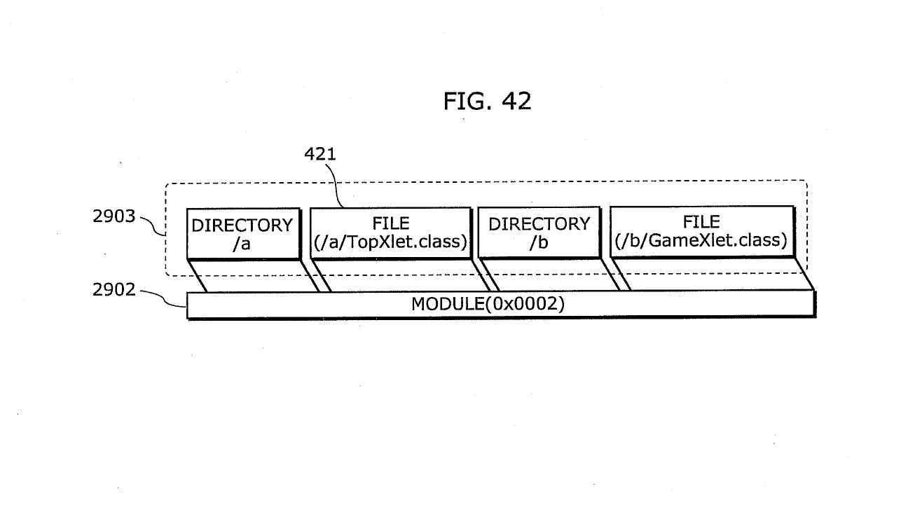

FIG. 41 shows an example of a data table when the DII in FIG. 32 is transmitted and version-upped to the DII in FIG. 39 at a media time “10:00”. In the case where the DII is updated from that in FIG. 32 to that in FIG. 39, since Module “0x0002” is upgraded, the is Module (FIG. 42) of the new Module version “0x0002” is obtained again, the Object included in the obtained Module is compared, the timing of updating to the new Module (421) is specified (row 3623 of column 4115), and reference to the pre- and post-updating Object (in other words, the address information of the second memory indicating the beginning position of data of the Object before updating, and the address information of the second memory indicating the beginning position of data of the Object after the updating) is held in the storage location. Furthermore, it is also acceptable to adopt a method in which the timing at which the Object transmitted by the Module “0x0002”, as described above, is “10:00” (rows 3622 to 3625 of column 23A15) at which the DII was received, and reference to the pre- and post-updating Object (in other words, the address information of the second memory indicating the beginning position of data of the Object before updating, and the address information of the second memory indicating the beginning position of data of the Object after the updating) is held in the storage location.

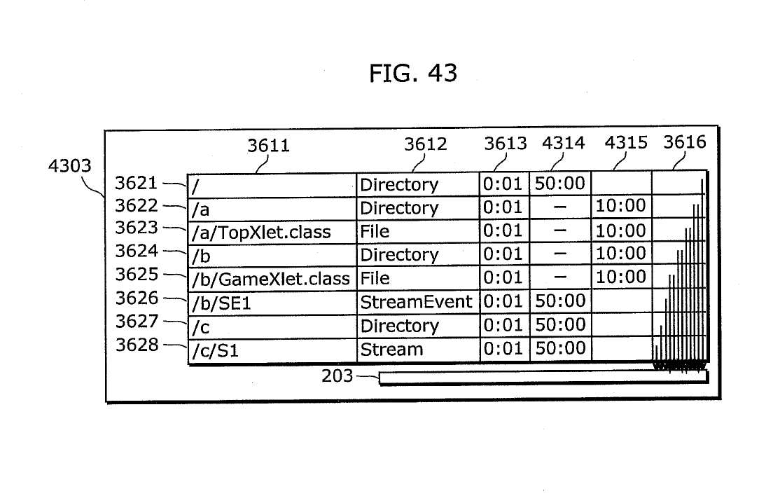

Note that, here, FIG. 43 shows another example of the data table when the DII is version-upped from that in FIG. 32 to that in FIG. 39. In the case where the DII is updated from that in FIG. 32 to that in FIG. 39, since it is known that Module “0x0002” is upgraded, it is possible to adopt a method in which “10:00” is specified for the timing (rows 3622 to 3625 of column 4315) for updating corresponding to all the Objects included in the Module “0x0002”, and reference to the pre- and post-updating Object (in other words, the address information of the second memory indicating the beginning position of data of the Object before updating, and the address information of the second memory indicating the beginning position of data of the Object after the updating) is held in the storage location (column 3616 in FIG. 43).

Note that although media time is used as information indicating each timing (for example, columns 3613 to 3615 shown in FIG. 36C, column 3813, and columns 3614 to 3615 shown in FIG. 38, columns 3616, 4014, and 3615 shown in FIG. 40, columns 3613 to 3615, and column 4115 shown in FIG. 41, column 3613, and columns 4314 to 4315 shown in FIG. 43, and so on), other information is also acceptable as long as it is information allowing recognition of position information within the recorded stream. Furthermore, although the timing (column 3613 to column 3615) at which a change occurs in each object is used as information to be associated with Object information (for example, column 3611, column 3612), it is also acceptable to adopt a method which records, in advance, the Module identifier and the Module version as association information, and detects an Object with the relevant timing at the time of an Object obtainment request from the multimedia data receiving apparatus 102.

Next, description is carried out using the example in which the network library 405e receives a request message such as the one below.

### <Object Request 1>

GET http://192.168.0.3/AVData/0001.m2ts?type=Object&path=/a /TopXlet.class&media_time=00:09:00 HTTP/1 0.1

### Host: 192.168.0.3

### Date: Thr Jan 11 15:00:00 2007 GMT

### User-Agent: AVT Client

### Connection: Keep-Alive

In this example, a request for an Object is included in the URI included in the request message. In this example, the request is an obtainment request for data associated with a stream represented by /AVData/0001.m2ts in a server with an IP address of 102.168.0.3. It shows that “type=Object” represents a request for Object obtainment, “path=/a/TopXlet.class” indicates that the “path” of the requested Object is “/a/TopXlet.class”, and “media_time=00:09:00” indicates that a request for data at a media time of “00:09:00”.

Furthermore, the Object obtainment request may be issued by adding an extension header X-Object-Request to the HTTP request. In this case, it is assumed that in the extension header X-Object-Request, the type of the Object within the requested multimedia data, and section information for which transmission is requested are delimited by a semicolon “;”. An example of the generated extension header is shown below.

X-Object-Request: type=Object; path=/a/TopXlet.class Media_time=00:09:00

Therefore, an HTTP request such as the example below is transmitted from the multimedia data receiving apparatus 102 to the multimedia data transmitting apparatus 101.

### <Object Request 2>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Object-Request: type=Object; path=/a/TopXlet.class; Media_time=00:09:00

In this manner, as long as it is a method that can identify information indicating the Object being requested and the identifier of the Object to be obtained, such as the path of the Object, any kind of request is acceptable. Furthermore, although the method which specifies the path from the root directory of the carousel is described here as the method for specifying the path, any kind of specifying is acceptable as long as it is a path allowing identification of an Object included in the carousel. Furthermore, although the path is used as the identifier of the Object, other identifiers, such as an ObjectID, may be used as long as it allows identification of the Object.

Note that although, as an example of a method for specifying the timing, a method using media time is described here, other specification methods are acceptable as long as it is information allowing identification of the timing. Since the method for specifying the timing is the same as in the previously described cases of requesting a section and a Module, detailed description shall be omitted here.

The network library 405e performs the same processing as the network library 405e described in the first embodiment which shows the constituent elements thereof in FIG. 23A, and in the section and Module request in the present embodiment, except for the following points of difference. Hereinafter, constituent elements having a different processing are described in detail.

In the case where the above-described request message is received, the request receiving unit 23a obtains, from the request message, at least the requested content and Module identifier, and passes these to the control unit 23b.

When the received request message is valid, the control unit 23b obtains the identifier of the recorded stream specified by the client (here, 0001.m2ts) and the Object obtainment condition (path=/a/TopXlet.class), and passes these to the data obtainment unit 23b. The control unit 23b generates the header of the HTTP response message by passing, to the Header generation unit 23e, information required in the generation of a header, such as the result from the data obtainment unit 23d. Note that the control unit 23b generates the HTTP response, including the Object obtained by the data obtainment unit 23d. Note that, although description is carried out here assuming the case where information identifying an Object is specified in the request, it is also acceptable to adopt a method which specifies, using a request, information identifying the DSM-CC such as the CarouselID, and the like, and transmits all the associated Objects to the multimedia data receiving apparatus 102. Subsequently, the control unit 23b transmits the generated HTTP message to the multimedia data receiving apparatus 102 by passing it to the information transmitting unit 23f. Note that the control unit 23b repeats the transmission until the request from the client is satisfied, or the connection ends, or the recorded stream ends.

Hereinafter, description shall be carried out using 4103 shown in FIG. 41 as an example of the data table. The data obtainment unit 23d reads the stream association table 3400 by requesting the IO 405g. The data obtainment unit 23d checks for the existence of a content associated with the identifier received from the control unit 23b, by referring to the identifier received from the control unit 23b and the column 3401 and comparing recorded stream identifiers. In the case where an associated content does not exist, the data obtainment unit 23d notifies such error details to the control unit 23b, and the process ends. On the other hand, when an associated content exists, the data obtainment unit 23d obtains the data table identifier 3406 and the data table storage location 3407. Next, the data obtainment unit 23d obtains the data table 4103 based on the obtained: identifier 3406, such as the name to of the event table; and the event table storage location 3407 thereof.

The data obtainment unit 23d compares the specified path and the paths recorded in the data table 4103, and selects a matching path. Here, since the requested “path” is “/a/Xlet.class”, is it is recognized as matching that in row 3623. In addition, the data obtainment unit 23d refers to columns 3613, 3614, and 4115 of row 3623 in the data table 4103, and recognizes that the Object was updated at “10:00”. Here, since the specified “mediaTime” is “00:09:00”, the multimedia data receiving apparatus 102 requests the data before the updating occurred. As such, the data obtainment unit 23d refers to 3616, obtains the pre-updating Object, and notifies this to the control unit 23b.

The Header generation unit 23e generates the HTTP response header based on data required for header generation such as the as result for the HTTP request, received from the control unit 23b, and returns the generated header to the control unit 23b.

The information transmitting unit 23f transmits, to the request-source terminal, the header generated by the Header generation unit 23e and the data obtained by the data obtainment unit 23d, that are received from the control unit 23b.

An example of the HTTP response transmitted by the information transmitting unit 23f is shown below.

### HTTP/1.1 200 OK

### Date: Thr Jan 11 15:00:01 2007 GMT

### Server: AVT Server

### Connection: Keep-Alive

Content-Type: application/octet-stream

### (Empty Line)

[Requested Object data]

Note that the Header generation unit 23e may generate an extension header indicating the type of Object included in the HTTP response. As an example, it is assumed that the extension header X-Object-Info is used to indicate the path, as well as media time which is the timing at which the Object is obtained from within the stream. Naturally, the condition specified by the HTTP request may be included as it is. Note that the information included in the extension header X-Object-Info may be other information as long as it is information that allows identification of data included in the HTTP response.

X-Object-Info: type=Object; path=/a/TopXlet.class; Media_time=00:09:00

In other words, the HTTP response which includes the extension header including the information of data included in the HTTP response is a response as shown below.

### HTTP/1.1 200 OK

### Date: Thr Jan 11 15:00:01 2007 GMT

### Server: AVT Server

### Connection: Keep-Alive

Content-Type: application/octet-stream
X-Object-Info: type=Object; path=/a/TopXlet.class; Media_time=00:09:00

### (Empty Line)

[Requested Object data]

Furthermore, although a method which describes information included in the HTTP response, using an extension header, is described here, notification to the multimedia data receiving apparatus 102 may be carried out through other formats.

With the above-described process, it is possible to transmit data making up an Object in response to a request from the multimedia data receiving apparatus 102.

Although the multimedia data receiving apparatus 102 in the present embodiment shall be described, since the multimedia data receiving apparatus 102 has functions that are the same as those described in the first embodiment, only the differences shall be described.

In the first embodiment, the network library 2504d receives the multimedia data obtainment request from the JMF 2504a. However, in the present embodiment, the network library 2504d receives data obtainment requests from other libraries (the AM 2504b, the DSM-CC 2504, and so on) issuing data requests for a section, Module, Object, and so on. Since the processes shown here in which the other libraries require the data have already been described, detailed explanation shall be omitted. However, although, in the first embodiment, data broadcast reproduction is performed by the AM 2504b extracting the Java program included in the MPEG-2 transport stream and causing the Java VM 403 to execute the Java program, in the present embodiment, aside from the function for requesting the data for data broadcasting to the network library 2504d, and obtaining the data for data broadcasting from the multimedia data transmitting apparatus 101, data broadcast reproduction can be performed with the same method described in the first embodiment. As with the JMF 2504a, the AM 2504b, receives the device identifier, the service identifier, and the content identifier from the service manager 2503 and receives the request for data broadcast reproduction. Then, as with the JMF 2504a, the AM 2504b obtains the PAT, PMT, obtains the PID transmitting the AIT, specifies the PID and table_id of the AIT, and obtains the section. In this manner, although, in the first embodiment, filtering is performed by setting the section condition by the JMF 2504a to the TS decoder 2405 which obtains the recorded stream and reproduces it, it is also acceptable to adopt a method in which the obtainment request for a section such as the PAT, PMT, and AIT is issued by the network library 2504d, and the section is received directly from the multimedia data transmitting apparatus is 101. Furthermore, the AM 2504b can obtain the specified file by referring to the obtained AIT, obtaining the DSM-CC identifier, and passing the relevant DSM-CC identifier and the information received from the service manager 2503, to the DSM-CC 25041. The AM 2504b performs data broadcast reproduction by extracting the obtained Java program and casing the Java VM 403 to execute the extracted Java program.

Note that the DSM-CC 25041 obtains the Objects making up the file system by performing the processing described thus far in the method for obtaining a file from the DSM-CC. At this time, although, in the obtainment of the DSI and DII, filtering may be performed by setting the section condition by JMF 2504a to the TS decoder 2405 which obtains the recorded stream and reproduces it, obtainment of the DSI, DII section may be requested to the network library 2504d. Furthermore, although it is acceptable to adopt the method in which the DSM-CC 25041 refers to the DSI, DII and, in order to obtain the Object, sets the filtering condition for the DDB section to the TS decoder 2405, it is also acceptable to adopt a method in which the obtainment request is issued to the network library 2504d through any of the following data formats.
Request data obtainment using the section format
Requesting data obtainment using the Module format
Requesting data obtainment using the Object format

Note that when the respective libraries issue a request to the network library 2504d, the multimedia obtainment request is issued, as with the JMF 2504a, by obtaining, from the HN 2504i, information such as the IP address of the multimedia data transmitting apparatus 101 as well as the URI of the content, based on the device identifier, service identifier, and content identifier received from the service manager 2503, and providing the obtained information to the network library 2504d.

Upon receiving the multimedia data obtainment request, the is control unit 2801a of the network library 2504d provides, to the connection management unit 2801b, at least the IP address of the multimedia data transmitting apparatus 101, the port number for the network connection, and so on, from among the received information, and requests the connection management unit 2801b to establish a network connection with the multimedia data transmitting apparatus 101.

Since the connection management unit 2801b performs the same processing as that in the first embodiment, description shall be omitted.

Next, in order to request the obtainment requests to the multimedia data transmitting apparatus 101, the control unit 2801a generates a corresponding HTTP request by requesting the message processing unit 2801c.

The message processing unit 2801c sets the URI of the requested multimedia data, in the HTTP request. As an example, in the case where an obtainment request for a section associated with a multimedia data URI of http://192.168.0.3/AVData/0001.m2ts is received, and a section condition of PID=0x5014, table_id=0x3B is set, the following HTTP request is generated.

### <Section Request 1>

GET http://192.168.0.3/AVData/0001.m2ts?type=Section&pid=0x5014&table_id=0x3B HTTP/1.1

### Host: 192.168.0.3

### Date: Thr Jan 11 15:00:00 2007 GMT

### User-Agent: AVT Client

### Connection: Keep-Alive

Furthermore, as long as it requests a section, and information identifying a section can be set, the format of the HTTP request need not be the HTTP request described above. For example, the HTTP request may be issued by adding an extension header X-Section-Request to the HTTP request. In this case, it is assumed that in the extension header X-Section-Request, the type of the section within the requested multimedia data, and section information for which transmission is requested are delimited by a semicolon “;”. An example of the generated extension header is shown below.

X-Section-Request: type=section; pid=0x5014; tablie_id=0x3B

Therefore, in the case of requesting using such a extension header, an HTTP request such as the example below is issued.

### <Section Request 2>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Section-Request: type=section; pid=0x5014; tablie_id=0x3B

Furthermore, in addition to such a section request as that described above, an example of setting the timing of a section to be obtained, in the request, shall be described. Here, an example in which media time is specified as the timing is shown. Note that, with regard to timing, the timing may be set when data obtainment is requested to the network library 2504d, and it is also acceptable to adopt a method of obtaining the timing from the JMF 2504a, and setting the timing when the message processing unit 2801c is instructed to generate a request. Here, as an example, a method which sets Media_time=00:00:15 is shown.

### <Section Request 3(1)>

GET http://192.168.0.3/AVData/0001.m2ts?type=Section&pid=0x5014&table_id=0x3B&media_time=00:10:00 HTTP/1.1

### Host: 192.168.0.3

### Date: Thr Jan 11 15:00:00 2007 GMT

### User-Agent: AVT Client

### Connection: Keep-Alive

### <Section Request 3(2)>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Section-Request: type=section; pid=0x5014; tablie_id=0x3B; media_time=00:10:00

Furthermore, in the case of successively obtaining sections from a specified time onward, “-” is specified after the media time specification (the example below shows an example for requesting successive obtainment of sections from the media time of “00:10:00” onward, by specifying “-” after specifying “00:10:00” as the specified time of the “media time”). As such, in the case of performing a successive obtainment requests, the request is as follows.

### <Section Request 4>

GET http://192.168.0.3/AVData/0001.m2ts?type=Section&pid=0x5014&table_id=0x3B&media_time=00:10:00—HTTP/1.1

### Host: 192.168.0.3

### Date: Thr Jan 11 15:00:00 2007 GMT

### User-Agent: AVT Client

### Connection: Keep-Alive

Furthermore, aside from specifying the obtainment start position, a method which specifies the range for issuing the obtainment request is also acceptable. In this case, the range is represented by connecting the timing for starting and the timing for ending with a “-”. As such, in the case of issuing an obtainment request with a specified range (for example, the media time is as “00:10:00-00:30:00”), the request is as follows.

### <Section Request 5>

GET http://192.168.0.3/AVData/0001.m2ts?type=Section&pid=0x5014 &table_id=0x3B& media_time=00:10:00-00:30:00 HTTP/1.1

### Host: 192.168.0.3

### Date: Thr Jan 11 15:00:00 2007 GMT

### User-Agent: AVT Client

### Connection: Keep-Alive

Note that although a method which notifies timing utilizing media time is used here, other information is acceptable as long as the position within the multimedia data can be identified. As an example of other information, there is a method which specifies the timing using the byte positions of NPT or a stream.

Furthermore, aside from the aforementioned specification method, any kind of request may be adopted as long as it is information that allows identification of the requested section, such as a method which specifies the range of the media time by using a TimeSeekRange.dlna.org extension header defined by the DLNA, or specifying the range of byte positions of a stream by using a Range header defined in HTTP 1.1.

Moreover, as another example of a request generated by the message processing unit 2801c, in the case where an obtainment request for a Module associated with a multimedia data URI of http://192.168.0.3/AVData/0001.m2ts is received and Carousel_id=0x0001, Module_id=0x0001, Module_Version=0 is specified as the condition of the Module to be obtained, an HTTP request such as the following is generated.

### <Module Request 1>

GET http://192.168.0.3/AVData/0001.m2ts?type=Module&Carous el_id=0x0001&ModuleId=0x0001&ModuleVersion=0 HTTP/1.1

### Host: 192.168.0.3

### Date: Thr Jan 11 15:00:00 2007 GMT

### User-Agent: AVT Client

### Connection: Keep-Alive

Furthermore, the Module obtainment request may be issued by adding an extension header X-Module-Request to the HTTP request. In this case, it is assumed that in the extension header X-Module-Request, the type of the Module within the requested multimedia data, and section information for which transmission is requested are delimited by a semicolon “;”. An example of the generated extension header is shown below.

X-Module-Request: type=module; carouselID=0x0001; ModuleID=0x0001; ModuleVersion=0

Therefore, an HTTP request like the example below is issued.

### <Module Request 2>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Module-Request: type=module; carouselID=0x0001; ModuleID=0x0001; ModuleVersion=0

Note that although Carousel_id, Module_id, and ModuleVersion are used here as the information for identifying a Module, any kind of request is acceptable as long as it is a method allowing specification of the Module to be obtained. Note that as an example, a method which specifies the timing of the Module to be obtained, using media time instead of the ModuleVersion. For the method which uses media time, it is possible to use the same method specified in the section requests 3 to 5. Here, as an example, only a Module request 3 corresponding to the section request 3 is shown below.

### <Module Request 3(1)>

GET http://192.168.0.3/AVData/0001.m2ts?type=Module&Carous el_id=0x0001&ModuleId=0x0002&media time=00:00:15 HTTP/1.1

### Host: 192.168.0.3

### Date: Thr Jan 11 15:00:00 2007 GMT

### User-Agent: AVT Client

### Connection: Keep-Alive

### <Module Request 3(2)>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Section-Request: type=module; carousel_id=0x0001; module_id=0x0002; media_time=00:00:15

Moreover, as another example of a request generated by the message processing unit 2801c, in the case where an obtainment request for an Object associated with a multimedia data URI of http://192.168.0.3/AVData/0001.m2ts is received and path=/a/TopXlet.class, Media_time=00:09:00 is specified as the condition of the Object to be obtained, an HTTP request such as the following is generated.

### <Object Request 1>

GET http://192.168.0.3/AVData/0001.m2ts?type=Object&path=/a /TopXlet.class&media_time=00:09:00 HTTP/1.1

### Host: 192.168.0.3

### Date: Thr Jan 11 15:00:00 2007 GMT

### User-Agent: AVT Client

### Connection: Keep-Alive

Furthermore, the Object obtainment request may be issued by adding an extension header X-Object-Request to the HTTP request. In this case, it is assumed that in the extension header X-Object-Request, the type of the Object within the requested multimedia data, and section information for which transmission is requested are delimited by a semicolon “;”. An example of the generated extension header is shown below.

X-Module-Request: type=Object; path=/a/TopXlet.class Media_time=00:09:00

Therefore, an HTTP request like the example below is issued.

### <Object Request 2>

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Module-Request: type=Object; path=/a/TopXlet.class Media_time=00:09:00

Although a method which specifies a path and media time as information identifying the Object is described here, as long as it is information allowing identification of an Object included in the carousel, other information may be used and any kind of request is acceptable. As an example of using other information, it is acceptable to adopt a method which uses an Object ID, instead of a path, as information for identifying the Object. Furthermore, although the method which specifies the path from the root directory of the carousel is described here as the method for specifying the path, any kind of specifying is acceptable as long as it is a path allowing identification of an Object included in the carousel.

Note that although, as an example of a method for specifying the timing, a method using media time is described here, other specification methods are acceptable as long as it is information allowing identification of the timing. Furthermore, since the method for specifying the timing is the same as in the cases of transmitting a section and a Module, description shall be omitted.

Next, the control unit 2801a provides the HTTP request generated in the above manner, to the transmitting and receiving unit 2801e and causes it to transmit the HTTP request to the multimedia data transmitting apparatus 101.

In addition, the control unit 2801a requests the transmitting and receiving unit 2801e to receive an HTTP response from the multimedia data transmitting apparatus 101. An example of the received HTTP response is shown below.
Example of a response to a section request

### HTTP/1.1 200 OK

### Date: Thr Jan 11 15:00:01 2007 GMT

### Server: AVT Server

### Connection: Keep-Alive

Content-Type: application/octet-stream
(Empty line)
[Requested section data]

Furthermore, the Header generation unit 23e may generate an extension header indicating the type of section data included in the HTTP response. As an example, it is assumed that the extension header X-Section-Info is used to indicate the filtering condition for data included in the HTTP response, such as the PID and table_id, as well as media time which is the timing at which the section exists within the stream. Naturally, a condition specified by the HTTP request may be included. Note that the information included in the extension header X-Section-Info may be other information as long as it is information that allows identification of data included in the HTTP response.

X-Section-Info: type=section; pid=0x5014; tablie_id=0x3B; media_time=00:10:00

In other words, the HTTP response which includes the extension header including the information of data included in the HTTP response is a response as shown below.

### HTTP/1.1 200 OK

### Date: Thr Jan 11 15:00:01 2007 GMT

### Server: AVT Server

### Connection: Keep-Alive

Content-Type: application/octet-stream
X-Section-Info: type=section; pid=0x5014; tablie_id=0x3B; media_time=00:10:00

### (Empty Line)

[Requested section data]

Furthermore, although a method which describes information included in the HTTP response, using an extension header, is described here, other formats are acceptable.
Example of a response to a Module request

### HTTP/1.1 200 OK

### Date: Thr Jan 11 15:00:01 2007 GMT

### Server: AVT Server

### Connection: Keep-Alive

Content-Type: application/octet-stream

### (Empty Line)

[Requested Module data]

Note that the Header generation unit 23e may generate an extension header indicating the type of Module included in the HTTP response. As an example, the extension header X-Module-Info includes the obtainment condition for data included in the HTTP response, such as the CarouselID and ModuleID, as well as media time which is the timing at which the section exists within the stream. Naturally, a condition specified by the HTTP request may be included. Note that the information included in the extension header X-Module-Info may be other information as long as it is information that allows identification of data included in the HTTP response.

X-Module-Info: type=module; carouselID=0x0001; ModuleID=0x0001; ModuleVersion=0

In other words, the HTTP response which includes the extension header including the information of data included in the HTTP response is a response as shown below.

### HTTP/1.1 200 OK

### Date: Thr Jan 11 15:00:01 2007 GMT

### Server: AVT Server

### Connection: Keep-Alive

Content-Type: application/octet-stream
X-Module-Info: type=module; carouselID=0x0001 ModuleID=0x0001; ModuleVersion=0

### (Empty Line)

[Requested Module data]

Furthermore, although a method which describes information included in the HTTP response, using an extension header, is described here, other formats are acceptable.
Example of a response to an Object request

### HTTP/1.1 200 OK

### Date: Thr Jan 11 15:00:01 2007 GMT

### Server: AVT Server

### Connection: Keep-Alive

Content-Type: application/octet-stream

### (Empty Line)

[Requested Object data]

Note that the Header generation unit 23e may generate an extension header indicating the type of Object included in the HTTP response. As an example, the extension header X-Object-Info includes the path, as well as media time which is the timing at which the Object is obtained from within the stream. Naturally, the condition specified in the HTTP request may be included as it is. Note that the information included in the extension header X-Object-Info may be other information as long as it is information that allows identification of data included in the HTTP response.

X-Object-Info: type=Object; path=/a/TopXlet.class; Media_time=00:09:00

In other words, the HTTP response which includes the extension header including the information of data included in the HTTP response is a response as shown below.

### HTTP/1.1 200 OK

### Date: Thr Jan 11 15:00:01 2007 GMT

### Server: AVT Server

### Connection: Keep-Alive

Content-Type: application/octet-stream
X-Object-Info: type=Object; path=/a/TopXlet.class; Media_time=00:09:00

### (Empty Line)

[Requested Object data]

Furthermore, although a method which describes information included in the HTTP response, using an extension header, is described here, other formats are acceptable.

Then, the control unit 2801a passes the received HTTP response message to the judgment unit 2801d, and requests for the interpretation thereof.

The judgment unit 2801d first checks the response code of the HTTP response. When the result is 200 OK, the judgment unit 2801d notifies the fact to the control unit 2801a. Then, the control unit 2801a records on the first memory 2402, the received data in the body portion of the HTTP response, and notifies the library that issued the data obtainment request.

As described above, by requesting the section, Module, or Object, they can be obtained separately from the recorded stream. By implementing such a method, the multimedia data receiving apparatus 102 can obtain required data from the multimedia data transmitting apparatus 101, even in the case where data for data broadcasting cannot be obtained, such as during trick play

### Third Embodiment

In the first and second embodiments, in response to an obtainment request for a stream, a Section, a Module, and an Object, from the multimedia data receiving apparatus 102, the multimedia data transmitting apparatus 101 selects data conforming to the request, and sends the selected data to the multimedia data receiving apparatus 102. On the other hand, the present embodiment is characterized in that the event table or data table managed by the multimedia data transmitting apparatus 101 is transmitted to the multimedia data receiving apparatus 102, and the multimedia data receiving apparatus 102 takes into account the occurrence of a version up and judges whether or not to send a request to the multimedia data transmitting apparatus 101. Note that, in this manner, since the multimedia data receiving apparatus 102 is able to judge the necessity for issuing a data obtainment request to the multimedia data transmitting apparatus 101, by detecting a version up for each data, there is the advantage of being able to suppress traffic on the network by issuing a request, for example, only when a version up has occurred. Furthermore, in the first embodiment, it was necessary for the multimedia data receiving apparatus 101 to definitely transmit event information included in the event table, to the multimedia data receiving apparatus 102, even during trick play. However, in the present embodiment in which the event table is transmitted to the multimedia data receiving apparatus 102, since the multimedia data receiving apparatus 102 can detect an event, such a process does not necessarily have to be performed.

First, the multimedia data transmitting apparatus 101 shall be described.

Although description of the multimedia data transmitting apparatus 101 shall be omitted since it performs the same processes for all or a part of the functions described in the first and second embodiment, the multimedia data transmitting apparatus 101 described in the present embodiment has the function for transmitting the event table or data table in response to a request from the multimedia data receiving apparatus 102.

Here, as an example, the extension header X-Index-Request is used for the obtainment request for an event table and data table to the multimedia data transmitting apparatus 101. Note that the format of the request may be any format as long as it is a format which can be interpreted as the obtainment requests for any one of an event table, a data table, or both.

The operation of the network library 405e in the present embodiment is described using the example in which a request such as the one below is received. Note that the configuration of the network library 405e in the present embodiment is the same as that shown in FIG. 23A.

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Index-Request: type=Event table
X-Index-Request: type=Data table

When the received request message is valid, the control unit 23b obtains, from the URI of the content specified by the client, an identifier such as the name of the recorded stream (here, 0001.m2ts) and “Event table” “Data table” specified through the as extension header X-Index-Request, and passes these to the data obtainment unit 23b. The control unit 23b generates the header of the HTTP response message by passing, to the Header generation unit 23e, information required in the generation of a header, such as the result of the processing by the data obtainment unit 23d and type of data to be transmitted. Note that the control unit 23b separates the data obtained by the data obtainment unit 23d, and generates the HTTP response from the stream that is separated from the generated header. Subsequently, the control unit 23b transmits the generated HTTP message to the request-source terminal by passing it to the information transmitting unit 23f.

The data obtainment unit 23d reads the stream association table 2200 shown in FIG. 21 or the stream association table 3400 shown in FIG. 34 by requesting the IO 405g. Here, the stream association table 3400 is used as an example. The data obtainment unit 23d checks for the existence of a content associated with the identifier received from the control unit 23b, by referring to the identifier received from the control unit 23b and the column 2201 and comparing identifiers such as the name of the recorded stream. In the case where an associated content does not exist, the data obtainment unit 23d notifies such error details to the control unit 23b, and the process ends. On the other hand, when an associated content exists, the data obtainment unit 23d obtains the storage location of the recorded stream whose identifier is identical. In addition, in case where “Event table” is specified as the “type”, the data obtainment unit 23d obtains the identifier 2204 such as the name of the event table and the storage location 2205 of such event table, or in case where “Data table” is specified as the type, the data obtainment unit 23d obtains the data table identifier 3406 and the storage location 3407 of the data table. Next, the data obtainment unit 23d obtains the event table (FIG. 20, FIG. 21) or the data table (any one of FIG. 33A, FIG. 33B, FIG. 35A, FIG. 35B, 3603 in FIG. 36C, FIG. 38, FIG. 40, FIG. 41, and FIG. 43) based on the obtained event table or identifiers 2204 and 3406 such as the table name of a data table, and the storage locations 2205 and 3407 of the event table, and passes the event table or data table to the control unit 23b. Note that it is acceptable to adopt a method in which the storage locations (column 2004 in FIG. 20, columns 3303 and 3333 in FIGS. 33A and 33B, and column 3616 in FIG. 36C) held by the respective event tables and data tables are deleted from the tables transmitted to the multimedia data receiving apparatus 102, the multimedia data receiving apparatus 102 issues an obtainment request as in the first and second embodiments, and the multimedia data transmitting apparatus 101 transmits the requested data by also referring to the same event table and data table; and it is also acceptable to adopt a format of replacing these storage locations with the URLs which indicate the locations where those data are stored in the second memory 203, and the multimedia data receiving apparatus 102 directly specifies and obtains the data.

Note that, here, event when an event table or data table does not exist, the HTTP response is not made an error as long as the requested recorded stream “000.1 m2ts” exists, and the following notification is made using an extension header X-Index-Response of the HTTP response.

X-Index-Response: result=no event table, no data table

The Header generation unit 23e generates the HTTP response header based on data required for header generation such as the result for the HTTP request, received from the control unit 23b, and the event table or data table obtained by the data obtainment unit 23d, and returns the generated header to the control unit.

The information transmitting unit 23f transmits, to the request-source terminal, the header generated by the Header generation unit 23e and the stream generated by the data obtainment unit 23d that are received from the control unit 23b. An example of a response for the case where the process is finished normally is shown.

### HTTP/1.1 200 OK

### Date: Thr Jan 11 15:00:01 2007 GMT

### Server: AVT Server

### Connection: Keep-Alive

Content-Type: video/mpeg
X-Index-Info: type=event table; url=http://192.168.0.3/table/0001_event.dat
X-Index-Info: type=data table url=http://192.168.0.3/table/0001_data.dat

### (Empty Line)

[Data of the stream generated by the data obtainment unit 23d, described in the first embodiment]

Furthermore, a response for the case where the event table and data table do not exist is shown.

### HTTP/1.1 200 OK

### Date: Thr Jan 11 15:00:01 2007 GMT

### Server: AVT Server

### Connection: Keep-Alive

Content-Type: video/mpeg
X-Index-Response: type=event table; result=no event table
X-Index-Response: type=data table; result=no data table

### (Empty Line)

[Data of the stream generated by the data obtainment unit 23d, described in the first embodiment]

By way of the multimedia data transmitting apparatus 101 returning a response such as that described above, the multimedia data receiving apparatus 102 obtains the URL of each table in the case where the event table and data table exist in the multimedia data transmitting apparatus 101. In addition, by issuing an HTTP response of an obtainment request to the multimedia data transmitting apparatus 101, using the respective URLs, the multimedia data receiving apparatus 102 can obtain the event table and the data table.

Next, the multimedia data receiving apparatus 102 shall be described.

Since the multimedia data receiving apparatus 102 is already described in the first and second embodiments, description of processes performing the same functions shall be omitted, and only the differences shall be described herein.

The multimedia data receiving apparatus 102 described in the present embodiment is characterized in performing the process of referring to the event table and data table and checking for the occurrence of a version up of data, that was performed by the multimedia data transmitting apparatus 101 in the second embodiment.

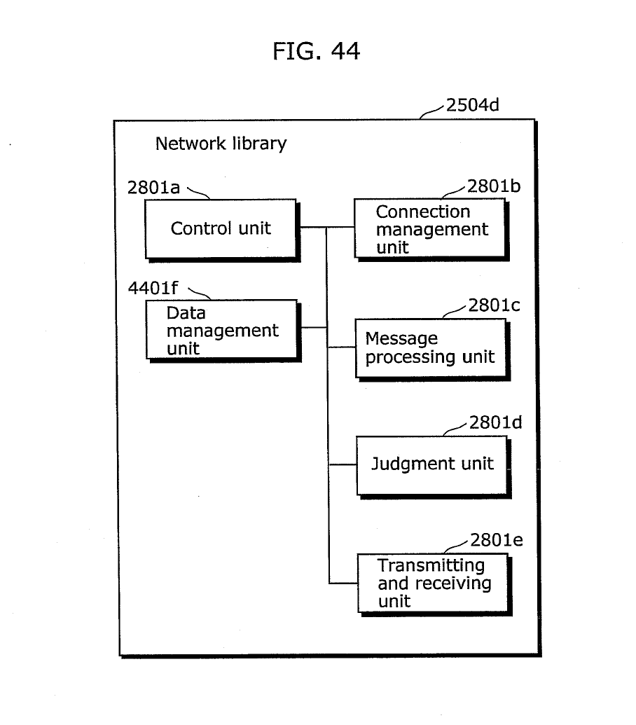

FIG. 44 shows the configuration of the network library 2504d described in the present embodiment. The data management unit 4401f holds the following three functions or a part thereof.

[Data Management]

The data management unit 4401f manages the event table and data table obtained by the multimedia data receiving apparatus 102 and the obtained data. More specifically, the data management unit 4401f deletes obtained data at the timing in which a version up of the managed data occurs.

[Data Update Notification]

The data management unit 4401f checks the event table and data table, and notifies an update to each library from which an update notification request is received, at the timing in which a version up occurs. For example, by requesting for an update notification request by the control unit 2801a, the network library 2504d can terminate a request in the case where an update occurs for the data for which the network library 2504d is currently issuing an obtainment request, to the multimedia data transmitting apparatus 101. Furthermore, as another example, by issuing an update notification request to the network library 2504d from each library which requests data obtainment, the multimedia data receiving apparatus 102 can detect the timing of an occurrence of version up of requested data such as a section, and can thus notify the application of the occurrence of the version up, or utilize this in changing internal processing.

[Advanced Obtainment of Data]

The data management unit 4401f can check the event table and the data table, and obtains, in advance, required data from the multimedia data transmitting apparatus 101, before requests are ordered from the respective libraries of the multimedia data receiving apparatus 102. With this, since data can already be obtained in advance by the timing in which the respective libraries require the data, the multimedia data receiving apparatus 102 can reduce the time created for obtaining data from the multimedia data transmitting apparatus 101. Furthermore, in particular, by obtaining, in advance, associated data at the timing in which the associated data are required for implementing a data broadcast, it becomes possible to correctly implement the data broadcast.

Note that constituent elements in FIG. 44 that are affixed with the same numerical reference as in FIG. 28 perform the same processing as in FIG. 28. As such, only the differences from FIG. 28 shall be described herein.

When the control unit 2801a of the network library 2504d receives requests for data obtainment from the respective libraries, the control unit 2801a passes, to the data management unit 4401f, the information of the received data obtainment requests. The data management unit 4401f checks whether data associated with the data obtainment request received from the control unit 2801a already exists in the data already being held. In the case where the requested data does not exist in the data held by the data management unit 4401f, the data management unit 4401f notifies the control unit 2801a of the fact that the non-existence of the requested data. Upon receiving the above notification, the control unit 2801a performs the same processing as described in the first and second embodiments, and data obtainment from the multimedia data transmitting apparatus 101 is performed. On the other hand, in the case where the requested data already exists in the data management unit 4401f, the data management unit 4401f checks whether a version up has occurred for the data by performing the same processing performed by the multimedia data transmitting apparatus 101 in the first and second embodiments. In the case where a version up has occurred, the data management unit 4401f notifies the control unit 2801a that the data does not exist. Upon receiving the above notification, the control unit 2801a performs the same processing as described in the first and second embodiments, and data obtainment from the multimedia data transmitting apparatus 101 is performed. Furthermore, in the case where a version up has not occurred, the data management unit 4401f passes the data held by the data management unit to the control unit 2801a. The control unit 2801a passes the data received from the data management unit 4401f to the respective libraries.

Furthermore, the data management unit 4401f can accept requests for the observation of data updates. Upon the time of the media time at which each requested data is updated, the data management unit 4401f notifies the library or the control unit 2801a issuing the data update request of the fact that a version up has occurred. Note that, since the data management unit 4401f obtains the media time, another library, such as the JMF 2504a, may be used, and implementation is also possible through a method in which the time is counted within the data management unit 4401f. Furthermore, although the case where timing is specified using media time is described here, information other than the media time may be used in the method for specifying the timing.

Furthermore, when a recording data obtainment request is issued by the JMF 2504a, and the like, the data management unit 4401f can forecast the data to be required by referring to the event table and data table, and obtain the data from the multimedia data transmitting apparatus 101. As an example, in the case where the event table in FIG. 21 is obtained, it is acceptable to adopt a method which obtains, in advance, the PAT 2010, the PMT 2011, the AIT 2012, the DSI 2013, and the DII 2014, which will be required during the implementation of a data broadcast. In addition, since timing is to important with regard to the events of a data broadcast, when obtaining an event in advance, it is also acceptable to adopt a method which obtains, in advance, the NPT 2017, the StreamEvent 2018, and the StreamEvent 2019.

Moreover, with regard to the data table, it is also acceptable to adopt a method in which, as an example, the data management unit 4401f that has received the data table in FIG. 41 obtains, in advance, the Stream 3628 and the StreamEvent 3626 which are data associated with the timing of the data broadcast. Furthermore, it is also acceptable to adopt a policy in which the data management unit 4401f obtains, in advance, all the data of 3621 and 3628.

Furthermore, it is also acceptable to adopt a policy of controlling in which, since it is known that the Object in 3623 will be updated at a media time of 10:00, the data management unit 4401f obtains, in advance, relevant Objects from 10:00 onward, so that even when a version up occurs, there is no need to send an obtainment request to the multimedia data transmitting apparatus 101.

Furthermore, it is also acceptable to adopt a method in which, during the obtainment of the AIT of the event table 2012, the data management unit 4401f obtains, in advance, the data specified by the program name (for example: 2604 in FIG. 19) described in the AIT.

In this manner, by having the multimedia data receiving apparatus 102 manage the event table and the data table, required data management or version up detecting and, in addition, advanced data obtainment from the multimedia data transmitting apparatus 101 become possible, and thus implementation of data broadcast with consideration to timing is possible.

Note that although a method in which the data management unit 4401f manages the event table and data table is described here, another library may implement this function.

### Fourth Embodiment

Hereinafter, the fourth embodiment of the present invention shall be described with reference to FIGS. 1 to 3, FIGS. 5A to 12, and FIGS. 45 to 54 used in the first embodiment.

FIG. 1 is a configuration diagram for the multimedia content communication system in the fourth embodiment of the present is invention. In FIG. 1, 101 denotes a multimedia data transmitting apparatus in the present invention, 102 denotes a multimedia data receiving apparatus in the present invention, 103 denotes a network, and 104 denotes a multimedia content communication system made up of these elements. The multimedia data transmitting apparatus 101 and the multimedia data receiving apparatus 102 are connected to the network 103, and can communicate with each other via the network 103. In addition, 105 denotes a cable television broadcast station, 106 denotes a cable connecting the multimedia data transmitting apparatus 101 and the broadcast station 105.

The multimedia data transmitting apparatus 101 in the present embodiment is a CATV Set Top Box (STB) which includes a network interface and a storage unit for storing multimedia data. The multimedia data transmitting apparatus 101 is connected to the broadcast station 105 via the cable 106. In addition, the multimedia data transmitting apparatus 101 stores the multimedia data of a digital broadcast content received from the broadcast station 105, in the storage unit. Furthermore, the multimedia data transmitting apparatus 101 is connected to the network 103 via the network interface. In addition, the multimedia data transmitting apparatus 101 receives, through the network 103, requests transmitted from the multimedia data receiving apparatus 102. The multimedia data transmitting apparatus 101 transmits, in response to the request from the multimedia data receiving apparatus 102, the multimedia data of the digital broadcast content received from the broadcast station 105, or information about stored multimedia data, to the multimedia data receiving apparatus 102, through the network 103.

Moreover, the digital broadcast content stored by the multimedia data transmitting apparatus 101 in the storage unit is data in the MPEG-2-TS format.

The multimedia data receiving apparatus 102 transmits a is transmission request for a list of contents that can be provided, to the multimedia data transmitting apparatus 101, according to a user's request. Then, it receives a list of contents from the multimedia data transmitting apparatus 101 as a response to the request, and presents the list to the user. In addition, the multimedia data receiving apparatus 102 transmits, to the multimedia data transmitting apparatus 101, a transmission request for the multimedia data of a content selected by the user. The multimedia data receiving apparatus 102 receives multimedia data as a response to the request, and reproduces the received data, and as then presents it to the user. In addition, upon receiving a request for trick play such as fast-forward, reverse, and the like from the user, the multimedia data receiving apparatus 102 implements the trick play by: once stopping the communication of multimedia data; successively issuing, anew, transmission requests for parts necessary in the trick play; each time receiving and reproducing multimedia data

The network 103 is a home network established in the household, and is an IP network configured of the Ethernet, wireless LAN, and so on.

Hereinafter the communication and respective operations of the multimedia data transmitting apparatus 101 and the multimedia data receiving apparatus 102 shall be described.

When connected to the network 103, the multimedia data transmitting apparatus 101, which is a multimedia data server, notifies other devices that it is a server that can provide services, by broadcasting such information to the network 103. In addition, according to a request from another device connected to the network 103, the multimedia data transmitting apparatus 101 transmits the information of services provided by the multimedia transmitting apparatus 101 and the access methods of each service to the request-source apparatus. When connected to the network 103, the multimedia data receiving apparatus 102, searches for server devices connected to the network 103, and obtains what functions each of the server devices have. Since these communications are carried out as defined by the UPnP Device Architecture (DA), in the same manner as with DLNA, detailed description shall be omitted. With this, the multimedia data receiving apparatus 102 can recognize that the multimedia data transmitting apparatus 101 is a multimedia server which is connected to the network 103.

Hereinafter, the communication of multimedia data between the multimedia data transmitting apparatus 101 and the multimedia data receiving apparatus 102 shall be described in sequence.

First, the multimedia data receiving apparatus 102 issues a transmission request for a list of contents that can be provided, to the multimedia data transmitting apparatus 101. Then, upon receiving the request, the multimedia data transmitting apparatus 101 retrieves the contents that can be provided, and replies to the multimedia data receiving apparatus 102, with the list. This communication can be carried out using the Browse or Search of the UPnP AV Content Directory Service (CDS), and thus detailed description shall be omitted.

Upon receiving, from the multimedia data receiving apparatus 102, the transmission request for the list of contents that can be provided, to the multimedia data transmitting apparatus 101 replies with a list of contents stored in the storage unit. Since a list defined by the UPnP AV or DLNA can be used for the list to be transmitted, detailed description shall be omitted.

Receiving the provided content list, the multimedia data receiving apparatus 102 presents this list to the user. Then, the multimedia data receiving apparatus 102 requests, to the multimedia data transmitting apparatus 101, the transmission of multimedia data of the content selected by the user. The multimedia data transmitting apparatus 101 reads the requested content data from the storage unit, and transmits this to the multimedia data receiving apparatus 102. In the communication of the multimedia, communication is performed using HTTP which is a mandatory protocol in DLNA.

Here, when trick play is requested by the user, the multimedia data receiving apparatus 102 implements trick play by repeating: judging the necessary data sections according to the type of trick play such as fast-forward, reverse, slow; receiving and reproducing data of only such sections; and displaying the reproduced data. As such, when trick play is implemented, there are cases where the multimedia data receiving apparatus 102 cannot obtain all the TS packets of the multimedia data. In this case, for example, even when the update occurs, such as version up, in the information within the multimedia data such as a table representing TV-program composition necessary for reproduction or a table representing data broadcast applications, the multimedia data receiving apparatus cannot detect such updates. Therefore, there occur instances such as not being able to perform reproduction correctly or not being able to activate or run the data broadcast application. Consequently, the multimedia data receiving apparatus 102 requests for the transmission of update-point information to the multimedia data transmitting apparatus 101.

Such communication can be carried out as follows.

It is assumed that the Uniform Resource Identifier (URI) of the multimedia data is http://192.168.0.3/AVData/0001.m2ts. In addition, the request for the update-point information for the information within the multimedia data is performed by adding an extension header X-Version-Request to the HTTP request. In the extension header X-Version-Request, the type of the update-point within the multimedia data that is requested, and the scope of occurrence of the update-point whose transmission is requested, are delimited by a semicolon “;”. Furthermore, it is assumed that “type” is used as a specifier indicating the type of the update-point, and this is specified as “type=xx”. As an example of the types of the update-point within the multimedia data whose transmission is requested, the table representing TV-program composition is specified as si, and the table representing data broadcast applications is specified as ait. Furthermore, it is assumed that for the scope of occurrence of the update-point whose transmission is requested, a specifier “scope” is used and specifying is carried out as “scope=yy”. In the case where a transmission request for all the update-points within the multimedia data is issued, this is specified as “all”. Specifying of the transmission request scope shall be described later. For example, in the case where a transmission request for version information of a table representing data broadcast applications is issued for the whole of the multimedia data, the following extension header X-Version-Request is used.

X-Version-Request: type=ait; scope=all
Therefore, an HTTP request such as in the example below is issued from the multimedia data receiving apparatus 102 to the multimedia data transmitting apparatus 101.
GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Version-Request: type=ait; scope=all

Upon receiving this HTTP request, the multimedia data transmitting apparatus 101, together with transmitting the is multimedia data to the multimedia data receiving apparatus 102, detects the update-point information for the specified scope from the requested multimedia data, and transmits the detected update-point information to the multimedia data receiving apparatus 102.

Here, the multimedia data transmitting apparatus 101 replies by indicating the URI where the update-point information of the multimedia data is provided, using an extension header X-Version-Info of the HTTP response. As its values, the extension header X-Version-Info indicates the type of the information notifying the update-point by using the specifier “type”, and indicates the URI providing the update-point information by using a specifier “url”. For example, in the case of the response for the abovementioned request, when the URI providing the update-point is http://192.168.0.3/VUP/0001-ait.vup, the extension header X-Version-Info is as follows.

X-Version-Info: type=ait; url=http://192.168.0.3/VUP/0001-ait.vup

When the process is finished normally, the response is issued using 200 OK as a response code. Therefore, the response to the abovementioned request is as follows.

### HTTP/1.1 200 OK

### Date: Thr Jan 11 15:00:01 2007 GMT

### Server: AVT Server

### Connection: Keep-Alive

Content-Type: video/mpeg

### Content-Length: 47952

X-Version-Info: type=ait; url=http://192.168.0.3/VUP/0001-ait.vup

### (Empty Line)

[47952-byte data]

Furthermore, although a response is carried out using 200 OK as a response code when another error involving HTTP does not occur in the case where the type specified by “type” is incorrect with regard to the value of X-Version-Request in the request, the value of the extension header X-Version-Info is specified as an “Invalid type” notifying an incorrect request. For example, a response such as below is issued.

### HTTP/1.1 200 OK

### Date: Thr Jan 11 15:00:01 2007 GMT

### Server: AVT Server

### Connection: Keep-Alive

Content-Type: video/mpeg

### Content-Length: 47952

X-Version-Info: Invalid type

### (Empty Line)

[47952-byte data]

Furthermore, although a response is carried out using 200 OK as a response code when another error involving HTTP does not occur in the case where the type specified in the “scope” is incorrect with regard to the value of X-Version-Request in the request, the value of the extension header X-Version-Info is specified as an “Invalid scope” notifying an incorrect request. For example, a response such as below is issued.

### HTTP/1.1 200 OK

### Date: Thr Jan 11 15:00:01 2007 GMT

### Server: AVT Server

### Connection: Keep-Alive

Content-Type: video/mpeg

### Content-Length: 47952

X-Version-Info: Invalid scope

### (Empty Line)

[47952-byte data]

Furthermore, in the case where the received HTTP request includes an error concerning an HTTP other than that which was extended, such as when multimedia data corresponding to the requested URI does not exist, a response corresponding to the error is issued. In this case, even for the request including the X-Version-Request, the response does not include X-Version-Info.

Note that, here, any format is acceptable for the data that can be obtained from the resource specified by the URI specified in the X-Version-Info as long as both the multimedia data transmitting apparatus 101 and the multimedia data receiving apparatus 102 can get the same interpretation. Data written in chart form, data written in XML, binary section data, and the like are given as examples.

Furthermore, here, a method is described in which, due to the registration, in the HTTP request, of an extension X-Version-Request by the multimedia data receiving apparatus 102, the multimedia data transmitting apparatus 101 responds by adding an extension header X-Version-Info to the HTTP response. However, it is also possible to have an embodiment in which the update-point information is notified from the multimedia data transmitting apparatus 101 through the extension header X-Version-Info, without an explicit request for the update-point information being issued from the multimedia data receiving apparatus 102.

Furthermore, a method that appends, to the extension header X-Version-Info of the HTTP response, the update-point information in a stream is also acceptable. A method which indicates the size of actual data in “length”, and specifies the binary information of section data in “bytes” is given as an example. Furthermore, aside from this, a method which specifies the information converted into the text instead of binary information is also acceptable.

X-Version-Info: type=ait; length=100; bytes=110110010001001 . . . 1111

Furthermore, a method that specifies, in the extension header X-Version-Info of the HTTP response, the range specifying the byte position of multimedia data where there is the section data which transmits update-point information of the stream is also acceptable. As an example, the type of the section data is indicated by the “type” specifier and, in such type, the table representing the TV-program composition is specified as si or the table representing data broadcast applications is specified as ait. Furthermore, the range of the byte positions for transmitting section data is specified using a “bytes” specifier, with the beginning of the multimedia data being assumed as 0. Note that the range of the byte positions may also be specified by the packet number of TS packets. This can be easily calculated since a TS packet has a fixed length of 188 bytes.

X-Version-Info: type=ait; bytes=5000-10000

In addition, upon being notified of the range of the byte positions for transmitting the section data, the multimedia data receiving apparatus 102 can obtain the section data including the update-point information by issuing the multimedia data transmitting request again which specifies the specified range of the byte positions.

Note that although a method that individually indicates the table representing TV-program composition (si) and the table representing data broadcast applications (ait) is described here, a method that handles all the update-points in the multimedia data collectively is also acceptable. For example, between the multimedia data transmitting apparatus 101 and the multimedia data receiving apparatus 102, it is possible that the multimedia data transmitting apparatus 101 notifies, as one update-point information, all the update-points of the section data, such as si and ait, in the scope specified in the multimedia data when the value of “type” is specified as “all” in the extension header X-Version-Request.

Furthermore, although in the above description, a method in which the entire multimedia data is subject to the occurrence scope of the update-point information to be obtained, it is also possible to have a method in which, when an update-point occurs within a certain scope of the multimedia data, such update-point information is notified. For example, the specifying of the update-point transmission request scope, in the extension header X-Version-Request, may be specified with the byte position from the beginning of the multimedia data. This can be specified in the “scope” identifier by indicating the start point and end point with byte positions having 0 as the beginning of the stream, and connecting these with a hyphen. Furthermore, in the case where the end point is omitted, it is assumed that the scope is specified up to the end of the multimedia data. However, it is not possible to designate a plurality of scopes at the same time. For example, when it is assumed that the transmission start requested position of the requested scope of the update-points within the multimedia data is the 47940th byte, with the beginning of the multimedia data as 0; and the transmission end requested position is the 95879th byte, with the beginning of the multimedia data as 0; and the type of the requested update-point is the table representing data broadcast applications, the extension header is as follows.

X-Version-Request: type=ait; scope=47940-95879

Furthermore, in the case of requesting the information of the update-points of for the table representing the data broadcast applications, occurring up to the 47940th byte from the beginning of the multimedia data, the extension header is as follows.

X-Version-Request: type=ait; scope=0-47940

Furthermore, in the case of requesting the information of the update-points of for the table representing the data broadcast applications, occurring from the 47940th byte up to the end of the multimedia data, the extension header is as follows.

X-Version-Request: type=ait; scope=47940

In this manner, the HTTP response concerning the request including the extension header can be issued in the same format as the above-described response.

Note that although in the present embodiment the specifying of the occurrence scope of the update-points for which the transmission request is issued is specified using the byte positions in the multimedia data, the same effect can be obtained even with a method which specifies the elapsed time from the beginning of the content of the multimedia data.

Furthermore, by receiving the update-point information of the table representing the data broadcast applications (ait), the multimedia data receiving apparatus 102 is able to detect the updates in the management information of an application. Therefore, the activation and termination of an application becomes possible on the multimedia data receiving apparatus 102. At this time, the files of the application may be multiplexed in multimedia data and sent from the multimedia data transmitting apparatus 101 to the multimedia data receiving apparatus 102, and extracted from the received multimedia data on the multimedia data receiving apparatus 102, or it may be sent from the multimedia data transmitting apparatus 101 to the multimedia data receiving apparatus 102, separately from the multimedia data. The following shows, in the case of the latter, an example of a method in which the multimedia data receiving apparatus 102 obtains the files of the application from the multimedia data transmitting apparatus 101.

First, the multimedia data receiving apparatus 102 requests the multimedia data transmitting apparatus 101 for the information about the place where the files are stored. Here, it is assumed that the base directory is requested. This is set in the header of an HTTP request requesting the multimedia data, by using an extension header X-Tree-Base-Request such as the one below.

X-Tree-Base-Request: carousel_id=1

The HTTP request including this header is as in the example below.

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Tree-Base-Request: carousel_id=1

Upon receiving such HTTP request, the multimedia data transmitting apparatus 101 describes the directory in which the file tree of the application is stored, in the header of the HTTP response, using an extension header X-Tree-Base-Info, and transmits the response. An example of the X-Tree-Base-Info header is given below.

X-Tree-Base-Info: directory=/DVR/Content/0001/Carousel1/

In addition, an example of the HTTP response including the X-Tree-Base-Info header is given below.

### HTTP/1.1 200 OK

### Date: Thr Jan 11 15:00:01 2007 GMT

### Server: AVT Server

### Connection: Keep-Alive

Content-Type: video/mpeg

### Content-Length: 47952

X-Tree-Base-Info: directory=/DVR/Content/0001/Carousel1/

### (Empty Line)

[47952-byte data]

In the case of obtaining a file from the multimedia data transmitting apparatus 101, the multimedia data receiving apparatus 102 receiving this response is able to obtain the file since it is possible to identify the file by concatenating the obtained file directory and a file path and specifying with it. For example, when the path from the root directory of the HTTP server on the multimedia data transmitting apparatus 101 is returned by X-Tree-Base-Info, and in the case where it is assumed that the obtained base directory is “/DVR/Content/0001/Carousel1/”, the base directory of the application is “/”, and the relative path from the base directory of the application is “TestXlet1.class”, the multimedia data receiving apparatus 102 can receive the file from the multimedia data transmitting apparatus 101 by requesting “http://192.168.0.3/DVR/Content/0001/Carousel1/TestXlet1.class” to the multimedia data transmitting apparatus 101.

Furthermore, the same effect can be obtained even with a method in which the directory which is permitted to be mounted by Network File System (NFS) is notified by the X-Tree-Base-Info and the files are accessed by performing a network mount to the notified directory For example, by performing an NFS mount of the disk or directory on the multimedia data transmitting apparatus 101, that is indicated by “/DVR/Content/0001/Carousel1/” notified by X-Tree-Base-Info, the multimedia data receiving apparatus 102 can access the files under the directory.

Hereinafter, the multimedia data transmitting apparatus 101 and the multimedia data receiving apparatus 102 included in the multimedia content delivery system 104 shall be described in more detail.

First, the multimedia data transmitting apparatus 101 shall be described.

FIG. 2 is a block diagram showing the relationship of constituent elements included in the multimedia data transmitting apparatus 101 in the present embodiment. The multimedia data transmitting apparatus 101 includes an input unit 201, a first memory 202, a second memory 203, a receiving unit 204, a demultiplex unit 205, a descrambler 206, a TS decoder 207, a video output unit 208, an audio output unit 209, a TS multiplexer 210, a network unit 211, and a CPU 212.

The input unit 201 is configured of a front panel, remote control signal receiver, and the like, and accepts an instruction, such as a channel selection, from a user. FIG. 3 shows an example of the input unit 201 in the case where it is configured of a front panel. 300 is a front panel configured of 8 buttons, namely, an up-cursor button 301, a down-cursor button 302, a left-cursor button 303, a right-cursor button 304, an OK button 305, a cancel button 306, an EPG button 307, and a theater button 308. When the user presses down a button, the identifier of such pressed button is notified to the CPU 212.

The first memory 202 is configured of a RAM, or the like, and is used when the CPU 212 temporarily stores data.

The second memory 203 is configured of a device that can hold information even when power is turned off, such as a flash memory, a hard disk, or the like, and stores a program executed by the CPU 212. For the second memory, a detachable storage device such as an SD memory card and the like may also be used.

The receiving unit 204 is connected to the cable from a CATV station from which it receives broadcast waves. The receiving unit 204 tunes to the frequency specified by the CPU 212, extracts an MPEG transport stream and passes the extracted MPEG transport stream to the demultiplex unit 205.

The demultiplex unit 205 receives the MPEG transport stream from the receiving unit 204, extracts information specified by the CPU 212 and passes it to the CPU 212. In addition, it passes the MPEG transport stream to the descrambler 206 as it is.

The descrambler 206 descrambles (=decrypts) the scrambled MPEG transport stream provided by the demultiplex unit 205, and passes the descrambled MPEG transport stream to the TS decoder 207. The descrambler 206 may be a module built-into the multimedia data transmitting apparatus 101, and may also be implemented through the CableCARD™ introduced in North American cable receivers. The specifications of CableCARD is described in the CableCARD Interface Specification laid out by the CableLabs in the United States, and thus description is omitted herein.

The TS decoder 207 receives, from the CPU 212, identifiers of is audio data, video data and section data such as PSI/SI information and so on. In addition, the TS decoder 207 extracts, from the descrambled stream received from the descrambler 206, data corresponding to the received identifiers of audio data, video data, and section data such as PSI/SI information, and so on, and passes the extracted video data to the video output unit 208, and the audio data to the audio output unit 209. Furthermore, the TS decoder 207 passes both the extracted video data and audio data, as well as the section data, to the TS multiplexer 210.

The video output unit 208, which includes a video output as terminal, converts the received video data to video data that complies with the terminal and outputs this. An example of the terminal is a composite cable terminal, and so on.

The audio output unit 209, which includes an audio output terminal, converts the received audio data to audio data that complies with the terminal and outputs this. Examples of the terminal are earphone terminals, a composite cable terminal, and so on.

The TS multiplexer 210 configures an MPEG2 transport stream from the received video data, audio data, and section data, and passes the MPEG2 transport stream to the network unit 211. The PSI/SI information can be rewritten as necessary.

The network unit 211, which includes a network interface, converts the data received from the CPU 212 into a signal that is in accordance with the physical media of the network to which the network interface is connected to, and outputs this signal. Furthermore, the network unit 211 receives a signal from the network interface, converts the signal into a packet defined by the IP network, and passes the packet to the CPU 212.

The CPU 212 controls the receiving unit 204, the demultiplex unit 205, the descrambler 206, the TS decoder 207, the TS multiplexer 210, and the network unit 211 by executing a program is stored in the second memory 203.

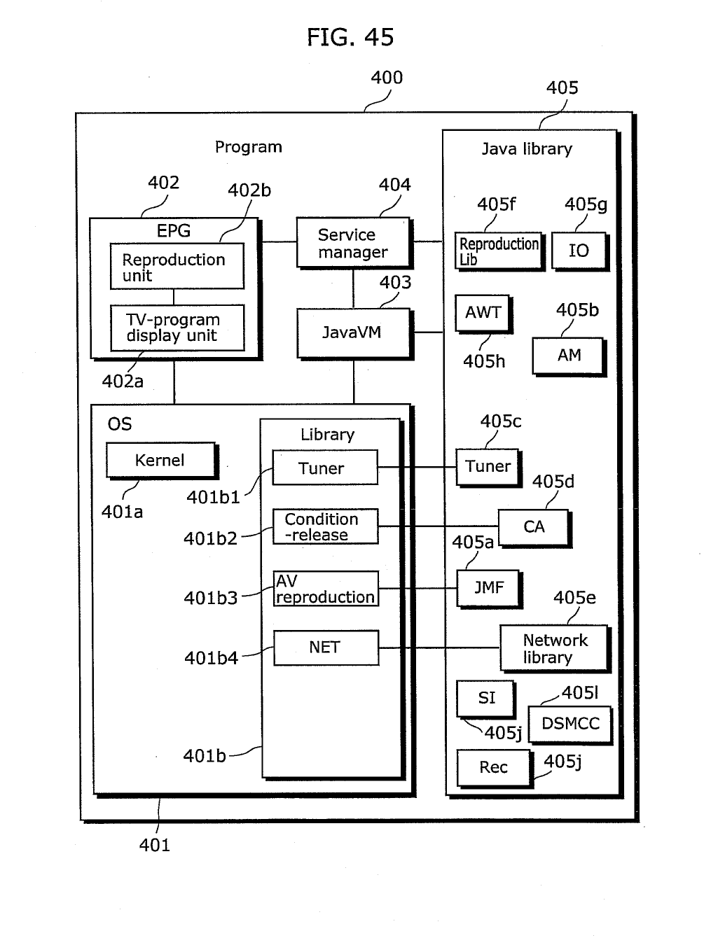

FIG. 45 is an example of a structure diagram of the program stored in the second memory 203 and executed by the CPU 212.

A program 400 is made up of plural subprograms, and is specifically made up of an OS 401 an EPG 402, a Java VM 403, a service manager 404, and a Java library 405.

The OS 401 is a subprogram activated on the CPU 212 when power to the multimedia data transmitting apparatus 101 is turned on. OS is the acronym for the operating system, an example of which is Linux and the like. The OS 401 is a generic name for publicly known technology made up of a kernel 401a for executing a subprogram concurrently with another subprogram and of a library 401b, and therefore detailed description is omitted. In the present embodiment, the kernel 401a of the OS 401 executes the EPG 402 and the VM 403 as subprograms. Furthermore, the library 401b provides these subprograms with plural functions required for controlling the constituent elements held by the multimedia data transmitting apparatus 101.

In the present embodiment, the library 401b includes a tuner 401b1, condition-release 401b2, AV reproduction 401b3, and NET 401b4, as an example of functions.

The tuner 401b1 receives tuning information including a frequency from other subprograms or a Tuner 405c of the Java library 405, and passes the received tuning information to the receiving unit 204. The receiving unit 204 can perform demodulation based on the provided tuning information, and pass the demodulated data to the demultiplex unit 205. As a result, the other subprograms and the Tuner 405c of the Java library 205 can control the receiving unit 204 through the library 401b.

The condition-release 401b2 receives information from other subprograms or a CA 405d of the Java library 405, and passes the received information to the descrambler 206.

The AV reproduction 401b3 receives the audio packet ID and video packet ID from the other subprograms or a JMF 405a of the Java library 405. The AV reproduction 401b3 then provides the received audio packet ID and video packet ID to the TS decoder 207. As a result, the TS decoder 207 performs filtering based on the provided packet IDs, and implements the reproduction of audio/video.

The NET 401b4 creates packets of a protocol lower than the application layer defined by the IP network, for the data received from the other subprograms or a network library 405e of the Java library 405. A protocol lower than the application layer refers to, for example, a TCP packet, a UDP packet, an IP packet, and so on. By passing this to the network unit 211, messages and data are transmitted to another device via the network 103. Furthermore, when a message is received from another device via the network 103, the NET 401b4 converts the message to an application layer protocol packet and passes this packet to the other subprograms or the network library 405e of the Java library 405. An application layer protocol refers to, for example, HTTP, Real-time Transport Protocol (RTP), and so on.

The EPG 402 is made up of a TV-program display unit 402a for displaying a list of TV-programs to the user as well as for accepting an input from the user, and a reproduction unit 402b for selecting channels. Here, EPG is an abbreviation of Electric Program Guide. The EPG 402 is activated by the kernel 401a when power to the multimedia data transmitting apparatus 101 is turned on. Inside the activated EPG 402, the TV-program display unit 402a and the reproduction unit 402b are activated at the same time. When activated, the TV-program display unit 402a waits for an input from the user through the input unit 201 of the multimedia data transmitting apparatus 101. Here, in the case where the input unit 201 is configured of a front panel as shown in FIG. 3, when the user is presses down the EPG button 307 of the input unit 201, the identifier of such EPG button is notified to the CPU 212. The TV-program display unit 402a of the EPG 402, which is a subprogram running on the CPU 212, accepts this identifier, then creates TV-program information display data, and displays this on a monitor 510 using a monitor output unit that is not shown in the figure. The monitor 510 may be included in the multimedia data transmitting-apparatus 101, and may also be a television connected to the multimedia data transmitting apparatus 101 by a composite cable, HDMI cable, or the like. The monitor 510 displays the received TV-program information display data. FIGS. 5A and 5B show examples of a TV-program list displayed on the monitor 510. Referring to FIG. 5A, TV-program information is displayed on the monitor 510 in a grid pattern. A column 501 displays time information. A column 502 displays a channel name “Channel 1” and TV-programs to be broadcast during time periods corresponding to the respective times described in the column 501. The monitor 510 shows that, on “Channel 1”, a TV-program “News 9” is broadcast from 9:00 to 10:30, and “Movie AAA” is broadcast from 10:30 to 12:00. As in the case of the column 502, a column 503 displays a channel name “Channel 2” and TV shows to be broadcast during time periods corresponding to the respective times described in the column 501. A TV show “Movie BBB” is broadcast from 9:00 to 11:00, and “News 11” is broadcast from 11:00 to 12:00. 530 is a cursor. The cursor 530 moves at the press of the left-cursor 303 or the right-cursor 304 on the front panel 300. When the right-cursor 304 is pressed down in the state illustrated in FIG. 5A the cursor 530 moves towards the right as shown in FIG. 5B. Furthermore, when the left-cursor 303 is pressed down in the state illustrated in FIG. 5B the cursor 530 moves towards the left as shown in FIG. 5A.

When the OK button 305 on the front panel 300 is pressed down in the state shown in FIG. 5A, the TV-program display unit 402a notifies the reproduction unit 402b of the identifier of the “Channel 1”. When the OK button 305 on the front panel 300 is pressed down in the state shown in FIG. 5B, the TV-program display unit 402a notifies the reproduction unit 402b of the identifier of the “Channel 2”.

Furthermore, through the demultiplex unit 205, the TV-program display unit 402a regularly stores in advance, in the second memory 203, TV-program information to be displayed. Generally, it takes time to obtain TV-program information from the broadcast station. It is possible to quickly display a TV-program table by displaying the TV-program information previously stored in the second memory 203, at the press of the EPG button 307 of the input unit 201

FIG. 6 shows an example of TV-program information stored in the second memory 203. The TV-program information is stored in tabular form. A column 601 describes the identifiers of channels. A column 602 describes TV-program names. A column 603 describes the broadcast start times of the TV-programs, and a column 604 describes the broadcast end times. A column 605 describes the sound type of the TV-programs, and indicates mono sound, stereo sound, and 5.1 channel sound as “mono”, “stereo”, and “5.1”, respectively. A column 606 describes the type of the TV-programs. A regular TV-program is described as an empty cell, a movie is described as “movie”, and a sports program is described as “spo”. Each of rows 611 to 614 describes information for one TV-program. In this example, one TV-program information is the set of the channel identifier, TV-program name, broadcast start time, broadcast end time, and TV-program sound type. For example, the row 611 describes a set which includes “1” as the channel identifier, “news 9” as the TV-program name, “9:00” as the broadcast start time, “10:30” as the broadcast end time, “mono” as the sound-type, and “regular” as the TV-program type.

The reproduction unit 402b reproduces a channel using the received identifier of the channel. In other words, it reproduces the video and audio making up the channel. The relationship between channel identifiers and channels is pre-stored in the second memory 203 as channel information. FIG. 7 shows an example of the channel information stored in the second memory 203. The channel information is stored in tabular form. A column 701 describes the identifiers of channels. A column 702 describes channel names. A column 703 describes tuning information. Here, the tuning information are values to be provided to the receiving unit 204, such as frequency, transmission rate, and coding ratio. A column 704 describes program numbers. Program numbers are numbers used to identify PMTs defined by the MPEG-2 standard. A description about PMT is given later. Each of rows 711 to 714 indicates a set of the identifier, channel name, and tuning information of each channel. The row 711 describes a set that includes “1” as an identifier, “Channel 1” as a channel name, a frequency of “150 MHz” as tuning information, and “101” as a program number. The reproduction unit 402b passes the identifier of the received channel directly to the service manager 404 in order to reproduce the channel.

Moreover, when the user presses down the up-cursor 301 or the down-cursor 302 on the front panel 300 while the reproduction is taking place, the reproduction unit 402b receives a notification about such pressing from the input unit 201 through the CPU 212, and changes the channel being reproduced accordingly. When the up-cursor 301 is pressed down, a channel having the next lower channel identifier to that of the currently-reproduced channel is reproduced, and when the down-cursor 302 is pressed down, a channel having the next higher channel identifier to that of the currently-reproduced channel is reproduced. First, the reproduction unit 402b stores, in the second memory 203, the identifier of the channel that is currently reproduced. FIGS. 8A, 8B, and 8C show example identifiers of channels stored in the second memory 203. FIG. 8A shows that an identifier “3” is stored, and by referring to FIG. 7, it is shown that a channel having the channel name “TV 3” is currently being reproduced. When the user presses down the up-cursor 301 in a state illustrated in FIG. 8A, the reproduction unit 402b refers to the channel information shown in FIG. 7, and passes the identifier “2” of a channel with the channel name of “Channel 2” to the service manager 404 in order to switch reproduction to the channel with the channel name of “Channel 2” as which is the channel having an identifier that is one value lower than that of the channel currently being reproduced. At the same time, the reproduction unit 402b rewrites the identifier stored in the second memory 203 to the channel identifier “2”. FIG. 8B shows the state in which the channel identifier has been rewritten.

Furthermore, when the user presses down the down-cursor 302 in a state illustrated in FIG. 8A, the reproduction unit 402b refers to the channel information shown in FIG. 7, and passes the identifier “4” of a channel having the channel name of “TV Japan” to the service manager 404 in order to switch reproduction to the channel having the channel name of “TV Japan” which is the channel having an identifier which is one value higher than that of channel currently being reproduced. At the same time, the reproduction unit 402b rewrites the identifier stored in the second memory 203 to the channel identifier “4”. FIG. 8C shows the state in which the channel identifier has been rewritten. The channel identifier is saved, even when power to the multimedia data transmitting apparatus 101 is cut-off, since it is stored in the second memory 203.

In addition, upon being activated when power to the multimedia data transmitting apparatus 101 is turned on, the reproduction unit 402b reads the channel identifier stored in the second memory 203. Then, the reproduction unit 402b passes such channel identifier to the service manager. With this, when power is turned on, the multimedia data transmitting apparatus 101 is able to start the reproduction of the last channel that was being reproduced at the time of its previous operation.

The Java VM 403 is a Java virtual machine that sequentially analyzes and executes programs written in the Java™ language. Programs written in the Java language are compiled into intermediate codes known as byte codes which are not dependent on hardware. A Java virtual machine is an interpreter that executes such byte code. Some Java virtual machines pass the byte code to the CPU 212 after translating the byte code into an execution format which can be interpreted by the CPU 212, and executes it. The Java VM 403 is activated, with a Java program to be executed being specified by the kernel 401a. In the present embodiment, the kernel 401a specifies the service manager 404 as the Java program to be executed. Details of the Java language are described in many publications such as “Java Language Specification (ISBN 0-201-63451-1)”. Here, such details are omitted. Furthermore, the detailed operation of the Java VM itself is described in many publications such as “Java Virtual Machine Specification (ISBN 0-201-63451-X)”. Here, such details are omitted.

The service manager 404, which is a Java program written in the Java language, is sequentially executed by the Java VM 403. It is possible for the service manager 404 to call or be called by another subprogram not written in the Java language, through the Java Native Interface (JNI). The JNI is also described in many publications such as in the book “Java Native Interface” and so on. Here, such details are omitted.

First the process in the case of receiving a digital broadcast and reproducing the received multimedia data shall be described.

The service manager 404 accepts the identifier of a channel from the reproduction unit 402b, through the JNI.

The service manager 404 first passes the identifier of the channel to the Tuner 405c in the library 405, and requests for tuning. The Tuner 405c refers to the channel information stored in the second memory 203, and obtains the tuning information. Now, when the service manager 404 passes the identifier “2” of the channel to the Tuner 405c, the Tuner 405c refers to the column 712 shown in FIG. 7, and obtains the corresponding tuning information “156 MHz”. The Tuner 405c passes the tuning information to the receiving unit 204 through tuner 401b1 of the library 401b of the OS 401. The receiving unit 204 performs demodulation on the signal transmitted from the broadcast station, based on the provided tuning information, and passes the result to the demultiplex unit 205.

The service manager 404 requests the CA 405d inside the Java library 405 to perform descrambling. The CA 405d provides the descrambler 206 with information required for descrambling, through the condition-release 401b2 of the library 401b in the OS 401. On the basis of such provided information, the descrambler 206 descrambles the signal provided by the receiving unit 204, and passes the result to the TS decoder 207.

The service manager 404 provides the identifier of the channel to a JMF 405a inside the lava library 405, and requests for the reproduction of the video and audio.

First, the JMF 405a obtains, from a PAT and a PMT, packet IDs used to specify the video and audio to be reproduced. PAT and PMT are tables stipulated by the MPEG-2 standard that show the TV-program line-up included in an MPEG-2 transport stream. PAT and PMT are embedded in the payloads in packets included in an MPEG-2 transport stream, and sent together with audio and video. Refer to the Specification for details. Here, only the outline shall be described. PAT, which is an abbreviation of Program Association Table, is stored and sent in packets with the packet ID “0”. In order is to obtain the PAT, the JMF 405a specifies, to the demultiplex unit 205, the packet ID “0”, through the library 401b of the OS 401. The demultiplex unit 205 performs filtering based on the packet ID “0” and, by passing the result to the CPU 212, the JMF 405a collects the PAT packets. FIG. 9 is a chart which schematically shows an example of information of the collected PAT. A column 901 describes program numbers. A column 902 describes packet IDs. The packet IDs shown in the column 902 are used to obtain the PMT. Each of rows 911 to 913 is a pair of the program number of a channel and a corresponding packet ID. Here, three channels are defined. The row 911 defines a pair of the program number “101” and the packet ID “501”. Now, when the channel identifier provided to the JMF 405a is “2”, the JMF 405a refers to the column 912 in FIG. 9, so as to obtain the corresponding program number “102”, and then refers to the column 912 in the PAT shown in FIG. 9, so as to obtain the packet ID “502” corresponding to the program number “102”. PMT, which is an abbreviation of Program Map Table, is stored and sent in packets of the packet ID stipulated in the PAT. In order to obtain the PMT, the IMF 405a specifies the packet ID to the demultiplex unit 205, through the library 401b of the OS 401. Here, it is assumed that the packet ID specified is “502”. The demultiplex unit 205 performs filtering based on the packet ID “502” and, by passing the result to the CPU 212, the IMF 405a collects the PMT packets. FIG. 10 is a chart which schematically shows an example of information of the collected PMT. A column 1001 describes stream types. A column 1002 describes packet IDs. Information specified in the respective stream types is stored and sent in the payloads of packets with the packet IDs specified in the column 1002. A column 1003 describes supplementary information. Each of columns 1011 to 1014 is a pair of a packet ID and the type of information being transmitted, which is known as an elementary stream. The column 1011, which is a pair of the stream type “audio” and the packet ID “5011”, indicates that audio data is stored in the payload of the packet with the packet ID “5011”. The IMF 405a obtains, from the PMT, the packet IDs of the video and audio to be reproduced. Referring to FIG. 10, the IMF 405a obtains the audio packet ID “5011” from the row 1011, and the video packet ID “5012” from the row 1012.

Next, the JMF 405a passes the obtained audio packet ID and video packet ID to the AV reproduction 401b3 of the library 401b of the OS 401. Upon receiving this, the AV reproduction 401b3 provides the received audio packet ID and video packet ID to the TS decoder 207. The TS decoder 207 performs filtering based on such provided packet IDs. Here, the packet with the packet ID “5011” is passed to the audio output unit 209, and the packet with the packet ID “5012” is passed to the video output unit 208. The audio output unit 209 converts (for example, digital-analog conversion) the provided packet, as necessary, and outputs this. The video output unit 208 converts (for example, digital-analog conversion) the provided packet, as necessary, and outputs this.

Finally, the service manager 404 provides the channel identifier to an AM 405b inside the Java library 405, and requests for data broadcast reproduction. Here, data broadcast reproduction refers to extracting a Java program included in the MPEG-2 transport stream, and having it executed by the Java VM 403. As a method of encapsulating a Java program in an MPEG-2 transport stream, a method referred to as DSMCC, which is described in the MPEG Standard ISO/IEC 13818-6, is used. Here, detailed description of DSMCC shall be omitted. The DSMCC defines a method of encoding the file system made up of directories and files used by a computer in the packets of an MPEG-2 transport stream.

Here, the DSMCC 4051 in the Java library 405 obtains the data encoded according to the Object Carousel method. Furthermore, information about the Java program to be executed is embedded and sent in packets in the MPEG-2 transport stream in a format referred to as AIT. AIT is an abbreviation of Application Information Table defined in the 10th chapter of the DVB-MHP Standard (formally as, ETS TS 101 812 DVB-MHP Specification V1.0.2).

First, in order to obtain the AIT, the AM 405b obtains the PAT and PMT as in the case of the JMF 405a, so as to obtain the packet ID of the packet that stores the AIT. Now, when “2” is the identifier of the provided channel and the PAT shown in FIG. 9 and the PMT shown in FIG. 10 are being transmitted, the Rec 405j obtains the PMT shown in FIG. 10 according to the same procedure followed by as the JMF 405a. The AM 405b extracts, from the PMT, the packet ID of the elementary stream having a stream type of “Data” and which has “AIT” as supplementary information. Referring to FIG. 10, the elementary stream in the row 1013 corresponds to such description, and therefore the AM 405b obtains the packet ID “5013”.

The AM 405b provides the packet ID of the AIT to the demultiplex unit 205, through the library 401b of the OS 401. The demultiplex unit 205 performs filtering based on such provided packet ID, and passes the result to the CPU 212. As a result, the AM 405b can collect the packets of AIT. FIG. 11 is a chart which schematically shows an example of information of the collected AIT. A column 1101 describes the identifiers of lava programs. A column 1102 describes control information of the Java programs. The control information includes “autostart”, “present”, and “kill”.

“autostart” means that the multimedia data transmitting apparatus 101 automatically executes the program immediately. “present” means that the program is not executed automatically. “kill/” means that the program is to be terminated. A column 1103 describes DSMCC identifiers for extracting packet IDs including a lava program in the DSMCC format. A column 1104 describes program names of the lava programs. Each of rows 1111 and 1112 is a set of information about a lava program. The Java program defined in the row 1111 is a set of an identifier “301”, control information “autostart”, a DSMCC identifier “1”, and a program name “a/TopXlet”. The Java program defined in the row 1112 is a set of an identifier “302”, control information “present”, a DSMCC identifier “1”, and a program name “b/GameXlet”. Here, the two Java programs have the same DSMCC identifier which indicates that two lava programs are included within a single file system encoded in the DSMCC format. Here, only four items of information are stipulated for the respective Java programs, but more items of information are specified in actuality. Refer to the DVB-MHP standard for details.

The AM 405b finds the “autostart” Java program from within the AIT, and extracts the corresponding DSMCC identifier and Java program name. Referring to FIG. 11, the AM 405b extracts the Java program in the row 1111, and obtains the DSMCC identifier “1” and the Java program name “a/TopXlet”.

Next, using the DSMCC identifier obtained from the AIT, the AM 405b obtains, from the PMT, the packet ID of packets that store lava programs in the DSMCC format. More specifically, the AM 405b obtains, from within the PMT, the packet ID of the elementary stream whose stream type is “Data” and having a matching DSMCC identifier in the supplementary information.

Now, assuming that such DSMCC identifier is “1” and the PMT is that shown in FIG. 10, the elementary stream in the row 1014 matches, and the packet ID “5014” is to be extracted.

The AM 405b specifies the packet ID of the packet in which data is embedded in the DSMC format, to the demultiplex unit 205, through the library 401b of the OS 401. Here, the packet ID “5014” is provided. The demultiplex unit 205 performs filtering based on such provided packet ID, and passes the result to the CPU 212. As a result, the AM 405b can collect the required packets. The AM 405b reconstructs the file system from the collected packets, according to the DSMCC format, and stores this in the first memory 202 or the second memory 203. Extracting the data of a file system, and the like, and storing this in the first memory 202 or the second memory 203 shall hereafter be referred to as download.

FIG. 12 shows an example of a downloaded file system. In the figure, a circle denotes a directory and a square denotes a file. 1201 denotes a root directory, 1202 denotes a directory “a”, 1203 denotes a directory “b”, 1204 denotes a file “TopXlet.class”, and 1205 denotes a file “GameXlet.class.

Here, although an example of downloading a file system from an MPEG2 transport stream is described, the OCAP specification also stipulates downloading using an IP network, and so on. Furthermore, a method for identifying the location of a file system using information referred to as XAIT, instead of AIT, and downloading the file system is also stipulated.

Next, the AM 405 passes, to the Java VM 403, the Java program to be executed from within the file system downloaded into the first memory 202 or the second memory 203. Here, when the name of the Java program to be executed is “a/TopXlet”, the file “a/TopXlet.class”, having “.class” added to the end of the Java program name, is the file to be executed. “/” is a division of a directory and file name and, by referring to FIG. 12, the file 1204 is the Java program to be executed. Next, the AM 405b passes the file 1204 to the Java VM 403.

The Java VM 403 executes the Java program passed to it.

Upon receiving an identifier of an other channel, the service manager 404 stops the execution, through the respective libraries included in the Java library 405, of the video/audio and Java program currently being reproduced likewise through the respective libraries included in the Java library 405, and performs the reproduction of video/audio and execution of a Java program based on the newly received channel identifier.

Furthermore, the service manager 404 also includes a function for receiving the identifier of a channel from a Java program executed on the Java VM 403, aside from the reproduction unit 402b. Specifically, a Java language class for obtaining the identifier of the channel, and the method thereof, are provided. Upon receiving an identifier of a channel, the service manager 404 stops the execution, though the respective libraries included in the Java library 405, of the video/audio and Java program currently being reproduced likewise through the respective libraries included in the Java library 405, and subsequently performs the reproduction of new video/audio and the execution of a Java program based on the newly received channel identifier.

Next, the operation of receiving a digital broadcast and storing the multimedia data thereof, in the multimedia data transmitting apparatus 101 shall be described.

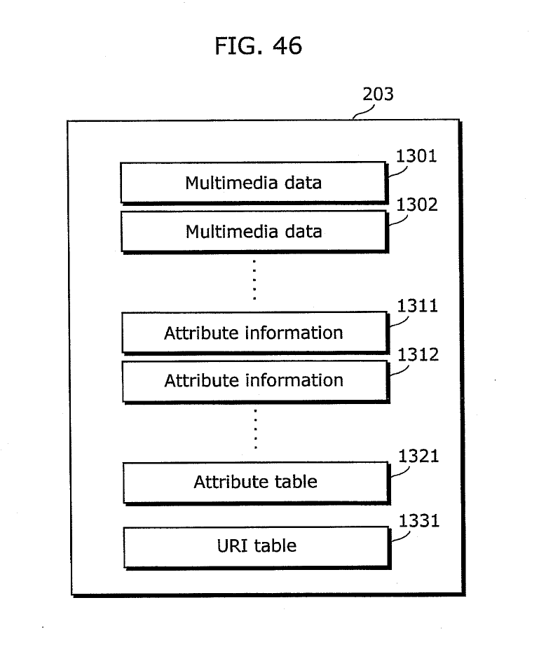

FIG. 46 is an example of the form of the storing of multimedia data into the second memory 203 by the multimedia data transmitting apparatus 101. The multimedia data transmitting apparatus 101 stores, in the second memory 203, multimedia data and its attribute information, an attribute information table, and a URI table. In FIG. 46, 1301, 1302, . . . denote multimedia data, 1311, 1312, . . . denote attribute information of the multimedia data, 1321 denotes an attribute information table, and 1331 denotes a URI table. The multimedia data 1301, 1302, . . . are multimedia data encoded in the MPEG-2 TS format, and encrypted. The attribute information 1311, 1312, . . . are additional information such as the title of each multimedia data. Here, the attribute information 1311 describes attribute information of the multimedia data 1301, the attribute information 1312 describes attribute information of the multimedia data 1302.

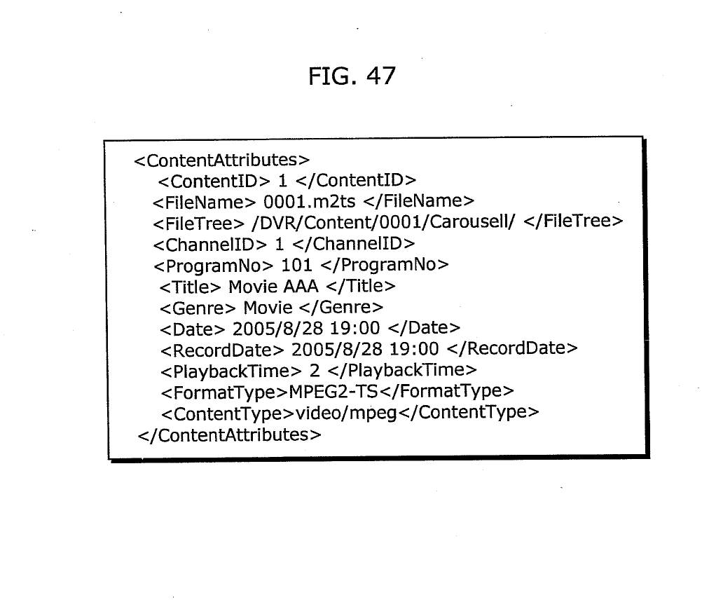

FIG. 47 shows an example of attribute information in the present embodiment. In the present embodiment, attribute is information is text defined in the Extensible Markup Language (XML). In FIG. 47, a ContentID element describes the identifier of a content; a FileName element describes the filename of the multimedia data; a FileTree element describe the directory name under which the file system configured of directories and files transmitted by an ObjectCarousel included in the multimedia data is stored; a ChannelID element describes an identifier of a channel on which the TV-program was broadcast, as shown in column 601 in FIG. 6; a ProgramNo element describes a program number for searching the PMT, as shown in column 704 in FIG. 7; a Title element describes the TV-program name as shown in column 602 in FIG. 6; a Genre element describes the type of the program, as shown in column 606 in FIG. 6; a Date element describes the date and time at which the TV-program was broadcast; a RecordDate element describes the date and time at which the TV-program was recorded; a PlaybackTime element describes the number of times the multimedia data has been reproduced or outputted to the network 103; a FormatType element describes the type of the media format of the content; and a ContentType element describes the Content-Type assigned to the media format of the content by the Internet Assigned Numbers Authority (IANA). Note that the attribute information is not limited to the XML configuration, and recording in other formats such as binary data is also possible.

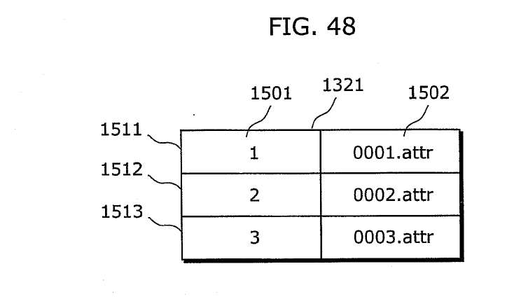

The attribute information table is a correspondence chart for the identifier of the content, the file on which the multimedia data of the content indicated by the identifier is recorded, and the file on which the attribute information is recorded. FIG. 48 shows an example thereof. In FIG. 48, a column 1501 describes the content identifiers, and a column 1502 describes file names of the attribute information. Rows 1511 to 1513 are pairs of the content identifier and the file name of the corresponding attribute information. From column 1511, it can be read that the attribute information of the content for identifier 1 is recorded in the file 0001.attr.

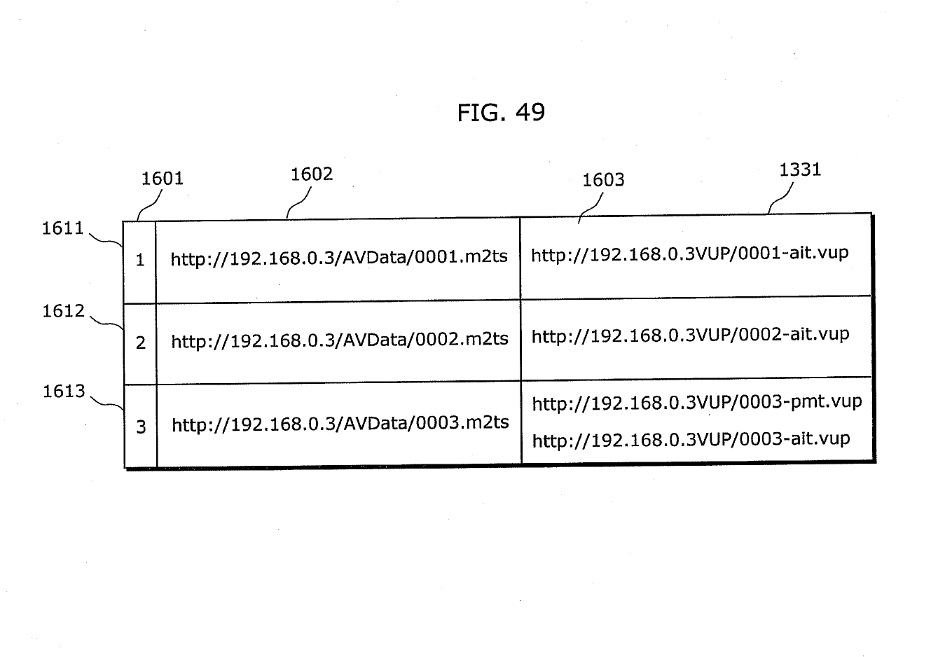

FIG. 49 shows an example of the structure of the URI table 1331. In FIG. 49, a column 1601 describes the identifiers of respective contents, and a column 1602 describes URIs for accessing the respective contents. A column 1603 describes URIs for accessing data holding update-point information of section data of AIT, PMT and the like. Rows 1611 to 1613 show sets of the identifier and URIs of respective contents. For example, row 1611 indicates that the URI of the content for identifier 1 is http://192.168.0.3/AVData/0001.m2ts., and the URI of the file holding the update-point information of an AIT section is http://192.168.0.3/VUP/0001-ait.vup.

Hereinafter, the storing process shall be described. First, the operation up to descrambling is the same as in the case of the previously described reproduction. Next, the service manager 404 requests, the CA 405d, for the obtainment of protection necessary/unnecessary information concerning the multimedia data and, in the case where protection is necessary, information on the kind of protection. This information shall be called protection information. The CA 405d receives the protection information of the multimedia data from the descrambler 206, and passes the received protection information to the service manager 404. Next, the service manager 404 judges, from the protection information passed on to it, whether or not the multimedia data can be stored. Only in cases where storing is possible does the service manager 404 request the storing of the multimedia data, and the recording of the update-point within the multimedia data, to the Rec 405j inside the Java library 405.

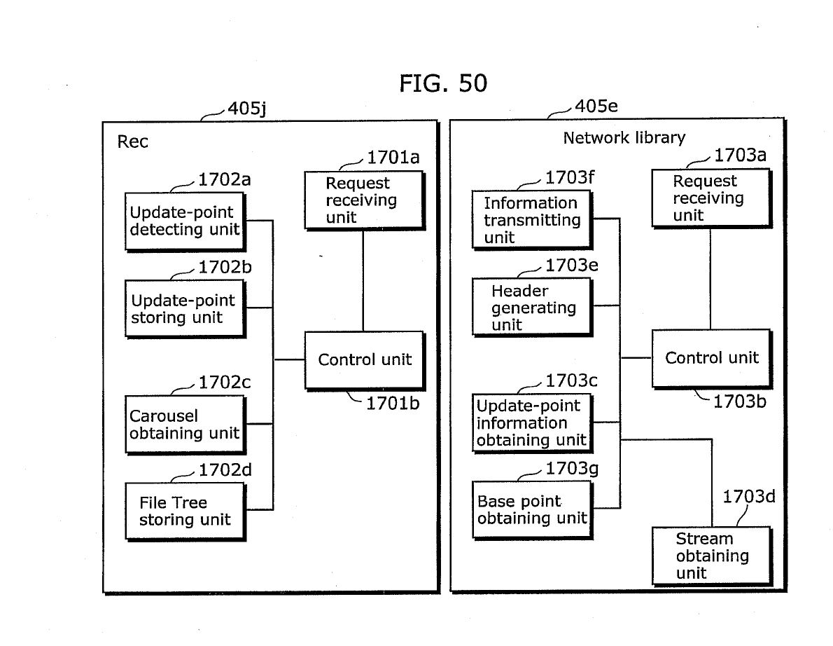

Here, FIG. 50 is a block diagram showing an example of the internal configuration of the Rec 405j shown in the configuration diagram of the program in FIG. 45.

A request receiving unit 1701a receives the request for storing the multimedia data received from the service manager 404 and the recording of the update-point in the multimedia data, and forwards the request details to a control unit 1701b.

In order to obtain the service and packet ID of the multimedia requested, the control unit 1701b, in the same manner as the above-described JMF 405a and AM 405b, obtains the PAT and PMT and obtains the packet IDs of video data, audio data, and respective section data, concerning the TV-program to be stored. Now, when “2” is the identifier of the provided channel and the PAT shown in FIG. 9 and the PMT shown in FIG. 10 are being transmitted, the Rec 405j obtains the PMT shown in FIG. 10 according to the same procedure followed by the JMF 405a. Note that, here, the data to be stored are all the data described in the PMT in FIG. 10.

The control unit 1701b provides these packet IDs to the TS decoder 207 through the library 401b of the OS 401 and causes these to be outputted to the TS multiplexer 210. The TS decoder 207 performs filtering based on such provided packet IDs, and passes the result to the TS multiplexer 210. At this time, the control unit 1701b notifies, to an update-point detecting unit 1702a, a packet ID identifying the section of which update is to be obtained.

The update-point detection unit 1702a compares the received section and the received section obtained previously, with regard to the identified section, and judges whether a version up for the section has occurred. At this juncture, the update-point detection unit 1702a checks the version field of the section and, when the version has changed, passes this section to the update-point storing unit 1702b in order to store the section details transmitted by this to section.

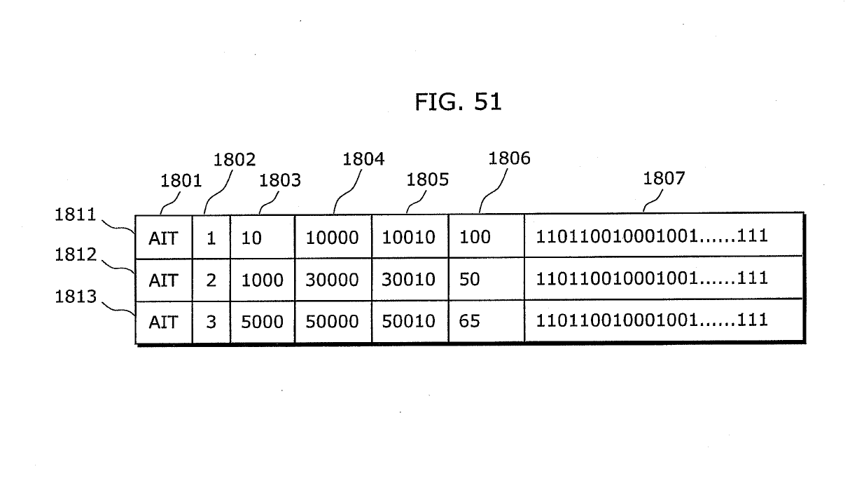

With respect to the update-point detected by the update-point detection unit 1702a, the update-point storing unit 1702b writes the timing of the version up occurrence and the section data at that point, into the second memory 203, by requesting the is IO 405g. Hereinafter, this information shall be called update-point information; an example of which is shown in FIG. 51. In FIG. 51, a column 1801 denotes types of the section. This is, for example, ait, pmt, and so on. A column 1802 denotes version numbers. A column 1803 denotes the time information at which the version zo changed. The time information is represented with the elapsed time from the beginning of the multimedia content. A column 1804 denotes a start position in a stream, for the transmission of the section whose version has changed, and a column 1805 denotes an end position in the stream, for the transmission of the section whose version has changed. Note that columns 1804 and 1805 are specified using byte positions when the beginning of the multimedia content is assumed to be 0. A column 1806 denotes binary section lengths by the number of bytes; a column 1807 denotes binary data of the section. Note that the update-point information shown in FIG. 51 is not limited to this format, and other formats are acceptable as long as information indicating the update-point and information indicating the details of the update are included.

After the update-point storing unit 1702b has written the update-point information, the control unit 1702a generates a URI indicating the place of storage of FIG. 51 in the second memory 203. Note that although a figure of version up of ait is shown in FIG. 51, the version up of pmt or a format in which different sections such as ait and pmt are written in the same table is also acceptable. Furthermore, although a method which collectively records the update-point information of a stream, at the time when multimedia content is recorded, is shown here, it is also possible that the update-point information is created from a stored MPEG transport stream at the timing when the request for stream update-point information from the multimedia data receiving apparatus 102 is received.

Furthermore, at the time of referring to the StreamType of Elementary Stream (hereafter called ES) included in the received PMT, the control unit 1701b checks whether an ObjectCarousel with StreamType=0x0b is included. Then, in the case where ObjectCarousel is included in the multimedia data, the control unit 1702b requests carousel obtainment to the carousel obtaining unit 1702c.

Using the DSMCC 4051 of the lava library 405, the carousel obtaining unit 1702c downloads all ObjectCarousels transmitted with the multimedia data, and constructs, for each Carousel, a file structure such as that shown in FIG. 12. This file structure shall hereafter be called FileTree. In order to store the obtained FileTree, a FileTree storing unit 1702d is called.

The FileTree storing unit 1702d stores the FileTree in the second memory 203 by requesting the IO 405g. At this time, the FileTree storing unit 1702d records the directory where the FileTree is stored in the FileTree element in FIG. 47.

Note that although a method which records the ObjectCarousels at the time when the multimedia content is recorded, it is also possible that the FileTree is newly created from an MPEG transport stream stored in the second memory 203, at the timing when the file obtainment request from the multimedia data receiving apparatus 102 is received.

Note that although the update-point detecting unit 1702b, which detects the version up of a section, is implemented as a constituent element of the Rec 405j here, this function may be included in the S1405i, or may also be a function of the TS decoder 207.

The control unit 1701b causes the TS multiplexer 210 to generate an MPEG-2 transport stream by providing data filtered by the TS decoder 207 and the type of such data, to the TS multiplexer 210.

In addition, by requesting the IO 405g in the Java library 405, the control unit 1701b writes the MPEG transport stream generated by the TS multiplexer 210, in the second memory 203.

In addition, the control unit 1701b obtains the channel identifier of the TV-program by requesting the service manager 404, and reads the TV-program information corresponding to the stored multimedia data from among the TV-program information stored in the second memory 203 shown in FIG. 6, by requesting the IO 405g.

In addition, the control unit 1701b obtains the identifier of the stored multimedia data, by requesting the service manager 404.

Furthermore, the control unit 1701b creates attribute information from the obtained TV-program information, the identifier of the multimedia data, the file name where the multimedia data is stored, and the aforementioned URI of the update-point information, and writes the attribute information into the second memory 203 by requesting the IO 405g.

In addition, the control unit 1701b reads the attribute information table by requesting the IO 405g and, updates its content, and rewrites the updated table into the second memory 203 by requesting the IO 405g, to update the attribute information table.

Next, the process of transmitting the multimedia data requested by a terminal connected to the network 103 among the multimedia data stored in the second memory 203 to the request-source terminal shall be described.

Here, the right portion of FIG. 50 shows a block diagram showing an example of the internal configuration of the network library 405e shown in the configuration diagram of the program illustrated in FIG. 45.

Hereinafter, the explanation shall be described using the example in which the URI table 1331 is as shown in FIG. 49 and the following request is received.

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Version-Request: type=ait; scope=all
X-Tree-Base-Request: carousel_id=1

A request receiving unit 1703a analyzes a request message transmitted from the request-source terminal, and passes the details thereof to a control unit 1703b. In the case where the above-described request is received, the request receiving unit 1703a obtains, at least, the URI of the requested content and the details of X-Version-Request and the X-Tree-Base-Request, and passes them to the control unit 1703b.

Following the information received from the request receiving unit 1703a, the control unit 1703b controls the other constituent elements of the network library 405e, generates a response message, and transmits the generated response message to the request-source terminal. First, when the received request message is invalid, the control unit 1703b: causes the generation of an HTTP error message of the corresponding to the error by requesting a Header generating unit 1703e; passes the generated error message to an information transmitting unit 1703f; transmits the error message to the request-source terminal and finishes the process. When the received request message is valid, the control unit 1703b reads the URI table 1331 by requesting the IO 405g. The control unit 1703b obtains the identifier of the requested content from the read URI table 1331 and the URI obtained by the request receiving unit 1703a. In the case of the above-described example, it can be seen the identifier of the content is 1. Furthermore, it is possible to obtain the URI http://192.168.0.3/VUP/0001-ait.vup of the update-point information of the stream in the requested content.

Next, the control unit 1703b checks whether there is a transmission request for the update-point in the stream, in the information received from the request receiving unit 1703a. In the case where there is a transmission request for stream update-point information, the control unit 1703b performs the following processes. First, the control unit 1703 passes, to the update-point information obtaining unit 1703c, the URI of the update-point information of the stream obtained from the URI table 1331, and the details of the transmission request for the update-point information of the stream received from the request receiving unit 1703a.

The update-point information obtaining unit 1703c identifies, from the received URI http://192.168.0.3/VUP/0001-ait.vup of the update-point information, the file in which the update-point information is stored. Then, the update-point information obtaining unit 1703c accesses the file and checks the existence of the file. In the case where the file does not exist, update-point information obtaining unit 1703c notifies the Header generating unit 1703e that update-point information does not exist, and finishes the process. In the case where the file exists, update-point information obtaining unit 1703c passes, to the Header generating unit 1703e, the URI thereof as well as type and scope information which are values of the extension header X-Version-Request in the request message. Note that it is also possible that, when the occurrence scope of the update-point is specified by using the “scope” in the X-Version-Request, the update-point information obtaining unit 1703c reads information from the file of the update-point information, newly generates update-point information of only the update-points included in the specified section, stores the generated update-point information in the second memory 203 as a new file, and passes the URI of the file to the Header generating unit 1703e.

Next, the control unit 1703b provides, to the stream obtaining unit 1703d, the URI of the requested content and the identifier of the content. Then, the stream obtaining unit 1703d reads the attribute information table 1321 by requesting the IO 405g. Subsequently, the stream obtaining unit 1703d obtains the file name of the attribute information file of the requested content based on the identifier of the content. For example, in the attribute information table 1321 shown in FIG. 48, it can be seen that the attribute information file of the content whose identifier is 1 is 0001.attr. Next, the stream obtaining unit 1703d reads the attribute information file whose name is the obtained file name by requesting the IO 405g. From among the details of the read attribute information file, the stream obtaining unit 1703d obtains the file name where the multimedia data of the content is recorded from the FileName element and the FileTree attribute information. For example, in the case of the attribute information file shown in FIG. 47, it can be seen that the file name of the multimedia data is 0001.m2ts, and the directory in which the FileTree of the ObjectCarousel is stored is /DVR/Content/0001/Carousel1.

Next, the stream obtaining unit 1703d verifies the existence of the multimedia data of the obtained file name by requesting the 405g. In the case where it does not exist, the stream obtaining unit 1703d passes error details to the Header generating unit 1703e, and notifies the control unit 1703b.

In addition, the control unit 1703b checks, in the information received from the request receiving unit 1703a, whether there is an X-Tree-Base-Info which is an information request for the obtaining of the file of an application. When there is such request, the following process is carried out. First, the control unit 1703b passes, to a base point obtaining unit 1703g, the obtained content identifier, and details of the X-Tree-Base-Info. The base point is obtaining unit 1703g reads the attribute information table 1321 by requesting the IO 405g. Subsequently, the base point obtaining unit 1703g reads the FileTree element of the attribute information file of the content, based on the identifier of the requested content. For example, in the case of the attribute information file shown in FIG. 47, it can be seen that the directory in which the FileTree of the ObjectCarousel is stored is /DVR/Content/0001/Carousel1. Next, the base point obtaining unit 1703g checks whether or not a FileTree exists under the obtained mount point, by requesting the IO 405g.

When it exists, the base point obtaining unit 1703g passes, to the Header generating unit 1703e, the directory name specified by the FileTree element. When it does not exist, the base point obtaining unit 1703g passes a null string to the Header generating unit 1703e.

Next, the control unit 1703b requests the Header generating unit 1703e to generate a header of a response message. The Header generating unit 1703e generates the header of an HTTP response message, based on the information obtained from the respective constituent elements of the network library 405e up to this point. In other words, when multimedia data exists, the Header generating unit 1703e collects information such as the attribute information file and the file size that can be obtained by requesting the IO 405g and generates the header of the response message. In addition, in the case where update-point information exists based on the result from the update-point information obtaining unit 1703c, the Header generating unit 1703e generates the extension header X-Version-Info, based on the information received from the update-point information obtaining unit 1703c. In the case of the above-described example, the Header generating unit 1703e generates a header of a response message by adding an extension header X-Version-Info: url=http://192.168.0.3/VUP/0001-ait.vup. In the case where update-point information does not exist, the Header generating unit is 1703e does not generate an X-Version-Info extension header. In addition, the Header generating unit 1703e generates the extension header X-Tree-Base-Info, based on the information received from the base point obtaining unit 1703g. In the case of the above-described example, the Header generating unit 1703e adds, to the header of the response message, an extension header X-Tree-Base-Info: directory=/DVR/Content/0001/Carousel1/. The Header generating unit 1703e passes this response message to the information transmitting unit 1703f. In the case where a null string is received from the base point obtaining unit 1703g, the Header generating unit 1703e generates the extension header X-Tree-Base-Info with no value and adds this to the header of the response message. Furthermore, in the case where nothing is received from the base point obtaining unit 1703g, the Header generating unit 1703e does not generate the extension header X-Tree-Base-Info. The response message generated in the above-described manner is passed on to the information transmitting unit 1703f.

Next, the control unit 1703b sends the response message to the request-source terminal, by requesting the information transmitting unit 1703f. First, the information transmitting unit 1703f sends, to the request-source terminal, the generated header of the response message received from the Header generating unit 1703e.

Next, while the control unit 1703b sequentially reads the multimedia data by requesting the IO 405g, the control unit 1703b transmits the read data to the request-source terminal by requesting the information transmitting unit 1703f.

Furthermore, in the case where the request-source terminal has specified the transmission range of the multimedia data, the control unit 1703b, by requesting the IO 405g, reads the corresponding portion of the multimedia data, collects information such as the data size of the corresponding portion, and generates the header of the response message. At this time, the header of the response message is generated by the same process as the above-mentioned. In addition, the control unit 1703b sends the generated response message to the request-source terminal, by requesting the information transmitting unit 1703f. Next, by requesting the information transmitting unit 1703f, the control unit 1703b transmits the corresponding portion of the multimedia data read by requesting the IO 405g, to the request-source terminal.

Note that although, in the above-described example, the respective constituent elements such as the stream obtaining unit 1703d, the base point obtaining unit 1703g, and so on, individually read the attribute information table 1321, it should go without saying that the control unit 1703b may read the attribute information table 1321 and pass the required information therein to the respective constituent elements.

Furthermore, although, in the above-described example, the URI for obtaining the update-point information is notified by being set in the header of the response message, the information of the update-point may be included in the header of the response message. In this case, the Header generating unit 1703e reads update-point information such as that shown in FIG. 51, from /DVR/Content/0001/VUP/00001-ait.vup obtained from the update-point information obtaining unit 1703c in particular. The Header generating unit 1703e refers to the read update-point information, and obtains the length of the section such as AIT and the details thereof. Then, the Header generating unit 1703e describes, in the extension header X-Version-Info, the length of the section by using a specifier “length”, as well as the details of the section by using the specifier “bytes”. For example, the Header generating unit 1703e generates the following extension header X-Version-Info.

X-Version-Info: type=ait; length=100; bytes=110110010001001 . . . 1111

Furthermore, by using the columns 1804 and 1805 in FIG. 51, it is possible to denote the byte positions for transmitting a section, when the beginning of the multimedia content is assumed to be 0. For example, the Header generating unit describes the start point and end point using a specifier “section_range”, and generates the following extension header.

X-Version-Info: type=ait; section_range=5000-10000

The Java library 405 is a collection of plural Java libraries stored in the second memory 203. In the present embodiment, the Java library 405 has JMF 405a, the AM 405b, the Tuner 405c, the CA 405d, the network library 405e, a reproduction Lib 405f, the IO 405g, an AWT 405h, an S1405i, the Rec 405j, and so on.

Since the functions of the JMF 405a, the AMF 405b, the Tuner 405c, the CA 405d, the Rec 405j have already been described, further description shall be omitted.

The reproduction Lib 405f provides the class and method of the Java language (hereafter called Java APIS) for passing, to the Java program, the identifier of the channel currently being reproduced, which is stored in the second memory 203. By using this Java API, the Java program is able to recognize the channel that is currently being reproduced.

The IO 405g provides, to the Java program, Java APIs for the writing of data to the second memory 203 by the Java program, or Java APIs for the reading of such written data from the second memory 203. By using this API, the Java program is able to store arbitrary data in the secondary memory 203. Since such stored is data is not erased even when power to the multimedia data transmitting apparatus 101 is turned off, the data can be read again after power to the multimedia data transmitting apparatus 101 is turned on.

The AWT 405h provides Java APIs for drawing or for the reception of a key input-notification from the input unit 201 by the Java program. To be more specific, these correspond to the java.awt package, java.awt.event package, and other java.awt subpackages described in “The Java class Libraries Second Edition, Volume 2” (ISBN0-201-31003-1). Here, detailed description shall be omitted.

The SI 405i provides Java APIs for the obtaining of channel information and electric program information by the Java program. To be more specific, there are the Java TV Specification and the like. Furthermore, the MPEG section filter API for obtaining raw binary data from an MPEG-2 transport stream currently being broadcast is defined in the OCAP Specification, and the Java application can understand and handle unique electric program data that has been transmitted.

Next, the multimedia data receiving apparatus 102 shall be described.

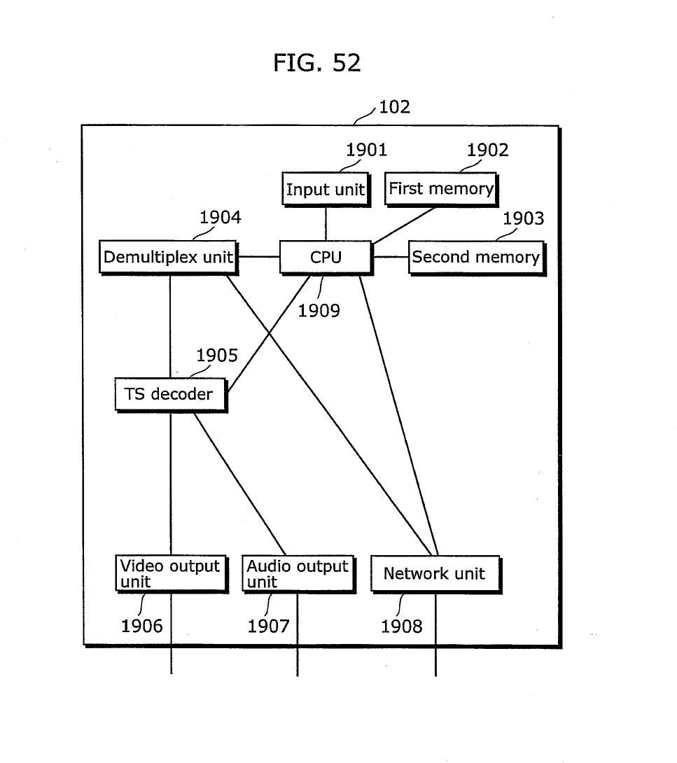

FIG. 52 is a block diagram showing the relationship of constituent elements of the multimedia data receiving apparatus 102 in the present embodiment. The multimedia data receiving apparatus 102 includes an input unit 1901, a first memory 1902, a second memory 1903, a demultiplex unit 1904, a TS decoder 1905, a video output unit 1906, an audio output unit 1907, a network unit 1908, and a CPU 1909.

The input unit 1901, the first memory 1902, and the second memory 1903 are identical to the input unit 201, the first memory 202, and the second memory 203 of the previously described multimedia data transmitting apparatus 101 in the present embodiment. Note that the multimedia data receiving apparatus 102 stores, in the second memory 1903, TV-program information such as the identifier, title, broadcast date and time, broadcast channel, and so on, of the multimedia data in the content list, EPG data, and so on, received from the multimedia data transmitting apparatus 101.

The demultiplex unit 1904 receives an MPEG transport stream from the CPU 1909, extracts information specified by the CPU 1909 and passes the extracted information to the CPU 1909. In addition, demultiplex unit 2904 passes the MPEG transport stream to the TS decoder 1905 as it is.

The TS decoder 1905 receives the identifiers of audio data and video data from the CPU 1909. In addition, the TS decoder 1905 extracts data corresponding to the received identifiers of audio data and video data, from the stream received from the demultiplex unit 1904. The TS decoder 1905 passes extracted video data to the video output unit 1906, and the extracted audio data to the audio output unit 1907.

The video output unit 1906 and the audio output unit 1907 are identical to the video output unit 208 and the audio output unit 209, respectively, of the previously described multimedia data transmitting apparatus 101 in the present embodiment.

The network unit 1908, which includes a network interface, converts the data received from the CPU 1909 into a signal that is in accordance with the physical media of the network to which the network interface is connected to, and outputs this signal. Furthermore, the network unit 1908 receives a signal from the network interface, converts the signal into a packet defined by the IP network, and passes the packet to the CPU 1909.

The CPU 1909 controls the demultiplex unit 1904, the TS decoder 1905, and the network unit 1908 by executing a program stored in the second memory 1903.

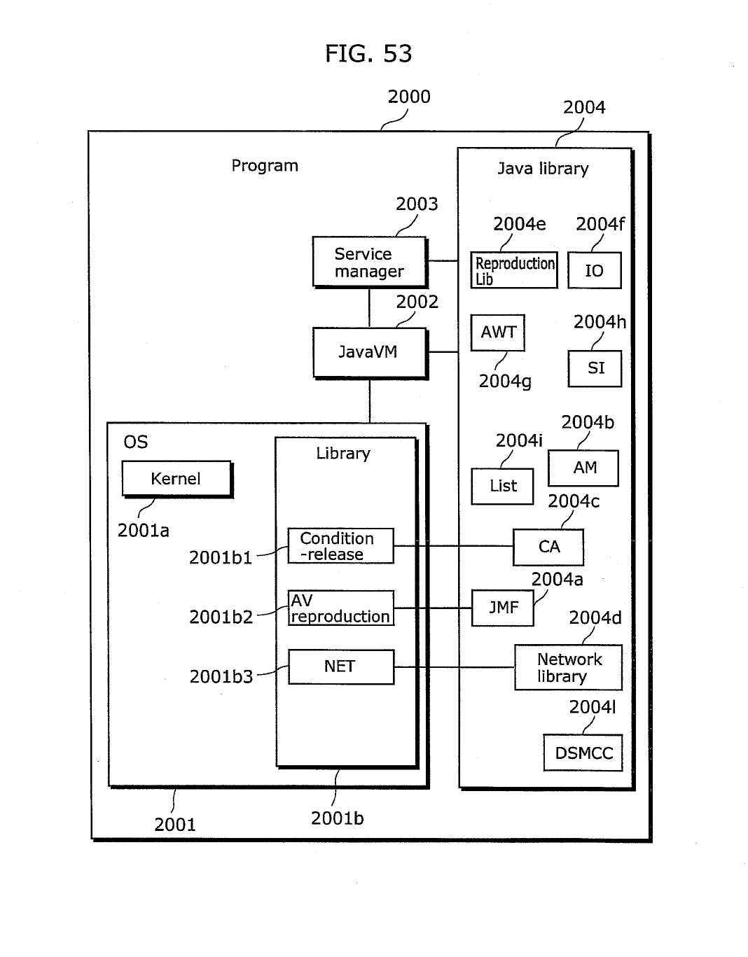

FIG. 53 is an example of a structure diagram of the program stored in the second memory 1903 and executed by the CPU 1909.

A program 2000 is made up of a plurality of subprograms. Specifically, it is made up of an OS 2001, a Java VM 2002, a service manager 2003, and a Java library 2004.

The OS 2001 is a subprogram activated on the CPU 1909 when power to the multimedia data receiving apparatus 102 is turned on.

OS is the acronym for operating system, an example of which is Linux and the like. The OS 2001 is a generic name for publicly known technology made up of a kernel 2001a for executing another subprogram concurrently, and of a library 2001b, and therefore detailed description is omitted. In the present embodiment, the kernel 2001a of the OS 2001 executes the Java VM 2002 as a subprogram. Furthermore, the library 2001b provides these subprograms with plural functions for controlling the constituent elements held by the multimedia data receiving apparatus 102.

In the present embodiment, the library 2001b includes condition-release 2001b1, AV reproduction 2002b2, and NET 2001b3, as an example of functions.

The condition-release 2002b1 receives information from other subprograms or a CA 2004c of the Java library 2004, enables the AV reproduction 2001b2, and permits the reproduction of the multimedia data received from the network.

The AV reproduction 2002b2 receives an audio packet ID and video packet ID from the other subprograms or a JMF 2004a of the Java library 205. The AV reproduction 2002b2 then provides the received audio packet ID and video packet ID to the TS decoder 1905. As a result, the TS decoder 1905 performs filtering based on the provided packet IDs, and implements the reproduction of video/audio.

The NET 2001b3 creates packets of a protocol lower than the application layer defined in the IP network, for the data received is from the other subprograms or a network library 2004d of the Java library 2004. A protocol lower than the application layer refers to, for example, a TCP packet, a UDP packet, an IP packet, and so on. By passing this to the network unit 1908, messages and data are transmitted to another device via the network 103. Furthermore, when a message is received from another device via the network 103, the NET 2001b3 converts the message to an application layer protocol packet and passes this packet to the other subprograms or the network library 2004d of the Java library 2004. An application layer protocol refers to, for example, HTTP, RTSP, RTP, and so on.

The service manager 2003 is identical to the service manager 404 of the previously described multimedia data transmitting apparatus 101 in the present embodiment except for the following points of difference. The service manager 404 receives a channel identifier from the reproduction unit 402b of the EPG 402; passes the identifier to the Tuner 405c and causes the Tuner 405c to perform tuning; performs descrambling by requesting the CA 405d, and requests the reproduction of video and audio by providing the channel identifier to the JMF 405a. Whereas, the service manager 2003 receives the content identifier from a List 2004i in the Java library 2004; passes the content identifier as well as information on the apparatus storing such content identifier, and so on, to the network library 2004d and receives a stream from the apparatus; then requests for the reproduction of video and audio by providing the content identifier to the JMF 2004a in the Java library 2004. The List 2004i shall be described later.

The service manager 2003 provides, to the network library 2004d in the Java library 2004, information such as the content identifier and the IP address of multimedia data transmitting apparatus 101. Then, the service manager 2003 requests the network library 2004d for the transmission of a multimedia data transmission request to the multimedia data transmitting apparatus is 101. In addition, the service manager 2003 requests the network library 2004d for the reception of the multimedia data transmitted from the multimedia data transmitting apparatus 101. Upon receiving the request, the network library 2004d connects to the multimedia data transmitting apparatus 101, and issues a transmission request for the multimedia data. Subsequently, the network library 2004d passes the data transmitted by the multimedia data transmitting apparatus 101, to the CPU 1909.

By passing the multimedia data to the demultiplex unit 1904, the service manager 2003 carries out the reproduction of the multimedia data.

Note that with regard to trick play such as fast forward, rewind, and so on, the service manager 2003 requests trick play to the JMF 2004a described later, and in addition, performs trick play by requesting the network library 2004d to sequentially receive data necessary for trick play.

The Java library 2004 is a collection of plural Java libraries stored in the second memory 1903. In the present embodiment, the lava library 2004 includes the IMF 2004a, an AM 2004b, the CA 2004c, the network library 2004d, a reproduction Lib 2004e, the List 2004i, and so on.

The JMF 2004a, the AM 2004b, the reproduction Lib 2004e, an 2004f, an AWT 2004g, an S12004h are identical to the IMF 405a, the AM 405b, the reproduction Lib 405f, the IO 405g, the AWT 405h, and the SI 405i, respectively, which are located in the Java library 405 of the previously described multimedia data transmitting apparatus 101 in the present embodiment.

The CA 2004c manages rights processing of the multimedia data, such as the copy control for the multimedia data transmitted via the network 103. Copy control information may be transmitted from the multimedia data transmitting apparatus 101, the content providers such as the broadcast station 105, or an external server specified by the rights holder. Or, it may also be possible that copy control information included in the PMT in a transport stream transmitted from the multimedia data transmitting apparatus 101 is referred.

The List 2004i displays an EPG of the multimedia data transmitting apparatus 101 or a list of multimedia contents stored and provided by the multimedia data transmitting apparatus 101, selects one multimedia content from the list according to a user's operation accepted by the input unit 1901, and requests reproduction to the service manager 2003. At this time, information of the multimedia data transmitting apparatus 101 is also passed to the service manager 2003. Furthermore, the EPG of the multimedia data transmitting apparatus 101 and the list of contents to be provided from the multimedia data transmitting apparatus 101 can be obtained through the network library 2004d. Note that the configuration that the List 2004i is included in the network library 2004d is possible.

The network library 2004d communicates with the multimedia data transmitting apparatus 101 connected to the network 103 through the NET 2001b3 of the OS2001b. The communication with the multimedia data transmitting apparatus 101 includes multimedia data list transmission/reception, multimedia data transmission request issuance and reception of the multimedia data.

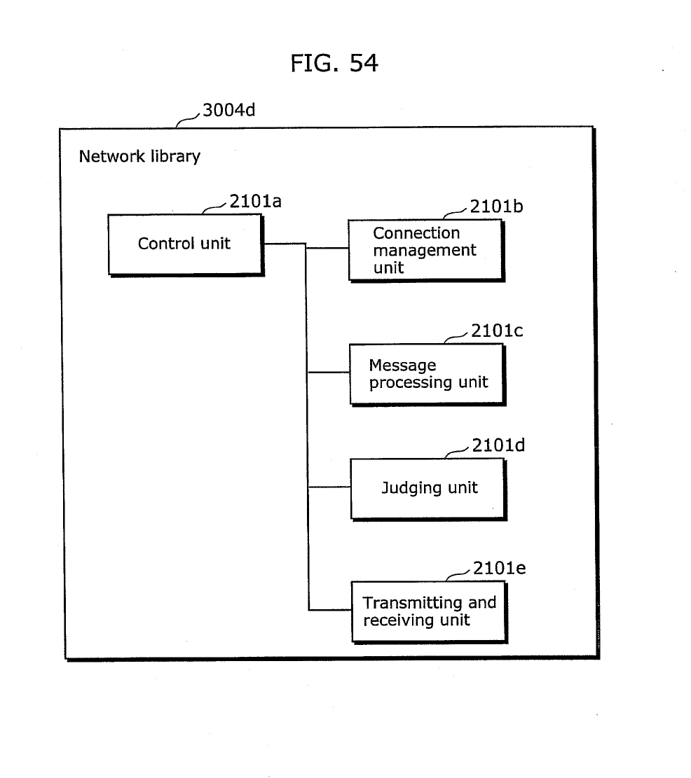

FIG. 54 is a block diagram showing an example of the internal configuration of the network library 2004d. A network library 2004d includes a control unit 2101a, a connection management unit 2101b, a message processing unit 2101c, a judging unit 2101d, and a transmitting and receiving unit 2101e. Note that the network library 2004 may also include other functions related to the IP network.

The control unit 2101a provides Java APIs to the downloaded Java application, the service manager 2003, or other constituent elements of the Java library 2004, all of which are executed on the multimedia data receiving unit 102, and enables them to use the functions realized by the network library 2004. The connection management unit 2101b operates upon a request from the control unit 2101a and manages the network connection with external devices on the network 103, such as the multimedia data transmitting apparatus 101. The message processing unit 2101c operates upon a request from the control unit 2101a and generates, based on information received from the control unit 2101a, a message to be transmitted to the external device connected through the network 103. The judging unit 2101d, which operates upon a request from the control unit 2101a, receives, from the control unit 2101a, a response message received from an external device, analyzes the response message, and notifies the details thereof to the control unit 2101a. The transmitting and receiving unit 2101e, which operates upon a request from the control unit 2101a, transmits data received from the control unit 2101a through the network connection managed by the connection management unit 2101b and received from the control unit 2101a. In addition, the transmitting and receiving unit 2101e receives data from the network connection and passes the received data to the control unit 2101a. The operation of the respective constituent units shall be described below.

First, the operation for obtaining a list of contents provided by an external device connected to the network 103 shall be described.

First, the control unit 2101a obtains a list of devices connected to the network 103, in accordance with a request from a downloaded Java application or the service manager 2003, and so on. This device list can be generated by carrying out communication defined in UPnP DA. Furthermore, the communication defined in UPnP DA includes the case of receiving an inquiry from an external device, and a case of inquiring from the multimedia data receiving unit 102, that is, from the control unit 2101a. In the case of receiving a notification from an external device, the control unit 2101a causes the judging unit 2101d to interpret the UPnP DA-defined message received by the transmitting and receiving unit 2101e, and obtains the details of the interpreted message. By the message, it is reported that the device like the server or the services provided by the server are available via the network 103. Next, the control unit 2101a causes the message processing unit 2101c to generate an UPnP DA-defined inquiry message for information about the sever device or the services, to the external device which sent the notification. In addition, the control unit 2101a provides the generated message to the transmitting and receiving unit 2101e and causes it to transmit the message, and to receive a response message from the server device. In addition, the control unit 2101a can get the details of the server device and the services provided by the server device, by providing the received message to the message processing unit 2101c and causing it to interpret the message. Note that the network connection used in these communications is managed by the connection management unit 2101b.

On the other hand, in the case of an inquiry from the control unit 2101a, the control unit 2101a generates a UPnP DA-defined message inquiring about the existence of a device, by requesting the message processing unit 2101c. Then, the control unit 2101a requests the transmitting and receiving unit 2101e to broadcast the generated message to the network 103. Next, by requesting the connection management unit 2101b, the control unit 2101a receives a connection request for receiving the response to the broadcasted message. When the acceptance of the connection is notified from the connection management unit 2101b, the control unit 2101a causes the transmitting and receiving unit 2101e to receive the message by requesting it. In addition, the control unit 2101a requests the judging unit 2101d to interpret the received message, and obtains the information thereof. In addition, the control unit 2101a requests the message processing unit 2101c to generate a message inquiring about the service or capability provided by the device, and requests the transmitting and receiving unit 2101e to transmit the generated message to the external device. In addition, the control unit 2101a requests the transmitting and receiving unit 2101e to receive a response message to the transmitted message, and provides the received message to the judging unit 2101d for interpretation, and obtains the details thereof. With this, the control unit 2101a can obtain information on a certain external device. By repeating such a process, a list of external devices connected to the network 103 can be obtained.

Next, the control unit 2101a obtains a list of contents provided by a specific device connected to the network 103, in accordance with a request from a downloaded Java application or the service manager 2003, and so on. Hereinafter, description is carried out with the specific external device being assumed to be the multimedia data transmitting apparatus 101.

First, the control unit 2101a generates a UPnP AV-defined content list transmission request message, by requesting the message processing unit 2101c. At this juncture, when a condition for the content is received from the Java application, and the like, the control unit 2101a generates the appropriate message by providing the condition to the message processing unit 2101c. Next, control unit 2101a provides, to the connection management unit 2101b, information such as the IP address of the multimedia data transmitting apparatus 101 provided from the Java application, and the like, and obtains information of the network connection with the multimedia data transmitting apparatus 101. Then, the control unit 2101a provides the obtained information to the transmitting and receiving unit 2101e. At this time, in the case where the network connection with the multimedia data transmitting apparatus 101 is not yet established, the connection management unit 2101b newly establishes a network connection with the multimedia data transmitting apparatus 101. Next, the control unit 2101a provides the content list transmission request message generated by the message processing unit 2101c to the transmitting and receiving unit 2101e and causes the transmitting and receiving unit 2101e to transmit the message to the multimedia data transmitting apparatus 101. In addition, the control unit 2101a requests the transmitting and receiving unit 2101e to receive a response message from the multimedia data transmitting apparatus 101. In addition, the control unit 2101a provides the received response message to the judging unit 2101d, causes the judging unit 2101d to interpret the response message, and obtains a content list which is the details of the response message. The control unit 2101a passes the obtained content list to the Java application, the service manager 2003, or the List 2004i.

Next, the process of receiving multimedia data and data related thereto, from the multimedia data transmitting apparatus 101, and reproducing such received data, in accordance with a request from a downloaded lava application or the service manager 2003, shall be described. Although the process according to a request from the service manager 2003 is exemplified below, the process is the same for the case of a request from a downloaded lava application.

First, upon receiving a multimedia data obtainment request from the service manager 2003, the control unit 2101a establishes a network connection with the multimedia data transmitting apparatus 101, by requesting the connection management unit 2101b. At this time, information such as the content identifier and the IP address of the multimedia data transmitting apparatus 101, as well as information such as the URI for accessing the content, are passed on from the service manager 2003 to the control unit 2101a. Among such information, the control unit 2101a provides the connection management unit 2101b with at least the IP address of the multimedia data transmitting apparatus 101 and the port number, and the like, for the network connection.

The connection management unit 2101b establishes the network connection with the multimedia data transmitting apparatus 101 using the information received from the control unit 2101a. Network connection means, for example, a TCP connection for performing HTTP communication in the case where multimedia as data is transmitted by HTTP. Note that although in the present embodiment the IP address of the multimedia data transmitting apparatus 101 and/or the port number are provided to the connection management unit 2101b, it is also acceptable that the connection management unit 2101b is provided with URI of the data to be obtained and obtains such information by interpreting the provided URI. Furthermore, it is also acceptable that the connection management unit 2101b is provided with the content identifier and obtains such information.

Next, in order to start reproduction by the service manager 2003, the control unit 2101a accepts the section obtainment requests and file obtainment requests from the various libraries shown in FIG. 53. For example, the control unit 2101a performs the receiving of the multimedia data for AV reproduction. Furthermore, when trick play is performed on the multimedia data receiving apparatus 102, the reception requests for PAT, PMT, and a file transmitted by DSMCC is required. This is because, during the trick play, there are some cases where not all the TS streams of the multimedia data are received and it may happen that, at the timing in which the JMF 2004a, the AM 2004b, or the DSMCC 20041, and so on, need to use the PAT and PMT, these section data or DSMCC file do not exist on the multimedia data receiving apparatus 102.

Next, in order to transmit the request for the obtainment of these information to the multimedia data transmitting apparatus 101, the control unit 2101a generates a corresponding HTTP request message by requesting the message processing unit 2101c.

The message processing unit 2101c sets the URI of the requested multimedia data in the HTTP request. For example, the following shows the HTTP request in which the URI of the multimedia data is http://192.168.0.3/AVData/0001.m2ts, and to which is set an extension header X-Version-Request for requesting update-point information within a stream in preparation for the trick play.

GET http://192.168.0.3/AVData/0001.m2ts HTTP/1.1

### Host: 192.168.0.3

### Date: Thr Jan 11 15:00:00 2007 GMT

### User-Agent: AVT Client

### Connection: Keep-Alive

X-Version-Request: type=ait; scope=all

Note that, during the trick play, the request is carried out using a method which specifies the specific section of the multimedia content that is required. This can be performed by using the Range header of HTTP. Furthermore, in the same manner, a header specifying the occurrence scope of the update-point is generated.

X-Version-Request: type=ait; scope=47940-95879

For example, during the trick play, when there is an update-point in a section of the stream that was not obtained, this extension header can be used for obtaining such section.

Next, the control unit 2101a provides the HTTP request generated in the above-described manner to the transmitting and receiving unit 2101e and causes the transmitting and receiving unit 2101e to transmit the HTTP request to the multimedia data transmitting apparatus 101.

Next, the control unit 2101a requests the transmitting and receiving unit 2101e to receive an HTTP response from the multimedia data transmitting apparatus 101. An example of the received HTTP response is shown below.

### HTTP/1.1 200 OK

### Date: Thr Jan 11 15:00:01 2007 GMT

### Server: AVT Server

### Connection: Keep-Alive

Content-Type: video/mpeg

### Content-Length: 47952

X-Version-Info: type=ait; url=http://192.168.0.3/VUP/0001-ait.vup

### (Empty Line)

[47952-byte data]

Subsequently, the control unit 2101a passes the received HTTP response message to the judging unit 2101d and requests interpretation of it.

First, the judging unit 2101d checks the response code of the HTTP response. When the result is 200 OK, this is provided to the control unit 2101a. Then, the control unit 2101a passes, to the service manager 2003, the received multimedia data in the body portion of the HTTP response, and reproduction is performed.

In addition, the judging unit 2101d checks whether an extension header X-Version-Info, which indicates update-point information in the stream, exists. In the case where an extension header X-Version-Info exists as in the above-described example, the judging unit 2101d notifies the details of the header to the is control unit 2101a. Then, the control unit 2101a generates and transmits, to the multimedia data transmitting apparatus 101, a message for the update-point information obtainment, by requesting the message processing unit 2101c and the transmitting and receiving unit 2101e, respectively, and in addition, receives the stream update-point information specified by the multimedia data transmitting apparatus 101, by requesting the transmitting and receiving unit 2101e. Subsequently, the control unit 2101a passes the received update-point information to the SI 2004h. In the case where an extension header X-Version-Info does not exist, the as control unit 2101a is merely notified by the judging unit 2101d of the fact that an extension header X-Version-Info does not exist.

The SI 2004h notifies the version up of the section data to the requested lava library according to the received update-point information, during the reproduction of the received multimedia data. With this, the Java application or service manager 2003, or the Java library is able to perform the appropriate processing corresponding to the version up of the section data. For example, in the case where there is a need to start a new application, it becomes possible to detect the timing for the activation and the like. Therefore, an application can be started at the appropriate timing. In the case where it is necessary to obtain a file from the multimedia data transmitting apparatus 101 in order to start an application, it is possible to obtain the file by using the above-described extension header X-Tree-Base-Request and the extension header X-Tree-Base-Info. In other words, the control unit 2101a generates a multimedia data transmission request message with the extension header X-Tree-Base-Request by requesting the message processing unit 2101c, and transmits the message to the multimedia data transmitting apparatus 101 by providing the message to the transmitting and receiving unit 2101e. Subsequently, the control unit 2101a receives the response message thereto, through the transmitting and receiving unit 2101e, and passes the received response message to the judging unit 2101d. The judging unit 2101d further checks whether the extension header X-Tree-Base-Info is included and, when included, notifies the control unit 2101a of the extension header. Upon receiving a request for file obtainment from the Java application or the service manager 2003, the control unit 2101a receives the file from the multimedia data transmitting apparatus 101 in the above-described manner, using the values of the notified X-Tree-Base-Info.

As described above, on the multimedia data receiving unit 102, update-points in a stream can be detected correctly, and content, including data broadcast, can be properly reproduced, even when trick play is performed.

Note that although an example is given here in which the SI 2004h manages the timing for version up, this function may be implemented by another library as long as it is possible to perform the appropriate processing such as version up notification, and so on, by taking the correspondence of the content viewing position and the received update-point information during the multimedia reproduction.

(Other Modifications)

Although the present invention is described based on the above-mentioned embodiments, it should be obvious that the present invention is not limited to such above-mentioned embodiments. The present invention also includes such cases as described below.

(1) Although, in the above-described embodiments, HTTP is used as the content data transmitting protocol, other protocols, such as RTP/RTSP, may be used.

(2) Although, in the above-described embodiments, only video content in the MPEG2-TS format is described, it goes without saying that the same processing can also be performed on video is content in other coding formats and other types of content such as music.

(3) Although, in the above-described embodiments, transmission of data and tables is performed by being transmitted from the multimedia data transmitting apparatus 101 which is a server, in response to a request from the multimedia data receiving unit 102 which is a client, the data and tables may also be transmitted from the server without the request from the client. In this case, the format for transmission from the server may be independently determined by the server, or may be determined in as advance between the server and the client. Furthermore, the transmission format may be determined according to an instruction from an external source such as the broadcast station.

(4) Although, in the above-described embodiments, the extension header is defined, as long as the same information can be transmitted, the format need not be limited to the present format.

(5) Although, in the above-described embodiments, the transmission request for data and tables is issued by being included in the transmission request for multimedia data, update-point information transmission may be performed independently of multimedia data communication. Furthermore, although in the above-described embodiments, the transmission request for data and tables is transmitted by being included in the header of an HTTP-GET request, communication for only the data and tables may be issued using an HTTP-HEAD request, or the like, which does not involve data transmission and reception.

(6) Although, in the above-described embodiment, transmission of the update-point of the stream is performed by being transmitted from the multimedia data transmitting apparatus 101 which is a server, in response to a request from the multimedia data receiving unit 102 which is a client, the stream update-point may also be transmitted from the server without the request from the client.

(7) Although, in the above-described embodiment, the extension header X-Version-Request and the extension header X-Version-Info are defined, it goes without saying that the present invention is not limited to such format as long as equivalent information can be transmitted. For example a Pragma header field may be used. In this case, by using getVersionInfoURI as the transmission request pragma-directive, and adopting versionInfoURI for the URI notification pragma-directive, the transmission request can be implemented by adding the following header to the request message.

Pragma: getVersionInfoURI

Furthermore, the URI can be notified by adding the following header to the response message.

Furthermore, the URI can be notified by adding the following header to the response message.

Pragma: versionInfoURI=“http://192.168.0.3/VUP/0001-ait.vup”

In the case where the update-point occurring in the specific section, or in the case of obtaining update-point information of the specific section data only, such Pragma-directive of Pragma header field like above may be added, and may also be used together with the aforementioned extension header X-Version-Request and extension header X-Version-Info. Furthermore, the Pragma header field may be used as a response to a request including the extension header X-Version-Request.

(8) Although, in the present embodiment, the transmission request for update-point information is issued included in the transmission request for multimedia data, update-point information communication may be performed independently of multimedia data communication. Furthermore, although in the present embodiment, the transmission request for update-point information is transmitted by being included in the header of an HTTP-GET request, communication for only the update-point information may be performed using an HTTP-HEAD request, or the like, which does not involve data transmission and reception.

(9) Although, in the present invention, the multimedia data transmitting apparatus notifies the update-point information within a range specified by the multimedia data receiving unit, it is also possible that the multimedia data transmitting apparatus notifies the update-points for the specified section in the case where the multimedia data receiving apparatus specifies the section by using a Range header field and the like and obtains data of only the specified section of the multimedia data. Alternatively, it is also possible that the multimedia data transmitting apparatus notifies the update-points before or after the specified section. Furthermore, in the case where the multimedia data receiving apparatus successively issues transmission requests with specifying the section, it is also possible that the multimedia data transmitting apparatus notifies the update-points between the preceding requested section and the current requested section.

(10) A part or all of the constituent elements making up each of the above-mentioned apparatuses may be made from one system LSI (Large Scale Integration circuit). The system LSI is a super multi-function LSI that is manufactured by integrating plural components in one chip, and is specifically a computer system which is configured by including a microprocessor, a ROM, a RAM, and so on. A computer program is stored in the RAM. The system LSI accomplishes its functions through the operation of the microprocessor in accordance with the computer program.

(11) A part or all of the constituent elements making up each of the above-mentioned apparatuses may be made from an IC card that can be attached to/detached from each apparatus, or a stand-alone module. The IC card or the module is a computer system made from a microprocessor, a ROM, a RAM, and so on. The IC card or the module may include the super multi-function LSI. The IC card or the module accomplishes its functions through the operation of the microprocessor in accordance with the computer program. The IC card or the module may also be tamper-resistant.

(12) The multimedia data transmitting apparatus and the multimedia data receiving apparatus of the present invention may also be the above-described methods. The present invention may also be a computer program for executing such methods through a computer, or as a digital signal made from the computer program.

Furthermore, the multimedia data transmitting apparatus and the multimedia data receiving apparatus of the present invention may be a computer readable recording medium on which the computer program or the digital signal is recorded, such as a flexible disc, a hard disc, a CD-ROM, an MO, a DVD, a DVD-ROM, a DVD-RAM, a Blu-ray Disc (BD), a semiconductor memory, and so on. Furthermore, the multimedia data transmitting apparatus and the multimedia data receiving apparatus of the present invention may also be the computer program or the digital signal recorded on such recording media.

Furthermore, the multimedia data transmitting apparatus and the multimedia data receiving apparatus of the present invention may also be the computer program or the digital signal transmitted via an electrical communication line, a wireless or wired communication line, a network represented by the internet, a data broadcast, and so on.

Furthermore, the multimedia data transmitting apparatus and is the multimedia data receiving apparatus of the present invention may also be a computer system including a microprocessor and a memory, with the memory storing the computer program and the microprocessor operating in accordance with the computer program.

Furthermore, the present invention may also be implemented in another independent computer system by recording the program or digital signal on the recording medium and transferring the recording medium, or by transferring the program or the digital signal via the network, and the like.

(13) It is also possible to combine the above-described embodiment and the aforementioned variations.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

With respect to the problem, in the sharing of multimedia content using a home network, in which a data broadcast cannot be correctly implemented in the case where trick play occurs when a multimedia data transmitting apparatus transmits multimedia data in response to a request from a client and the multimedia data is reproduced, the multimedia data transmitting apparatus, the multimedia data receiving apparatus, and the multimedia content communication system configured thereof according to the present invention enable the implementation of the data broadcast at the correct timing, by providing a technique for definitely notifying the multimedia data receiving apparatus of required timing-dependent data in the data for data broadcasting. As such, the present invention is useful as a server apparatus, a receiving terminal, and a multimedia data communication method in a networked environment such as in a home network.

What is claimed is:

1. A multimedia data transmitting apparatus which transmits stored multimedia data to a multimedia data receiving apparatus via a network, in response to a transmission request from the multimedia data receiving apparatus, said multimedia data transmitting apparatus comprising:
a storage unit in which first multimedia data received from a digital broadcast is stored, the first multimedia data including audio, video, and added information;
an event information management unit operable to manage event information representing: an event occurring in the first multimedia data stored in said storage unit, and an occurrence timing of the event;
a request receiving unit operable to receive a request message from the multimedia data receiving apparatus; and
an information transmitting unit operable to transmit, to the multimedia data receiving apparatus, the multimedia data and the event information which are specified in the request message.

2. The multimedia data transmitting apparatus according to claim 1, further comprising
a transmission data generating unit operable to extract plural portions from the stored first multimedia data, and to generate as second multimedia data conforming to a specified trick play,
wherein, in the case of receiving a request for a trick play from the multimedia data receiving apparatus, said transmission data generating unit is operable:
to generate the second multimedia data by referring to the event information, so as to include the event occurring in the first multimedia data specified by the multimedia data receiving apparatus, and
in the case where a portion including the occurrence timing of the event in the first multimedia data is specified, to place the event at the same position in the portion of in the second multimedia data, and
in the case where the portion including the occurrence timing of the event in the first multimedia data is not specified, to place the event immediately before the portion of the second multimedia data that is equivalent to the portion of the first multimedia data that is specified immediately after the occurrence timing of the event in the first multimedia data, and
said information transmitting unit is operable to transmit the second multimedia data generated by said transmission data generating unit.

2. The multimedia data transmitting apparatus according to claim 1,
wherein the request message received, from the multimedia data receiving apparatus, by said request receiving unit is an obtainment request for one of: multimedia data, Moving Picture Experts Group (MPEG) section data, a file, a directory, an MPEG Digital Storage Media Command and Control (DSMCC) Module, and an MPEG DSM-CC Object.

4. The multimedia data transmitting apparatus according to claim 3,
wherein the request message received from the multimedia data receiving apparatus by said request receiving unit specifies at least one from among a data type, a data identifier, and a multimedia data section.

5. The multimedia data transmitting apparatus according to claim 3,
wherein said information transmitting unit is operable to transmit, in response to the request message from the multimedia data receiving apparatus, one of the following which conforms to the request message: multimedia data, MPEG section data, a file, a directory, an MPEG DSM-CC Module, and an MPEG DSM-CC Object.

6. The multimedia data transmitting apparatus according to claim 5,
wherein, when the request is received from the multimedia data receiving apparatus, said information transmitting unit is operable to select data conforming to the request message, by referring to data managed by said event information management unit, and to transmit the selected data.

7. The multimedia data transmitting apparatus according to claim 1,
wherein said event information management unit is further operable to manage information for reproducing a data broadcast included in the first multimedia data.

8. The multimedia data transmitting apparatus according to claim 1,
wherein said information transmitting unit is operable to transmit management information of the event information held by said event information management unit, to the multimedia data receiving apparatus, in response to the request from the multimedia data receiving apparatus.

9. A multimedia data receiving apparatus which receives multimedia data and association information of the multimedia data from a multimedia data transmitting apparatus, and reproduces the multimedia data,
wherein the association information is one of the following which is associated with the multimedia data: MPEG section data, a file, a directory, an MPEG DSM-CC Module, an MPEG DSM-CC Object, and event information representing an event occurring in the multimedia data and an occurrence timing of the event, and
the multimedia is reproduced by a process that conforms to the type of the received association information.

10. The multimedia data receiving apparatus according to claim 9,
wherein, in the case where an event information is received, said multimedia data receiving apparatus updates the multimedia data or the association information which are held in said multimedia data receiving apparatus, by performing either of the following according to details of the received event information: deleting the received multimedia data or the association information; and receiving new multimedia data or association information by requesting to the multimedia data transmitting apparatus.

11. The multimedia data receiving-apparatus according to claim 9,
wherein said multimedia data receiving apparatus receives the association information by requesting the multimedia data transmitting apparatus.

12. The multimedia data receiving apparatus according to claim 9, further:
receives management information of the event held by the multimedia data transmitting apparatus;
determines data that is required according to the event, by referring to the received management information; and
receives the required data by requesting to the multimedia data transmitting apparatus.

13. The multimedia data receiving apparatus according to claim 9, further comprises
a Java™ execution unit operable to execute a Java application,
wherein the multimedia data or the association information of the multimedia data is obtained according to an instruction from the Java application.
